(19) United States
(12) Patent Application Publication
(10) Pub. No.: US 2026/0192844 A1
(43) Pub. Date: Jul. 9, 2026

(54) HAND TRUCK STRAP TIE-DOWN

(71) Applicant: Tricam Industries, LLC, Eden Prairie, MN (US)

(72) Inventors: Joseph P. Foley, Mendota Heights, MN (US); Benjamin M. Wernberg, Savage, MN (US); Jackson T. Wilkey, Minneapolis, MN (US); Marie A. Vanderwarn, Minneapolis, MN (US)

(73) Assignee: Tricam Industries, LLC, Eden Prairie, MN (US)

(21) Appl. No.: 19/557,528

(22) Filed: Mar. 5, 2026

Related U.S. Application Data
(63) Continuation of application No. 18/817,502, filed on Aug. 28, 2024.
(60) Provisional application No. 63/579,061, filed on Aug. 28, 2023.

(51) Int. Cl. B62B 5/06; B62B 1/10; B62B 3/02

(52) U.S. Cl. CPC B62B 5/068; B62B 1/10; B62B 3/02

(57) ABSTRACT

Material handling devices are disclosed. Specifically disclosed are hand truck structures such as toe plates, wheel supports, handles, and lock mechanisms, as well as methods of construction and manufacturing. Structures and methods of providing for anchoring and passing of straps, cords, and other devices for securing materials or items to be transported via a hand truck are specifically disclosed.

### RELATED APPLICATION

The present application claims the benefit of U.S. patent application Ser. No. 18/817,502, filed Aug. 28, 2024, which claims the benefit of U.S. Provisional Application No. 63/579,061, filed Aug. 28, 2023, both of which are incorporated herein by reference in their entirety.

### FIELD OF THE INVENTION

The present disclosure relates generally to material handling devices such as hand trucks and dollies used to move items that are too heavy or bulky to be moved manually and more particularly to improvements to the size, arrangement, orientation, and materials of construction to enhance strength, stability, functionality, and overall user experience while lowering the cost of manufacturing and lessening the weight of the devices.

### BACKGROUND OF THE INVENTION

Material handing devices are well known. Improvements to material handling devices include those disclosed in U.S. Pat. No. 6,308,967 to Stallbaumer et al. ; U.S. Pat. No. 6,341,788 to Ciccone; U.S. Pat. No. 6,877,586 to Babkes et al. ; U.S. Pat. No. 7,464,947 to Corese; U.S. Pat. No. 7,487,976 to Williams; U.S. Pat. No. 8,100,430 to Meyers et al. ; U.S. Pat. No. 8,126,822 to Harrison; U.S. Pat. No. 8,465,046 to Meyers et al. ; U.S. Pat. No. 8,770,598 to Li; U.S. Pat. No. 9,096,251 to Bowden; U.S. Pat. No. 9,150,233 to Su; U.S. Pat. No. 9,776,650 to Berlinger; U.S. Pat. No. 9,810,571 to Su; U.S. Pat. No. 10,182,629 to Naiva; U.S. Pat. No. 10,864,933 to Mendoza; U.S. patent application Ser. No. 13/329,034 to Ryan et al. (published as US 20120153584A1); U.S. patent application Ser. No. 17/478,228 to O'Brien et al. (published as US20220089208 A1); and International Application No. PCT//US2020/021612 to Mendoza (published as WO2020185638 A1), all of which are incorporated by reference herein in their entirety.

A hand truck, commonly referred to as a dolly, is used to transport heavy boxes, articles, or other loads. A conventional hand truck typically includes an elongated, tubular body or frame having a handle mounted or formed at an upper end thereof and a load support platform that extends perpendicularly from a lower end thereof. A pair of wheels connected by an axle are usually mounted behind the load support platform at the lower end of the body or frame. In the use of a conventional hand truck, a user places the hand truck in a rest position, in which the body is vertically oriented to be perpendicular to a ground or floor surface. In this position, the user places one or more boxes or other loads on the load support platform. To maneuver the load, the user tips the hand truck into an inclined position by tilting the body or frame backwardly relative to the load on the platform to thereby elevate the load such that the body and the load are supported on the wheels. In this position, the load support platform is no longer on the ground and the weight of the load is supported by the body or frame and the wheels. As a result, the user can pull or push the load to a desired location.

While a conventional hand truck does aid in the transportation of heavy loads, it does have certain drawbacks. For instance, to maneuver a load, the user must tip the hand truck from the rest position where the weight of the load is supported by the load support platform to the inclined orientation where the weight of the load is supported by the body or frame and the wheels. However, the heavier or bulkier the load, the more difficult it is to tilt the hand truck. Further, during the tilting procedure, the user must brace the hand truck at the lower portion thereof to prevent premature horizontal movement of the hand truck. During tilting, the user must also ensure that the load supported on the support platform is stabilized and tilts backwardly on the body or frame and does not tilt forwardly or laterally relative to the hand truck and thereby fall from a properly seated position on the hand truck. Whenever a center of mass of a load is or becomes spaced beyond a forward or side edge of the support platform, the load will always be tilted away from the body or frame of the hand truck when the hand truck is being tilted to the inclined maneuvering orientation. Therefore, the user must provide sufficient force to retain the load against the body or frame during tilting, while again, preventing any premature horizontal motion of the hand truck. Not only can the user be injured trying to physically control a load placed on the support platform, but if the load falls, then it is possible to damage the load being maneuvered. This problem becomes greater when several items are stacked on the support platform for concurrent movement and when large or heavy objects are being handled.

Also, while a conventional hand truck can be very helpful when moving heavy loads across generally planar surfaces, the conventional hand truck cannot easily traverse obstacles, such as stairs and curbs. To maneuver the hand truck over such obstacles, a user must lift the weight of the load and the hand truck to a position where the axle of the wheels is above the obstacle so that wheels can roll over the obstacle. In other words, apart from a rolling contact of the wheels of a conventional hand truck with the risers of stairs and the like, the conventional hand truck does not provide any mechanical assistance when moving a load over an obstacle, such as a stair or curb.

In addition, a conventional hand truck is prone to tipping when it encounters an irregularity in a ground surface, such as a bump or a pothole, often resulting in spilling the item or items being transported. When one wheel of the conventional hand truck encounters the surface irregularity, the body and the load supporting platform, which is perpendicularly mounted thereto, become laterally angled or tilted. As a result, the skewed load support platform causes the load to slide off the hand truck. Thus, there remains a need for a hand truck that can be more easily and safely tilted from a rest position to an inclined maneuvering orientation. There also exists a need for a hand truck that can easily traverse obstacles, such as stairs and curbs. Additionally, there is a need for a hand truck that remains stable when it encounters an irregularity in a ground surface, such as a bump or a pothole.

Furthermore, while hand trucks have varied over the years depending on factors such as load capacity and specialized use, ergonomics have been overlooked. Existing handlebar arrangements have been used for decades and do not allow for varying loads without adjusting the hand truck configuration. This is not only inconvenient but can be a safety issue when the need to adjust hand positioning arises while moving a load when modification of the device is not possible. There are also limited areas for grasping other parts of existing hand trucks to allow repositioning when changing position or with change in terrain (e.g., stairs).

The toe plate of a hand truck is located at the lower front edge of the truck adjacent to the ground and functions to support the load being transported with a horizontal angular portion cantilevered outward which transmits the weight of the load to the remaining structure of the hand truck. An example of improvements to a toe plate are found in U.S. Pat. No. 6,481,727, incorporated by reference herein in its entirety. The horizontal portion of the toe plate is the most highly stressed part of the hand truck as to any bending loads. Traditionally, toe plates have been either cast aluminum or a welded steel plate fabrication. Because the end of the toe plate must sustain substantial bending loads, light-gauge steel plate has not been utilized until the design of the present invention. Another known aspect of hand trucks is having a sturdy, simple arrangement for a folding toe plate that may be positioned in an extended operating position and in a retracted, folded position. It is particularly useful to have a folding toe plate hand truck with easily removable wheels so that the hand truck may be partially disassembled by removing the wheels and shipped in a low-profile box at a minimum shipping cost. An example of one solution to a repositionable toe plate may be found in U.S. Pat. No. 10,703,397, incorporated by reference herein in its entirety. The '397 Patent also proclaims to provide a novel wheel configuration that allows removal of the wheels that, in combination with the toe plate design, allows for minimizing the depth of the hand truck for shipping. However, there is a need for improved toe plate configurations that allow for better performance, allow for use of accessories such as straps, and provide additional lift handling positions.

Yet a further aspect of existing hand trucks is the ability to convert the hand truck to multiple orientations. For instance, hand trucks can be converted into a dolly or cart position or in an angled orientation such as disclosed in U.S. Pat. No. 10,864,933, incorporated herein by reference in its entirety. This capability allows the carried load to be shared among four wheels instead of the standard two wheels for an upright hand truck. The angled orientation allows for the bulk of the carried load to be carried by the main wheels while allowing for more stability and control of the carried load. These type of hand trucks are commonly used for taller, bulkier items such as appliances and, therefore are commonly referred to as “appliance hand trucks.” Convertibility also requires a means of locking the hand truck in the different orientations. An example of a latching mechanism for this purpose may be found in U.S. Pat. No. 11,472,461, incorporated herein by reference in its entirety.

There are a number of drawbacks to existing material handling devices. Appliance and utility hand trucks tend to be heavy to account for structural integrity. U.S. Pat. No. 5,749,588, incorporated herein by reference in its entirety, addresses weight by providing a frame construction molded of high strength plastic. However, the use of plastics limits the load capacity of the hand truck. Further, appliance and utility hand trucks are foldable, which makes them awkward for storing. Whereas convertible hand trucks tend to have limited weight capacity because they tend to be lighter weight and more maneuverable than appliance or utility hand trucks. Another drawback of current hand trucks is their limited maneuverability in tight spaces. Other issues with known material handling devices include cost of manufacturing, difficulty in replacing parts, lack of or poor positioning of strapping anchors, difficulty in transfiguring convertible hand trucks, and sub-optimal balancing in relation to the wheels. The present disclosure addresses these concerns.

### SUMMARY OF THE INVENTION

The disclosed invention provides a variety of material handling devices that overcome the above-cited shortcomings of prior-art material handling devices. The example embodiments described hereafter relate generally to improvements in hand trucks and more particularly, but not by way of limitation, to hand truck structural framing, ergonomics, convertibility, storage, load-bearing, cost of manufacturing, shipping, and lifespan.

With particularity, one embodiment has an improved toe plate support structure and geometry to better hold a carried load and improve storability and conversion. Further embodiments include the method of manufacturing a toe plate, coining that tapers to the front of the toe plate to provide strength while narrowing the thickness of the plate at the front where it needs to slide under a load. Yet another embodiment directed to toe plates is integrating wheel guards in the toe plate and attaching the toe plate to the hand truck frame uprights with bolts. Further improvements include strategically placed openings in the toe plates that can be used for strapping loads to the device, using a hook to assist in lifting the front of the device, or to actually allow hands to grip the toe plate for lifting. Folding toe plates allow for the overall depth of the device to be less than twelve inches for easier storage. One embodiment is provided in FIGS. 91-106. Detents may be used to lock the folding toe plate in the stored or use orientation. Another embodiment includes the use of a narrower support plate beneath the folding portion of the toe plate to provide strength while allowing the toe plate itself to be made of thinner material and easier to manipulate/hold in position. See, e.g., FIGS. 50-63. Embodiments of various toe plate improvements are provided in FIGS. 1-99.

Yet another embodiment allows for adjustment to multiple heights instead of the standard two. See, e.g., FIGS. 50-63 . A further embodiment utilizes a C-Channel for crossbars that have angled bends instead of curved to increase strength of the hand truck while allowing for better load retention of curved loads such as cylinders, barrels, water bottles, etc. Preferably the depth of the angled bends is approximately 1.7 inches to provide optimal load retention without sacrificing strength. See, e.g., FIGS. 1-7. A further embodiment includes replaceable stair guards that also function as handle grips on the crossbars that provide recognized handling points along the length of the hand truck and to improve comfort at those handling points. The grips are preferably formed to fit inside the C-Channels to improve durability and are bolted in to allow for replacement for wear. See, e.g., FIGS. 8-14.

Another embodiment of the material handling devices include modularity to allow for replacement of wear parts such as axles and wheels. This embodiment provides an improved wheel axle arrangement that allows the axle to be easily moved and replaced while providing extra strength and stiffness to the axle. See, e.g., FIGS. 1-14. The arrangement further improves the strength and stiffness of the hand truck by fitting the axle shaft geometry to that of the rear braces. See, e.g., FIGS. 1-7. Another embodiment includes wheel supports inside the frame of the hand truck that allow the wheelbase to be narrower for moving down hallways or between rows in a warehouse. See, e.g., FIGS. 8-14.

Additional embodiments provide improved handle orientations that allow for optimum handling of the hand truck in various positions and for easier changing of gripping while transporting a load. One embodiment provides a flared loop that allows for the hand truck to be gripped on the outside of the handle or behind the handle. See, e.g., FIGS. 64-99. Another embodiment provides a handle that curves backward to more easily change grip while working with taller loads. See, e.g., FIGS. 1-7. Yet another embodiment of an improved handle includes angled straight sections at the top corners of the handle that are more ergonomic. See, e.g., FIGS. 36-49.

Other embodiments address the materials of manufacture and their arrangement on the hand truck. One embodiment includes extruded aluminum channels for uprights that allow a rubber bumper to be inserted along the length of the upright for more durability than attaching with adhesive or screws. See, e.g., FIGS. 43-49. Another embodiment utilized overmolded plastic handles that can be bolted on for better retention on the hand truck and easier replacement. See, e.g., FIGS. 8-14. Another aspect of the handles is that their geometry allows for the face on the ground surface and provide a support leaves the hand truck substantially parallel to the ground for either stacking on top of or merely for storage of the device.

A further embodiment includes strap loops on the rear upright of the hand truck to provide both load tie-down locations as well as storage of cords or other materials used to tie down carried loads. See, e.g., FIGS. 8-14. An additional embodiment includes having more than two levels of height adjustment for the upright portion of the hand truck as well as having a single J-lock mechanism. See, e.g., FIGS. 22-35. Another embodiment includes the use of bushings on both the top of the upper wheel structure as well as the top of the upright to provide two tight points of contact for the movable handle that provides strength and eliminates play in the handle. Id. A further embodiment includes an axle bushing that also functions as a visible foot grip to assist in tipping the hand truck. Id. Another improvement is the use of tabs on the bushings to secure them inside the handle and frame structures. A further embodiment includes the use of a coned plug at the end of the handle tubing to allow for easier insertion into the frame when changing the orientation of the cart. An additional embodiment includes having support for the casters of the device outside the upright frame for a wider footprint on the handle side of the device in a cart orientation and allows for the front and rear wheels to be aligned to allow for better load distribution and balance. See, e.g., FIGS. 22-35. A further embodiment utilizes the axle between the caster supports as an additional grab bar for handling the device. Id.

An additional embodiment of a hand truck includes a device that can convert into multiple orientations for use as a dolly with or without toe plate extended, as a hand truck, or as an appliance hand truck. See, e.g., FIGS. 64-106. One embodiment includes a hand lock mechanism to quickly and easily unlock the legs/handle portion of the device to change device orientation. Id. The lock mechanism uses a leaf or torsion spring on each upright to bias the lock bar out of the locked position. This lessens the force necessary to release the lock and is accomplished by having the push mechanism biased by the spring and is shaped to move the lock bar out of the shape of the lock plates. Another aspect of this embodiment is that the weight and configuration of the handle and lock mechanism allow the lock to engage when the handle is dropped from a height of only a couple of feet. This design also has the advantage of the user easily being able to observe whether the legs/handle are in a locked or unlocked orientation.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

FIG. 1 depicts a perspective view of an embodiment of a material handling device.

FIG. 2 depicts a front elevation view of the material handling device of FIG. 1.

FIG. 3 depicts a rear elevation view of the material handling device of FIG. 1.

FIG. 4 depicts a left-side elevation view of the material handling device of FIG. 1.

FIGS. 4A-4B depict a left-side elevation view of the frame of the material handling device of FIG. 1 and an exploded view of the center axle bushing and axle tube of the material handling device of FIG. 1.

FIG. 5 depicts a right-side elevation view of the material handling device of FIG. 1.

FIG. 6 depicts a top plan view of the material handling device of FIG. 1.

FIG. 7 depicts a bottom plan view of the material handling device of FIG. 1.

FIG. 8 depicts a perspective view of another embodiment of a material handling device.

FIG. 9 depicts a front elevation view of the material handling device of FIG. 8.

FIG. 10 depicts a rear elevation view of the material handling device of FIG. 8.

FIG. 11 depicts a left-side elevation view of the material handling device of FIG. 8.

FIG. 12 depicts a right-side elevation view of the material handling device of FIG. 8.

FIG. 13 depicts a top plan view of the material handling device of FIG. 8.

FIG. 14 depicts a bottom plan view of the material handling device of FIG. 8.

FIG. 15 depicts a perspective view of an additional embodiment of a material handling device.

FIG. 16 depicts a front elevation view of the material handling device of FIG. 15.

FIG. 16A is a cross section of the side rail and rail bumper taken along A-A in FIG. 16.

FIG. 17 depicts a rear elevation view of the material handling device of FIG. 15.

FIG. 17A is a cross section of the cross brace taken along B-B in FIG. 17.

FIG. 18 depicts a left-side elevation view of the material handling device of FIG. 15.

FIG. 19 depicts a right-side elevation view of the material handling device of FIG. 15.

FIG. 20 depicts a top plan view of the material handling device of FIG. 15.

FIG. 21 depicts a bottom plan view of the material handling device of FIG. 15.

FIG. 22 depicts a perspective view of a further embodiment of a material handling device in an upright or hand truck orientation.

FIG. 23 depicts a front elevation view of the material handling device of FIG. 22.

FIG. 24 depicts a rear elevation view of the material handling device of FIG. 22.

FIG. 25 depicts a left-side elevation view of the material handling device of FIG. 22.

FIG. 26 depicts a right-side elevation view of the material handling device of FIG. 22.

FIG. 27 depicts a top plan view of the material handling device of FIG. 22.

FIG. 28 depicts a bottom plan view of the material handling device of FIG. 22.

FIG. 29 depicts a perspective view of the embodiment of FIG. 22 in a dolly or cart orientation.

FIG. 30 depicts a front elevation view of the material handling device of FIG. 29.

FIG. 31 depicts a rear elevation view of the material handling device of FIG. 29.

FIG. 32 depicts a left-side elevation view of the material handling device of FIG. 29.

FIG. 33 depicts a right-side elevation view of the material handling device of FIG. 29.

FIG. 34 depicts a top plan view of the material handling device of FIG. 29.

FIG. 35 depicts a bottom plan view of the material handling device of FIG. 29.

FIG. 36 depicts a perspective view of yet another embodiment of a material handling device in an upright or hand truck orientation.

FIGS. 36A-C depict a left side elevation view, a front elevation view, a top plan view, and an isometric view of an embodiment of a latch release of the material handling device of FIG. 36.

FIG. 37 depicts a front elevation view of the material handling device of FIG. 36.

FIGS. 37A-C depict an isometric view, a left side elevation view, and a cross section of the bracket tube taken along C-C in FIG. 37B of an embodiment of a latch release of the material handling device of FIG. 37.

FIG. 38 depicts a rear elevation view of the material handling device of FIG. 36.

FIG. 39 depicts a left-side elevation view of the material handling device of FIG. 36.

FIG. 40 depicts a right-side elevation view of the material handling device of FIG. 36.

FIG. 41 depicts a top plan view of the material handling device of FIG. 36.

FIG. 42 depicts a bottom plan view of the material handling device of FIG. 36.

FIG. 43 depicts a perspective view of the embodiment of FIG. 36 in a dolly or cart orientation.

FIG. 44 depicts a front elevation view of the material handling device of FIG. 43.

FIG. 45 depicts a rear elevation view of the material handling device of FIG. 43.

FIG. 46 depicts a left-side elevation view of the material handling device of FIG. 43.

FIG. 47 depicts a right-side elevation view of the material handling device of FIG. 43.

FIG. 48 depicts a top plan view of the material handling device of FIG. 43.

FIG. 49 depicts a bottom plan view of the material handling device of FIG. 43.

FIG. 50 depicts a perspective view of a material handling device with extendable handle and folding toe plate in a storage orientation.

FIG. 52 depicts a front elevation view of the material handling device of FIG. 50.

FIG. 52 depicts a rear elevation view of the material handling device of FIG. 50.

FIG. 53 depicts a left-side elevation view of the material handling device of FIG. 50.

FIG. 54 depicts a right-side elevation view of the material handling device of FIG. 50.

FIG. 55 depicts a top plan view of the material handling device of FIG. 50.

FIG. 56 depicts a bottom plan view of the material handling device of FIG. 50.

FIG. 57 depicts a perspective view of the embodiment of FIG. 50 with the handle extended and toe plate open.

FIG. 58 depicts a front elevation view of the material handling device of FIG. 57.

FIG. 59 depicts a rear elevation view of the material handling device of FIG. 57.

FIG. 60 depicts a left-side elevation view of the material handling device of FIG. 57.

FIG. 61 depicts a right-side elevation view of the material handling device of FIG. 57.

FIG. 62 depicts a bottom plan view of the material handling device of FIG. 57.

FIG. 63 depicts a top plan view of the material handling device of FIG. 57.

FIG. 64 depicts a perspective view of a 4-in-1 material handling device in an upright or hand truck orientation.

FIG. 65 depicts a front elevation view of the material handling device of FIG. 64.

FIG. 66 depicts a rear elevation view of the material handling device of FIG. 64.

FIG. 67 depicts a left-side elevation view of the material handling device of FIG. 64.

FIG. 68 depicts a right-side elevation view of the material handling device of FIG. 64.

FIG. 69 depicts a top plan view of the material handling device of FIG. 64.

FIG. 70 depicts a bottom plan view of the material handling device of FIG. 64.

FIG. 71 depicts a perspective rear view of the locking mechanism of the device of FIG. 64.

FIG. 72 depicts a section view of the locking mechanism of the device of FIG. 64 taken along A-A in FIG. 66.

FIG. 73 depicts a perspective view of the embodiment of FIG. 64 in a dolly or cart orientation.

FIG. 74 depicts a front elevation view of the material handling device of FIG. 64.

FIG. 75 depicts a rear elevation view of the material handling device of FIG. 64.

FIG. 76 depicts a left-side elevation view of the material handling device of FIG. 64.

FIG. 77 depicts a right-side elevation view of the material handling device of FIG. 64.

FIG. 78 depicts a top plan view of the material handling device of FIG. 64.

FIG. 79 depicts a bottom plan view of the material handling device of FIG. 64.

FIG. 80 depicts a perspective rear view of the locking mechanism of the device of FIG. 73.

FIG. 81 depicts a section view of the locking mechanism of the device of FIG. 73 taken along B-B in FIG. 79.

FIG. 82 depicts a perspective view of the embodiment of FIG. 64 in an appliance hand truck orientation.

FIG. 83 depicts a front elevation view of the material handling device of FIG. 64.

FIG. 84 depicts a rear elevation view of the material handling device of FIG. 64.

FIG. 85 depicts a left-side elevation view of the material handling device of FIG. 64.

FIG. 86 depicts a right-side elevation view of the material handling device of FIG. 64.

FIG. 87 depicts a top plan view of the material handling device of FIG. 64.

FIG. 88 depicts a bottom plan view of the material handling device of FIG. 64.

FIG. 89 depicts a perspective rear view of the locking mechanism of the device of FIG. 82.

FIG. 90 depicts a section view of the locking mechanism of the device of FIG. 82 taken along C-C in FIG. 84.

FIG. 91 depicts a right perspective view of the toe plate for the embodiment of FIG. 64 in the fully raised/storage orientation.

FIG. 92 depicts a rear elevation view of the toe plate of FIG. 91.

FIG. 93 depicts a right elevation view of the toe plate of FIG. 91.

FIG. 94 depicts a right perspective view of the toe plate for the embodiment of FIG. 64 in the partially folded orientation.

FIG. 95 depicts a rear elevation view of the toe plate of FIG. 94.

FIG. 96 depicts a right elevation view of the toe plate of FIG. 94.

FIG. 97 depicts a right perspective view of the toe plate for the embodiment of FIG. 64 in the fully deployed/use orientation.

FIG. 98 depicts a rear elevation view of the toe plate of FIG. 97.

FIG. 99 depicts a right elevation view of the toe plate of FIG. 97.

FIG. 100 depicts a perspective view of the toe plate for the embodiment of FIG. 64.

FIG. 101 depicts a front elevation view of the toe plate of FIG. 100.

FIG. 102 depicts a rear elevation view of the toe plate of FIG. 100.

FIG. 103 depicts a left-side elevation view of the toe plate of FIG. 100.

FIG. 104 depicts a right-side elevation view of the toe plate of FIG. 100.

FIG. 105 depicts a top plan view of the toe plate of FIG. 100.

FIG. 106 depicts a bottom plan view of the toe plate of FIG. 100.

While the various embodiments of the invention are amenable to various modifications and alternative forms, specifics thereof have been shown by way of example in the drawings and will be described in detail. It should be understood, however, that the intention is not to limit the invention to the embodiments described. On the contrary, the intention is to cover all modifications, equivalents, and alternatives falling within the spirit and scope of the inventions as may be claimed.

### DETAILED DESCRIPTION OF THE PREFERRED EMBODIMENTS

The present invention is various embodiments of a material handling device 100, 200, 300, 400, 600, and 1000.

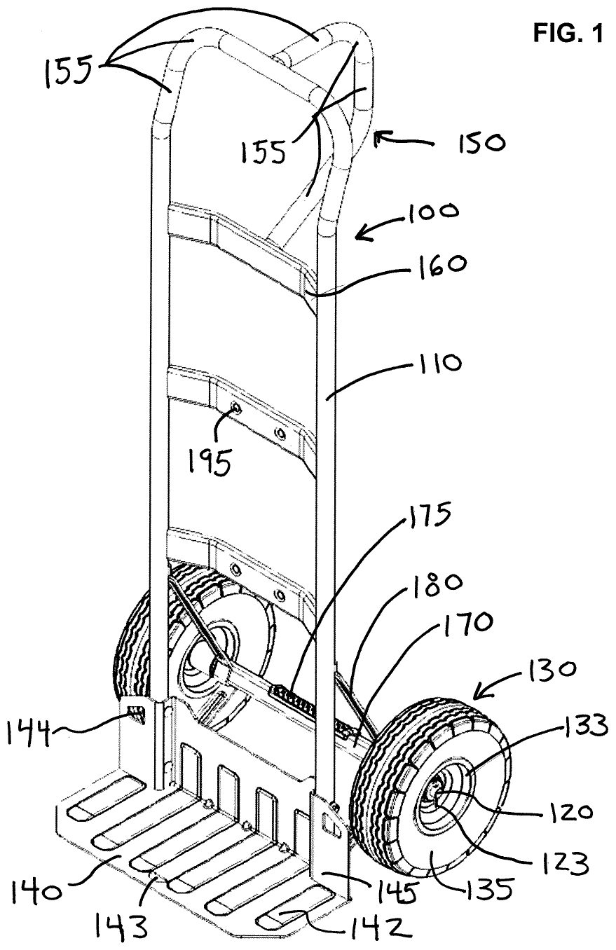

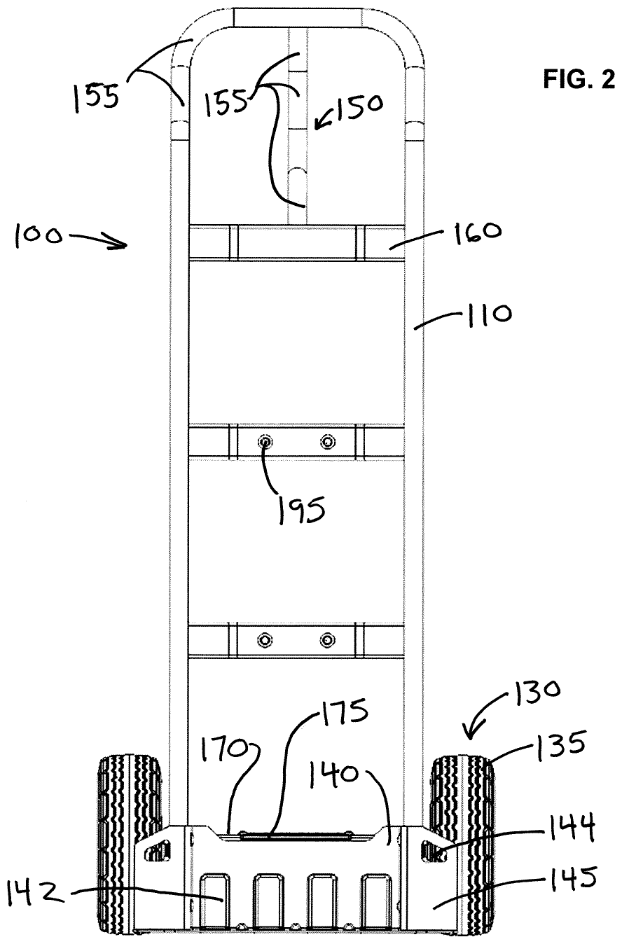

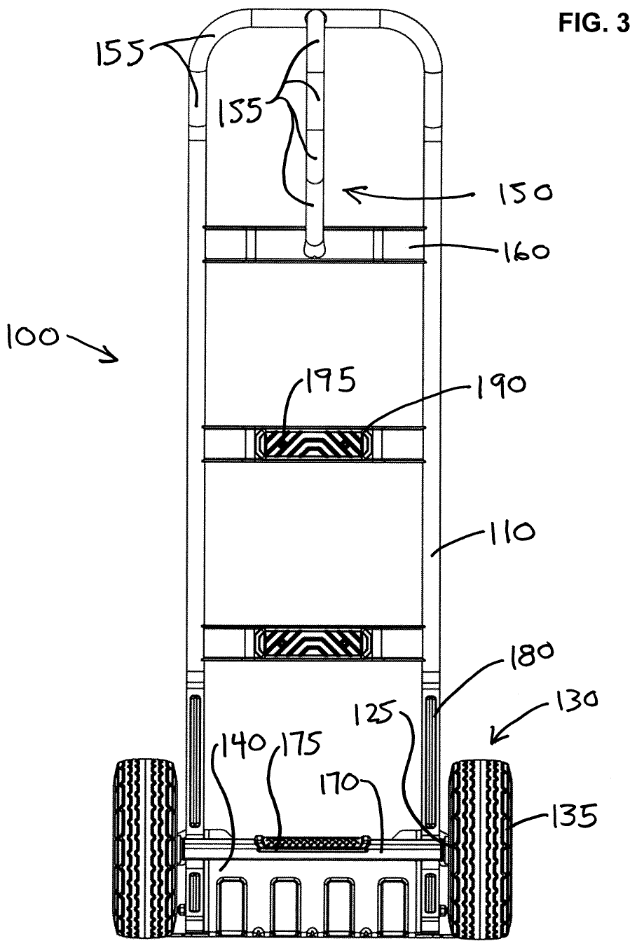

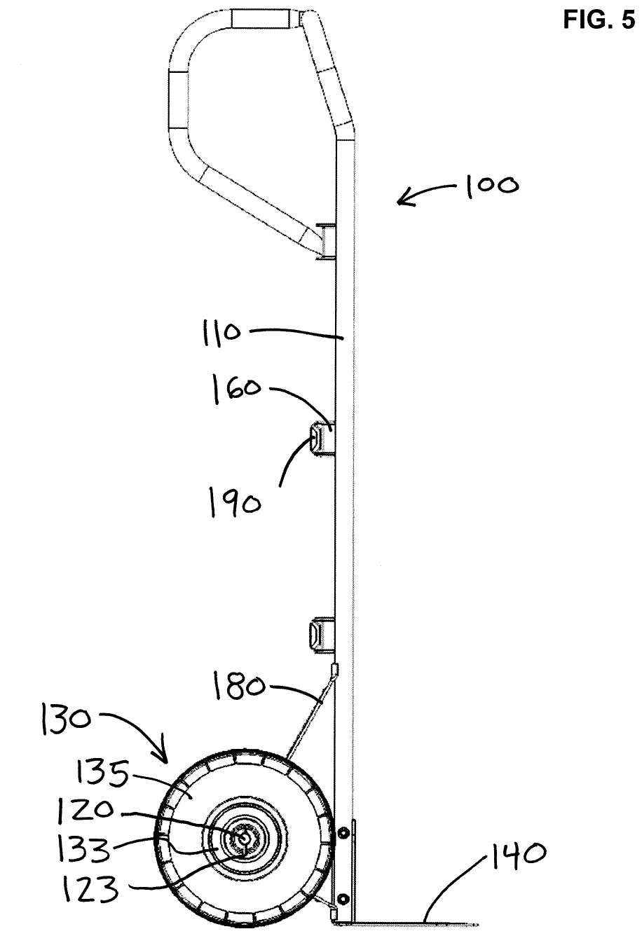

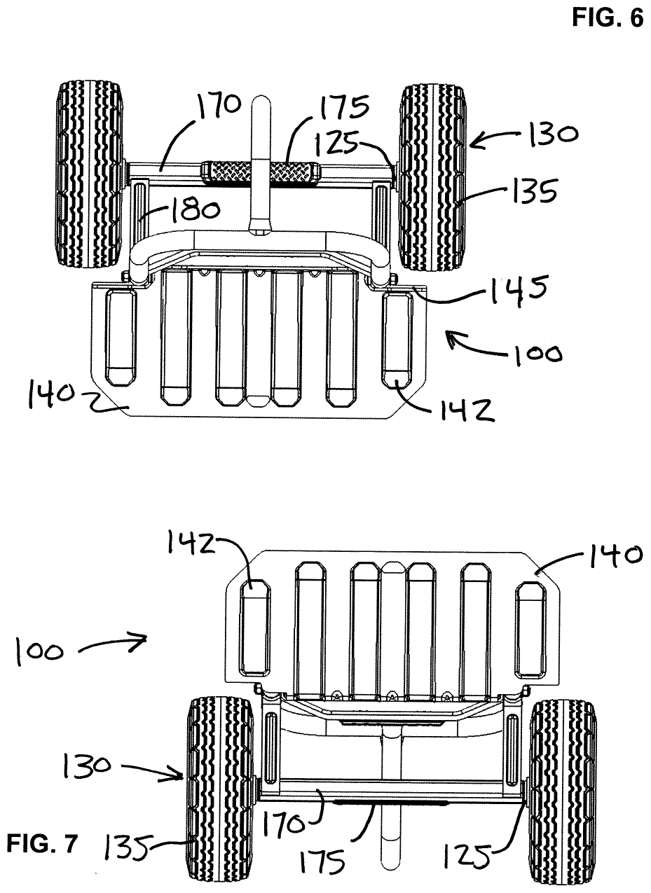

One embodiment of a material handling device 100 of the present invention is illustrated in FIGS. 1-7. The material handling device 100 has a frame 110 with a handle 150, a toe plate 140, an axel 120, and a pair of wheels 130. The frame, 110, handle 150, toe plate 140, and cross braces 160 are preferably made from steel with the axle 120 being made from high strength structural steel. In this embodiment the frame 110 is a loop formed of tubing with a p-shaped handle 150 welded to the frame 110 and to a cross brace 160. The handle 150 and top of the frame 110 may include grips 155 to assist in handling the material handling device 100. Grips 155 may be texturing of the handle 150 or frame 110, such as knurls, or may be rubber, plastic, or any other material known in the art. While the preferred embodiment uses welding to attach the handle 150 to the frame 110 and cross brace 160, any means known in the art such as bolts, are considered to be within the scope of the invention.

One or more cross braces 160 add structural stability and strength to the material handling device 100 while also providing a support for items that are transported by the material handling device 100. In this embodiment, the cross braces 160 form a concave shape facing the toe plate 140 to better secure loads and include lift grips 190 that is preferably attached to the cross braces 160 with rivets 195 to provide a more comfortable grasping area for lifting the material handling device 100. The cross braces 160 are preferably made of steel and welded to the frame 110. The lift grips 190 are preferably made of rubber or plastic for comfort and durability, but can be made of any material known in the art. While rivets 195 are the preferred method of attachment because it allows for easy replacement of the lift grips 190 for wear or damage, any means known in the art such as bolts or adhesive.

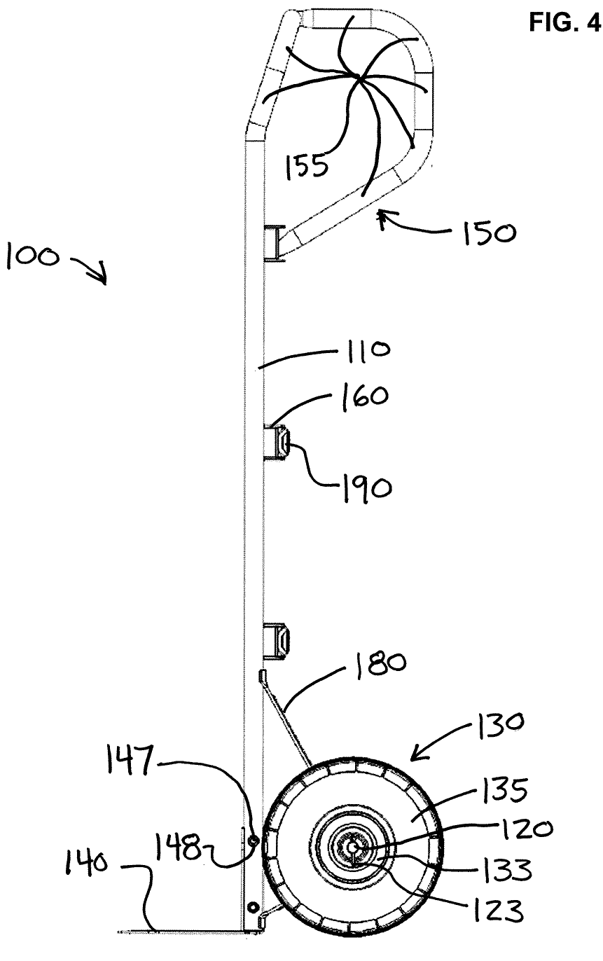

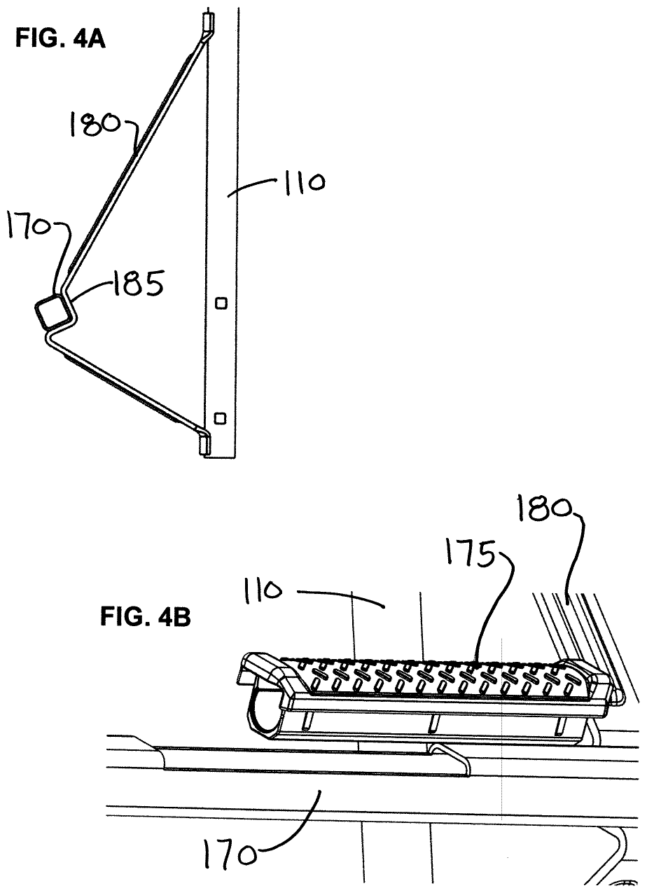

The axle 120 of the embodiment of FIGS. 1-7 is housed in an axel tube 170 having a preferably square cross section for strength that is attached to the frame 110 by axle brackets 180. As best seen in FIG. 4A, each axle bracket 180 has a square axle tube inset 185 that is sized to accommodate the axle tube 170. While it is preferable to have a square axle tube 170 and axle tube inset 185, any shape may be used.

To support the axle 120 within the axle tube 170, a center axle bushing 175 is inserted in the center of the axle tube 170 and axle bushings 125 are located at the outer extremities of the axle tube 170. These bushings 125, 175 are preferably made of polypropylene to provide adequate support and cushion for the axle 120. As best seen in FIG. 4B, the center axle bushing 175 is exposed at the top and rear exterior of the axle tube 170 to also provide a textured foot lever for aid in tipping the material handling device 100. This is accomplished by having the center axle bushing 175 sit within a cavity 177 in the axle tube 170 sized to tightly fit the bushing 175.

Wheels 130 each comprise a rim 133 and tire 135 are attached at either end of the axle 120, preferably by a cotter pin 123. Other means known in the art may be used to attach the wheels 130 to the axle 120 and the wheels 130 may be a single body instead of separate rim 133 and tire 135. Preferably the tires 135 are rubber and pneumatic while the rims 135 are steel. However, other materials may be used for both the tires 135 and rims 133 for specific needs.

The toe plate 140 of the embodiment of FIGS. 1-7 is attached to ends of the frame 110, preferably by bolts 147 and nuts 148, but may be welded or attached by any other means known in the art. The toe plate 140 is sized width-wise to extend to the approximate midpoint of each wheel 130. The portions of the upright portion of the toe plate 140 from the interior of the frame 110 to the outer extremity of the toe plate 140 form a wheel guard 145, which prevents cargo being transported with the material handling device 100 from contacting the wheels 130. The upper portion of each wheel guard 145 preferably includes a strap orifice 144 to allow straps, bungie cords, etc. to secure cargo to the material handling device 100. The front of the toe plate 140 includes a lift orifice 143 that allows a hook or strap to be attached to the toe plate 140 for lifting the front part of the material handling device 100. The toe plate 140 may include coining 142 to provide strength and the toe plate 140 is sized and configured to inset within the frame 110 depth. The central portion of the top of the toe plate 140 upright set at a height that is at or below the height of the center axle bushing 175 to prevent interference with a user's foot. For strength and durability, the toe plate 140 of the preferred embodiment is a unibody construction by welding to eliminate the need for connections other than bolts 147 and nuts 148.

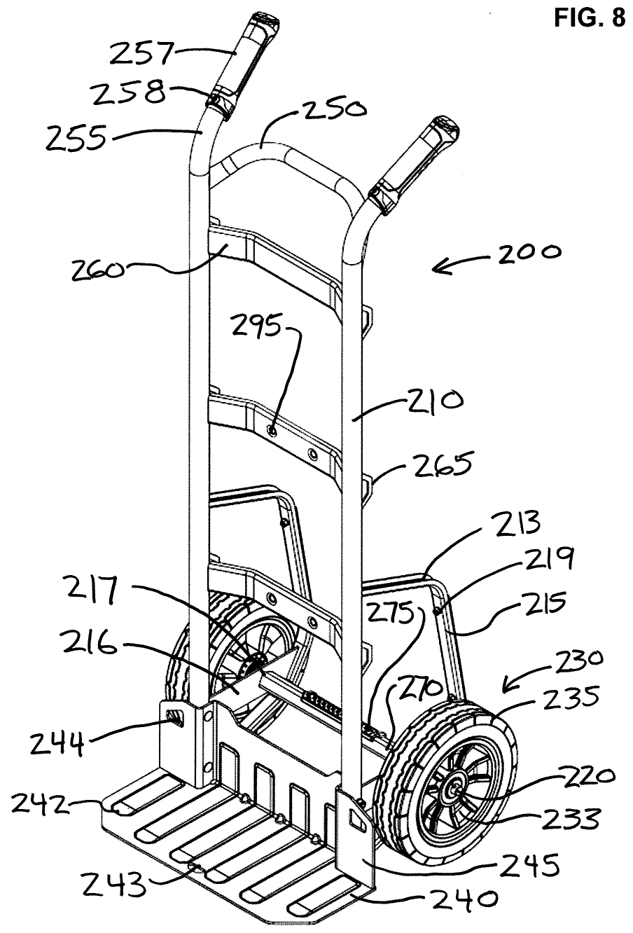

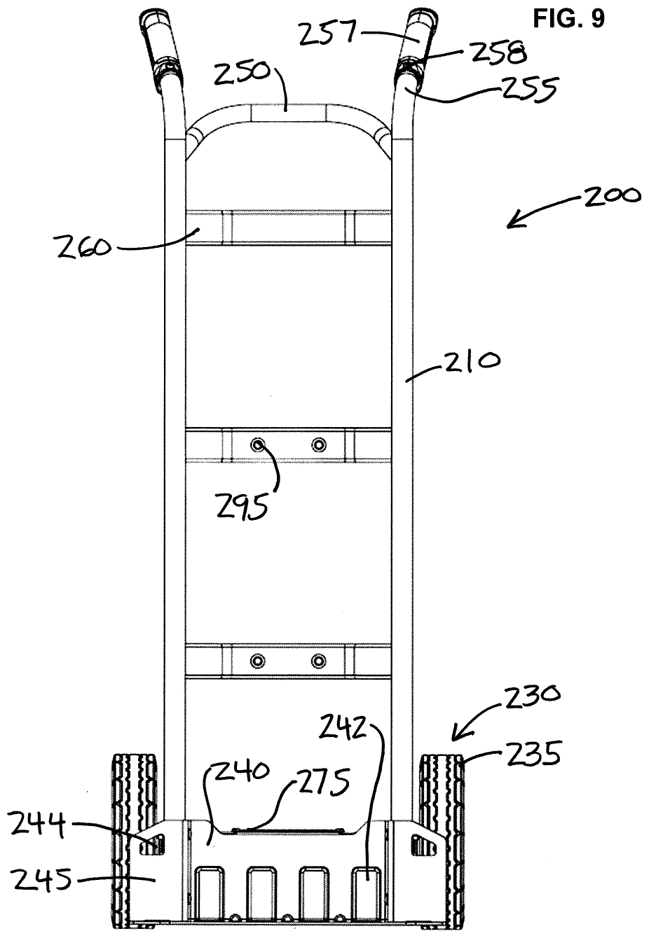

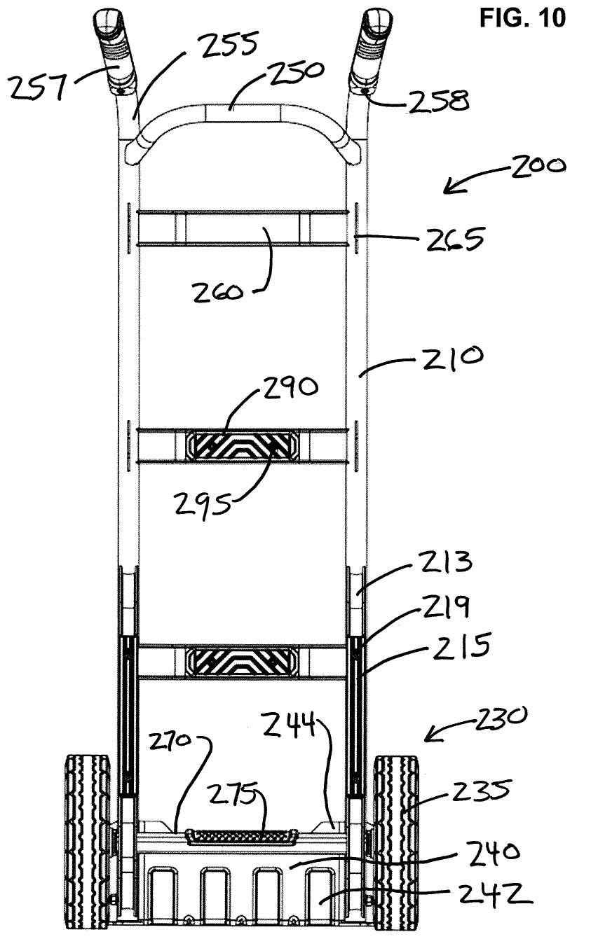

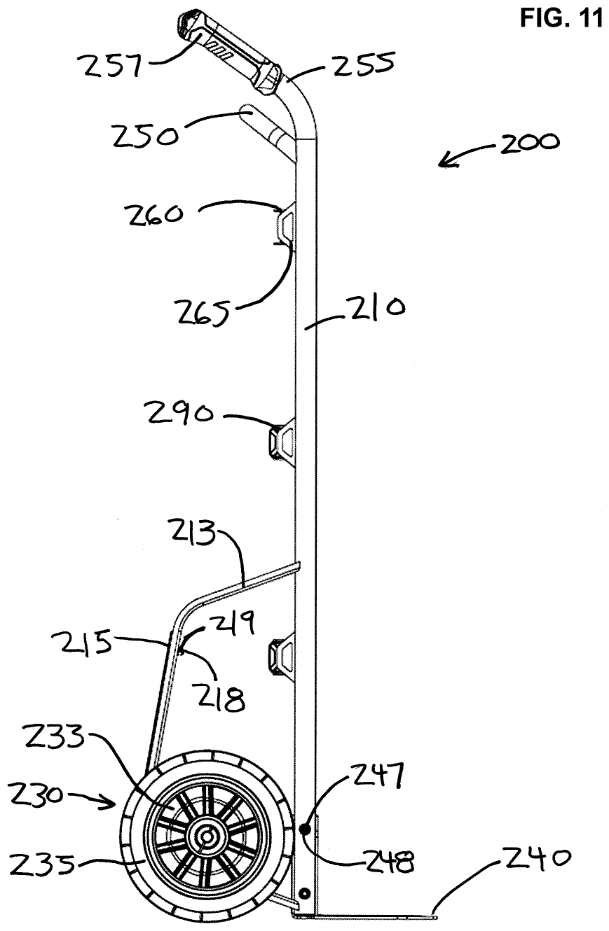

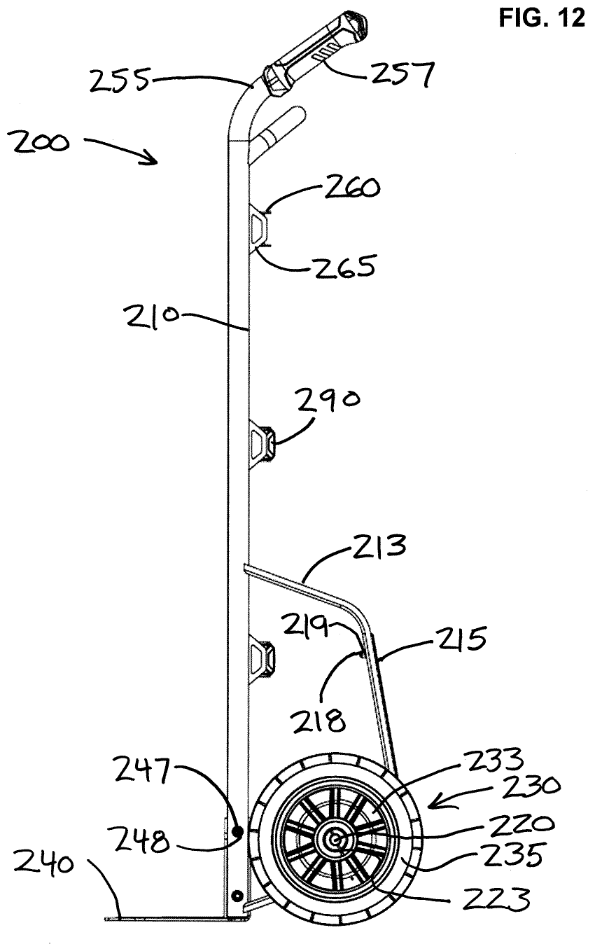

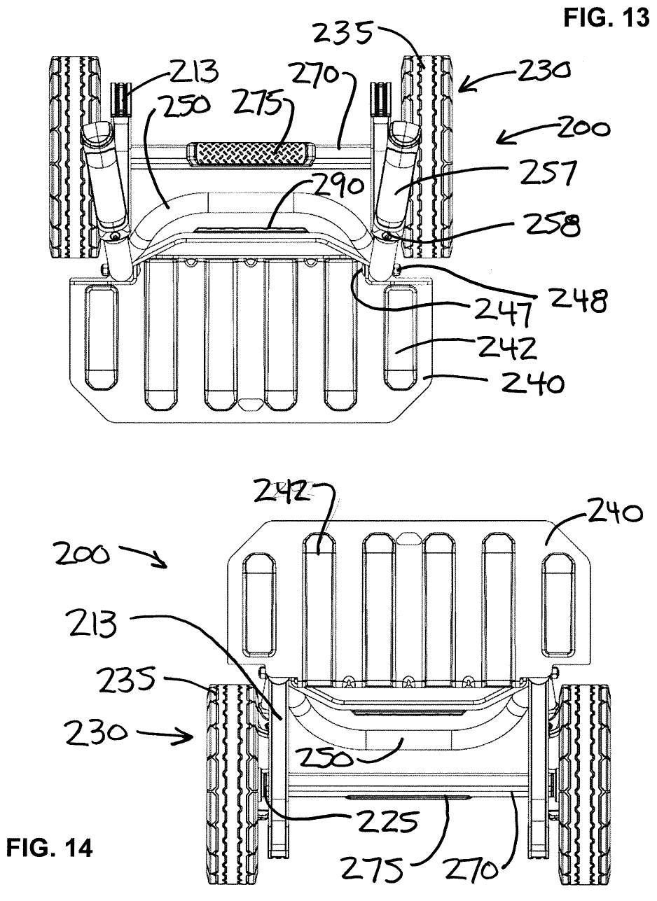

Another embodiment of a material handling device 200 of the present invention is illustrated in FIGS. 8-14. The material handling device 200 is heavier duty than the embodiment of FIGS. 1-7, but with many of the same features. The material handling device 200 has a frame 210 with a handle 250, grips 255, cross braces 260, a toe plate 440, an axle 220, and a pair of wheels 230. The frame, 210, handle 250, grips 255, toe plate 240, and cross braces 160 are preferably made from steel with the axle 220 being made from high strength structural steel. In this embodiment the frame 210 is made of a pair of uprights with the toe plate 240 attached to the lower end of the uprights, preferably with bolts 247 and nuts 247, but may be attached by any means known in the art. Grips 255 are attached to the top end of the uprights and the handle 250 is attached proximate the top of the uprights, with all connections preferably being welds but can be any means known in the art.

To facilitate comfort and hold, it is preferable that grip sleeves 257 made of polypropylene with a thermoplastic vulcanizate overmold are attached to the grips 255 via rivets 258. The materials for the grip sleeves 257 and means of attaching to the grips 255 may be any known in the art. The handle 250 may be textured, such as with knurls, to provide improved comfort and hold or may be covered in rubber, plastic, or any other material known in the art.

One or more cross braces 260 add structural stability and strength to the material handling device 200 while also providing a support for items that are transported by the material handling device 100. In this embodiment, the cross braces 160 form a concave shape facing the toe plate 240 to better secure loads and include lift grips 290 that is preferably attached to the cross braces 260 with rivets 295 to provide a more comfortable grasping area for lifting the material handling device 200. The cross braces 260 are preferably made of steel and welded to the frame 210. As with the embodiment of FIGS. 1-7, the lift grips 290 are preferably made of rubber or plastic for comfort and durability, but can be made of any material known in the art. And, while rivets 295 are the preferred method of attachment because it allows for easy replacement of the lift grips 290 for wear or damage, any means known in the art such as bolts or adhesive.

Similar to the embodiment of FIGS. 1-7, the axle 220 of the embodiment of FIGS. 8-14 is housed in an axel tube 270 having a preferably square cross section for strength and having a center axle bushing 275 with axle bushings 225 at the extremities of the axle tube 270. However, in this embodiment the axle tube 270 is attached to the frame 210 by frame axle supports 216, which have frame axle support orifices 217 sized to accommodate the cross section of the axle tube 270. The frame axle supports 216 are attached at one end to the uprights of the frame 210 and at the other end to frame axle brackets 213, which are each attached to the frame 210 above and below their respective frame axle supports 216. All these connections are preferably welding, but may be accomplished by any means known in the art. The frame axle brackets 213 are dimensioned to aid in using the material handling device 200 on stairs. The longer upright and angle of the rear portion of the brackets 213 provides a surface upon which the material handling device 200 may be dragged along steps. To facilitate dragging and to protect stair surfaces, a stair climber runner 215 is attached on the portion of each bracket 213, preferably with bolts 218 and nut 219 that allow for replacement of the runner 215 when worn or damaged.

Wheels 230 each comprise a rim 233 and tire 235 are attached at either end of the axle 220, preferably by a cotter pin 223. Other means known in the art may be used to attach the wheels 230 to the axle 220 and the wheels 230 may be a single body instead of separate rim 233 and tire 235. Preferably, the tires 235 are rubber and pneumatic while the rims 235 are steel. However, other materials may be used for both the tires 235 and rims 233 for specific needs.

The toe plate 240 of the embodiment of FIGS. 8-14 uses the same toe plate 240 as of the embodiment of FIGS. 1-7. The toe plate 240 is attached to ends of the frame 210, preferably by bolts 247 and nuts 248, but may be welded or attached by any other means known in the art. The toe plate 240 is sized width-wise to extend to the approximate midpoint of each wheel 230. The portions of the upright portion of the toe plate 240 from the interior of the frame 210 to the outer extremity of the toe plate 240 form a wheel guard 245, which prevents cargo being transported with the material handling device 200 from contacting the wheels 230. The upper portion of each wheel guard 245 preferably includes a strap orifice 244 to allow straps, bungie cords, etc. to secure cargo to the material handling device 200. The front of the toe plate 240 include a lift orifice 243 that allows a hook or strap to be attached to the toe plate 240 for lifting the front part of the material handling device 200. The toe plate 240 may include coining 242 to provide strength and the toe plate 240 is sized and configured to inset within the frame 210 depth. The central portion of the top of the toe plate 240 upright set at a height that is at or below the height of the center axle bushing 275 to prevent interference with a user's foot.

The material handling device 200 of FIGS. 8-14 also include strap loops 265 attached on the rear of the uprights of the frame 210, preferably at the same elevations as the cross tubes 260, to attach straps, bungie cords, etc. for securing cargo to the material handling device 200. The strap loops 265 are preferably made of the same steel as the frame 210 and welded to the frame 210. However, the strap loops 265 may also be made of any appropriate material and attached by any means known in the art. It is also preferable that the strap loops 265 to not extend in depth beyond the cross braces 260 and lift grips 290.

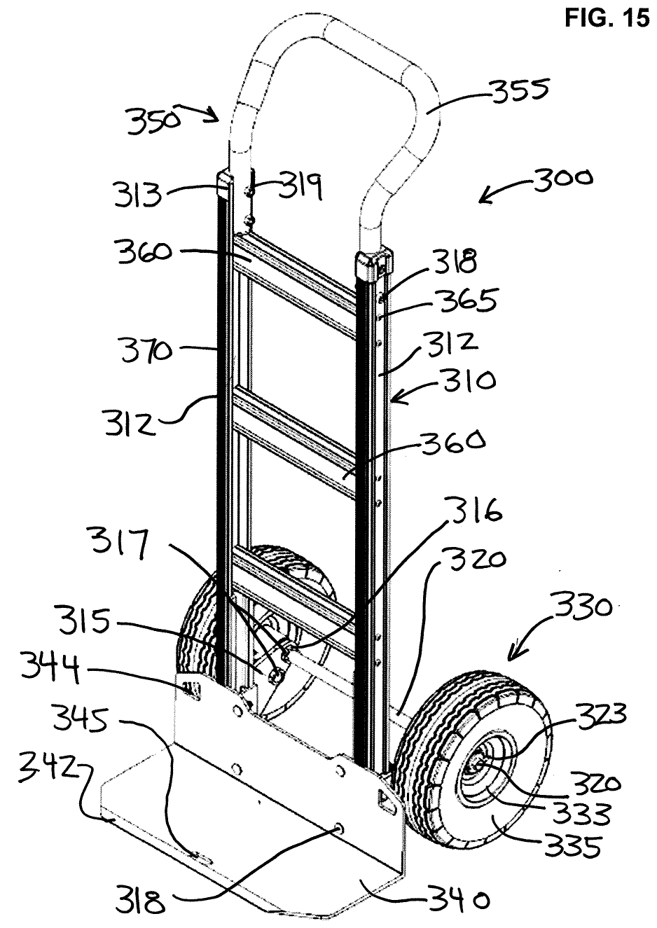

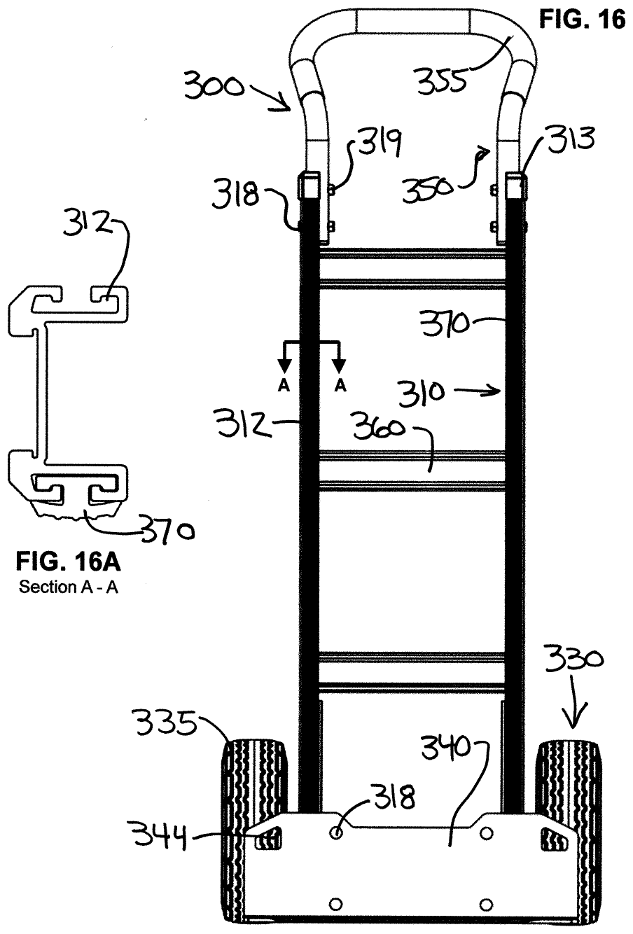

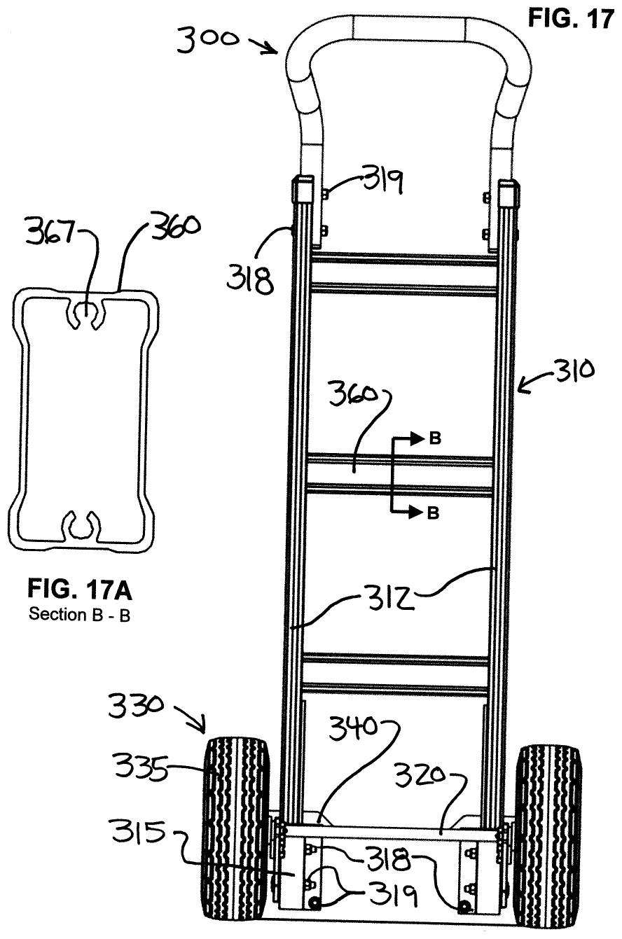

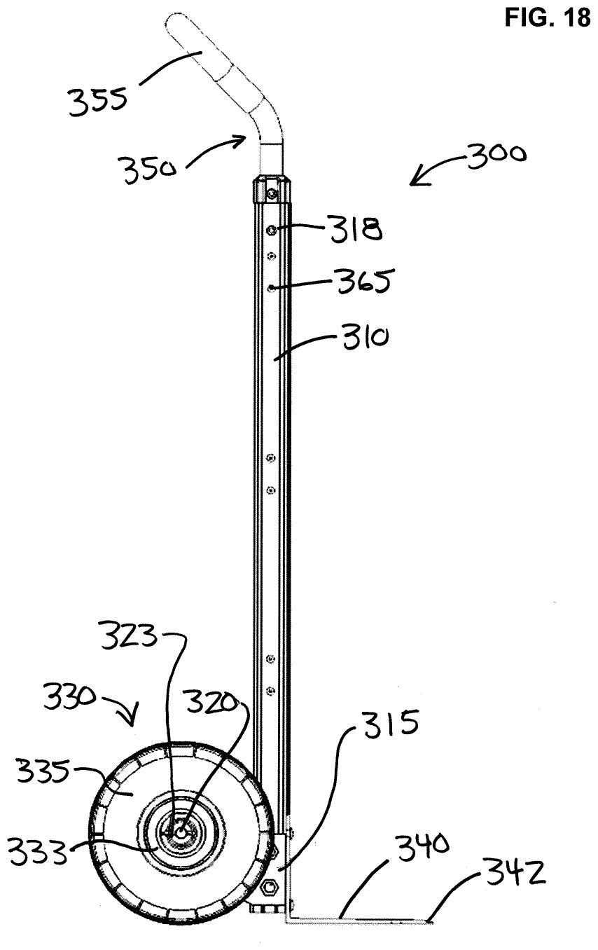

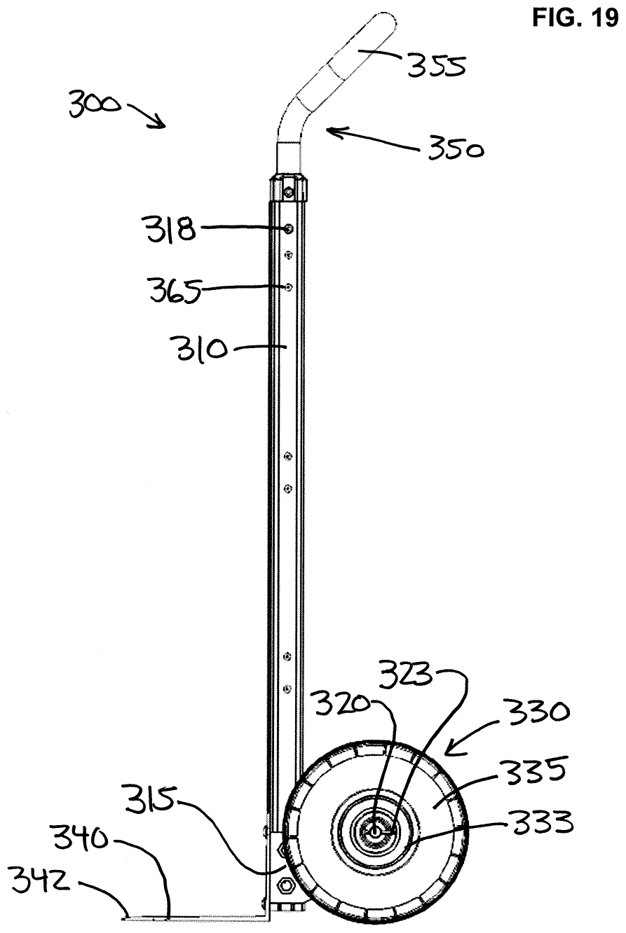

A further embodiment of a material handling device 300 of the present invention, being mostly constructed of aluminum structural parts, is illustrated in FIGS. 15-21. The frame 310 comprises two side rails 312 that are preferably extruded 6063-T6 aluminum with a C-channel cross section as illustrated in FIG. 16A. This configuration provides an inset for heads of screws 365 that secure cross braces 360 to the side rails 312 as well as insets to secure rail bumpers 370. FIGS. 15-21 show rail bumpers 370 only on the front of the rails 312 but may be used on the rear of the rails 312, as well. The rail bumpers 370 are preferably made of PVC, but may be any material known in the art. The cross braces 360 are also preferably formed from extruded 6063-T6 aluminum in the form illustrated in FIG. 17A. The cross braces 360 include internal screw channels 367 to accept screws to secure the cross braces to the side rails 312. The opening in the interior of the side rails 312 is sized to tightly fit the width of the cross braces 360 for added strength and stability.

The handle 355 of this embodiment is a loop formed of preferably extruded 6063-T5 aluminum with a circular cross section that flairs out at the top of the handle 350. The grip 355 on the loop handle 350 is preferably PVC heat shrink to provide comfort and improved grasping of the handle 350. Then handle 360 is secured to the top of the rails 312 by bolts 318 and nuts 319. To protect the top of the rails side 312 and provide support for the handle 360, rail caps 313 that are formed to fit over the side rail 312 cross section as well as fittingly receive the handle 350 cross section.

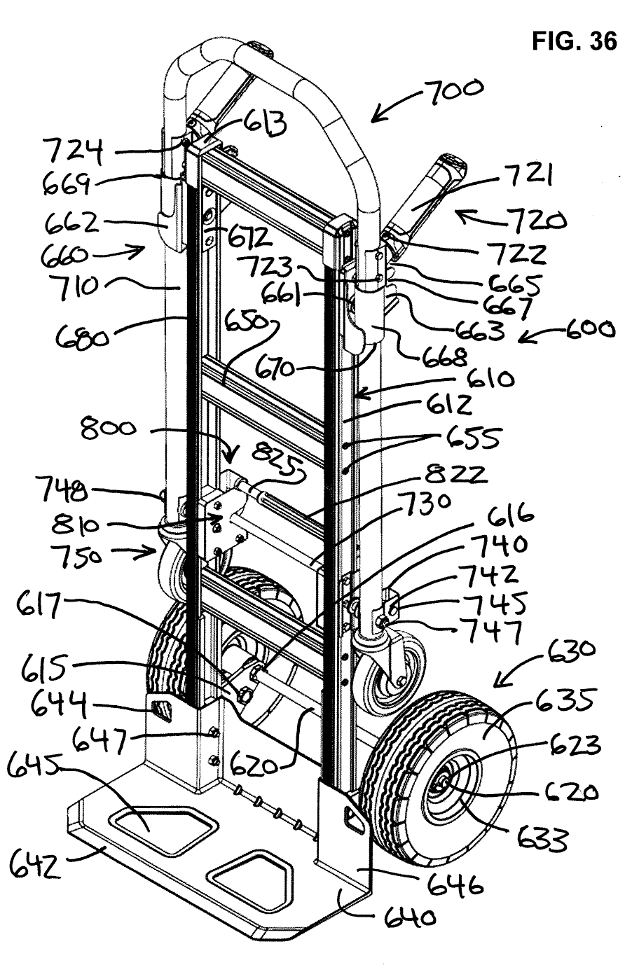

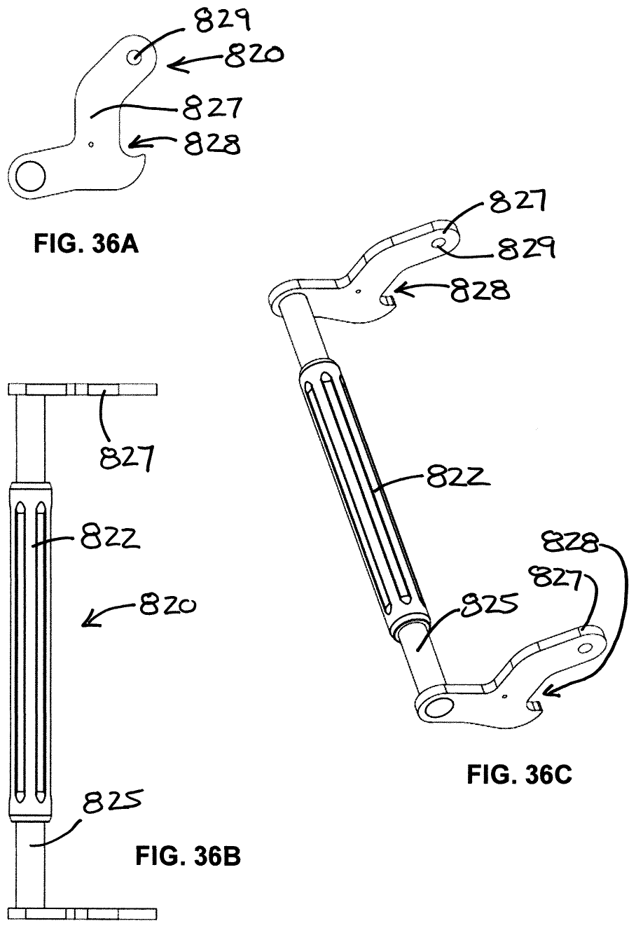

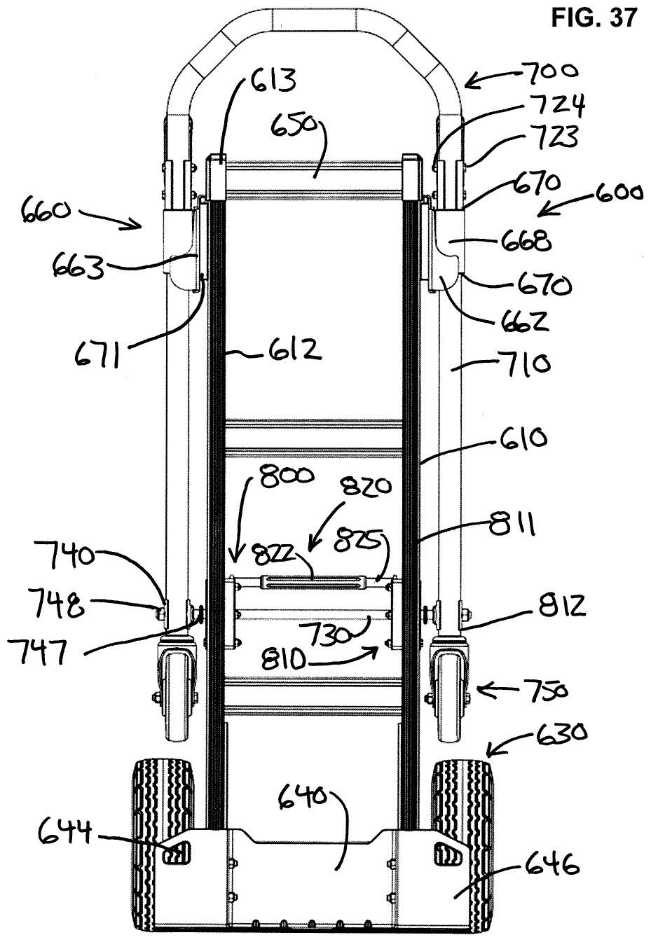

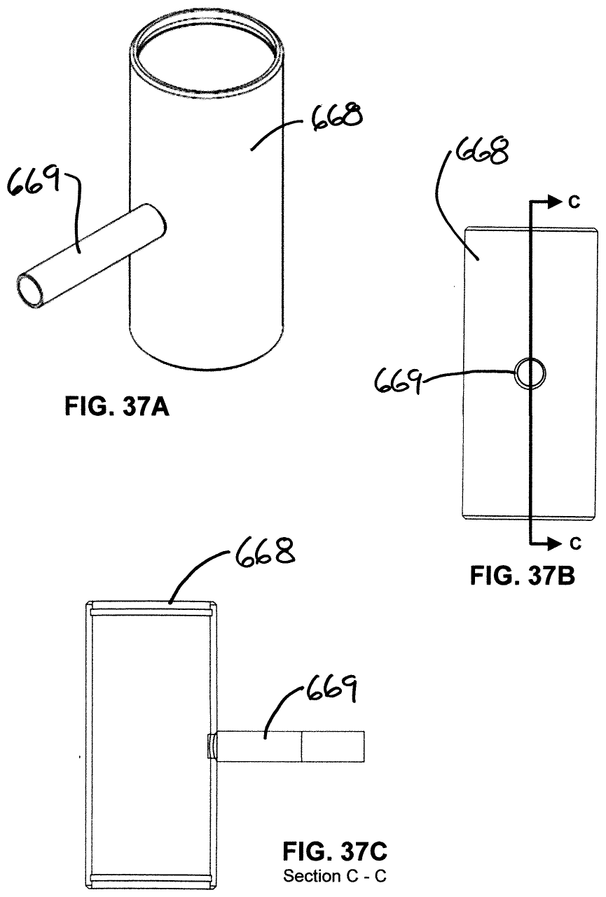

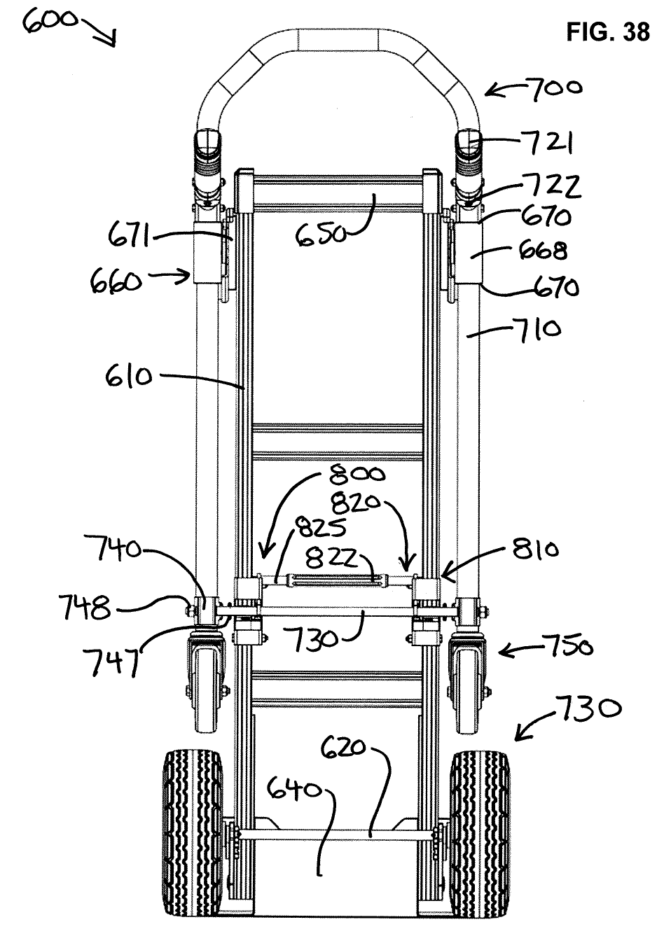

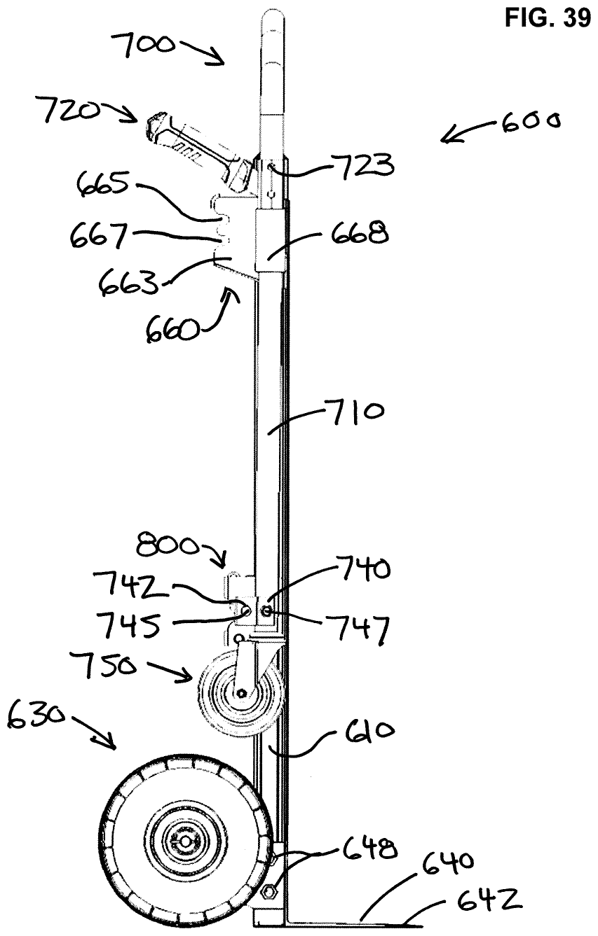

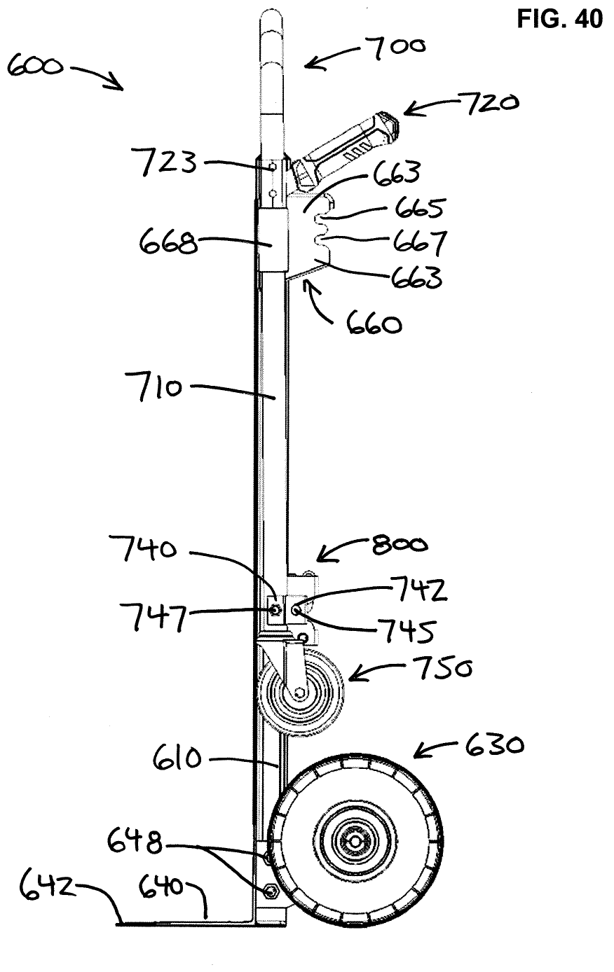

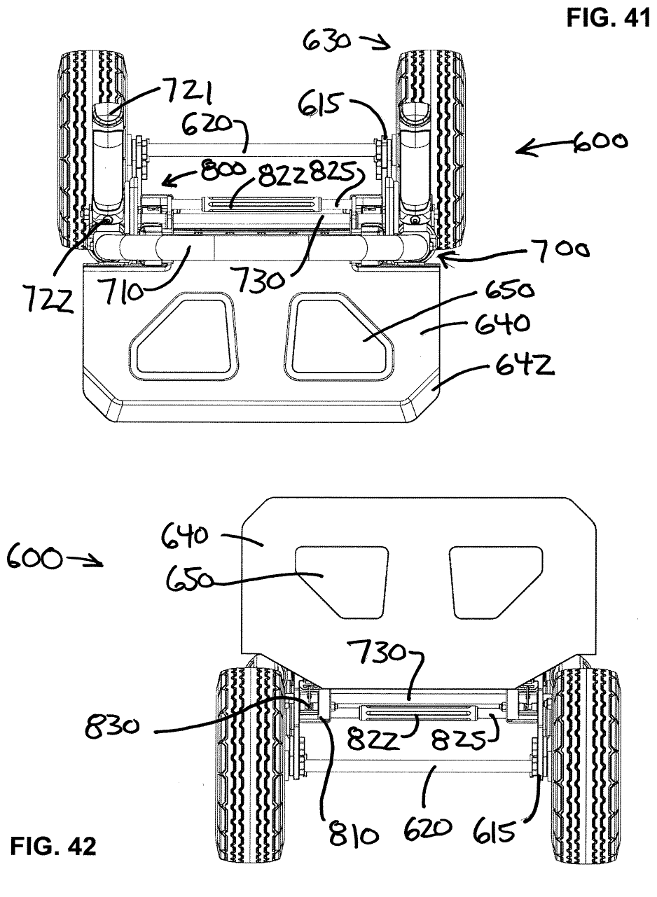

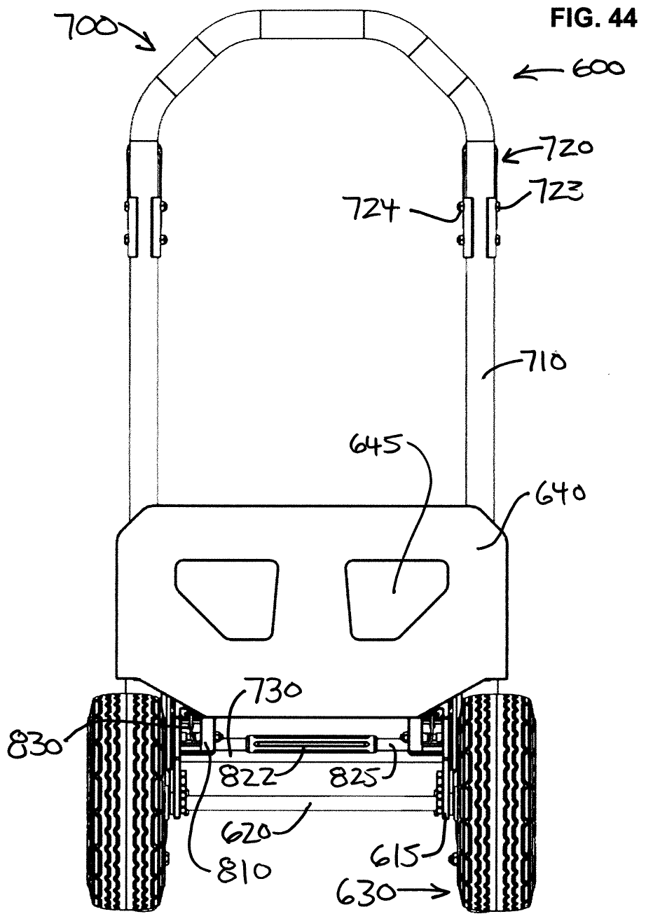

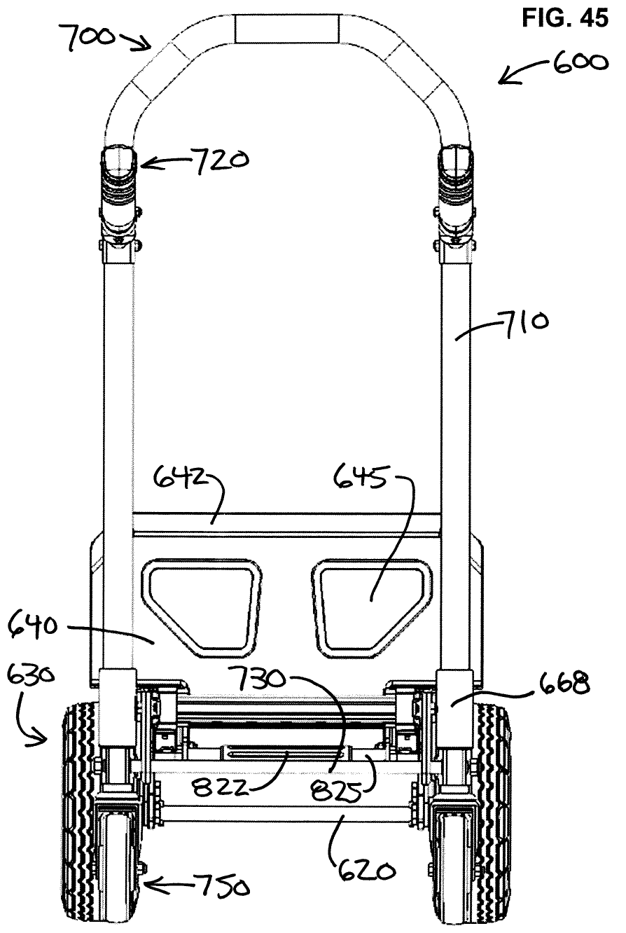

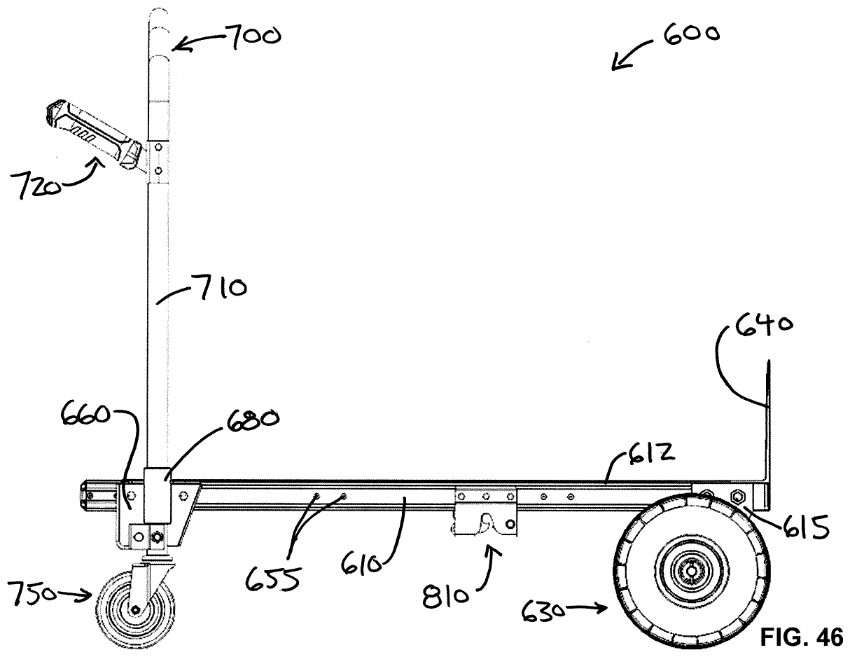

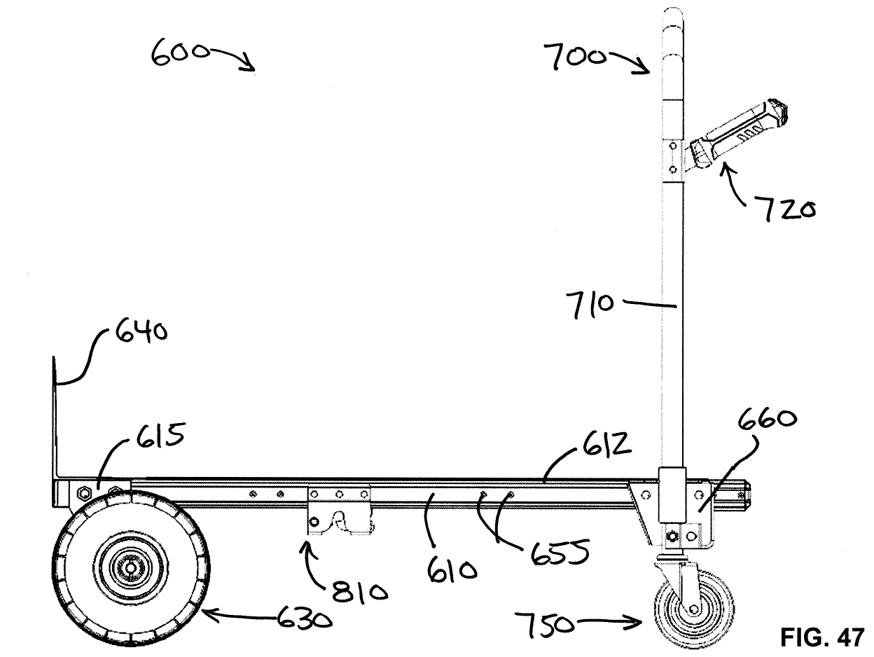

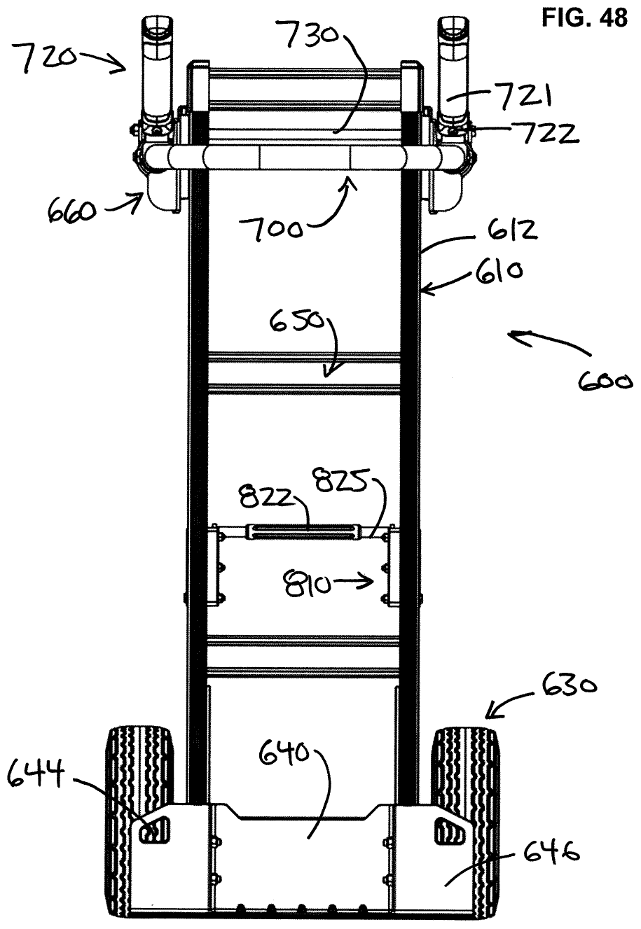

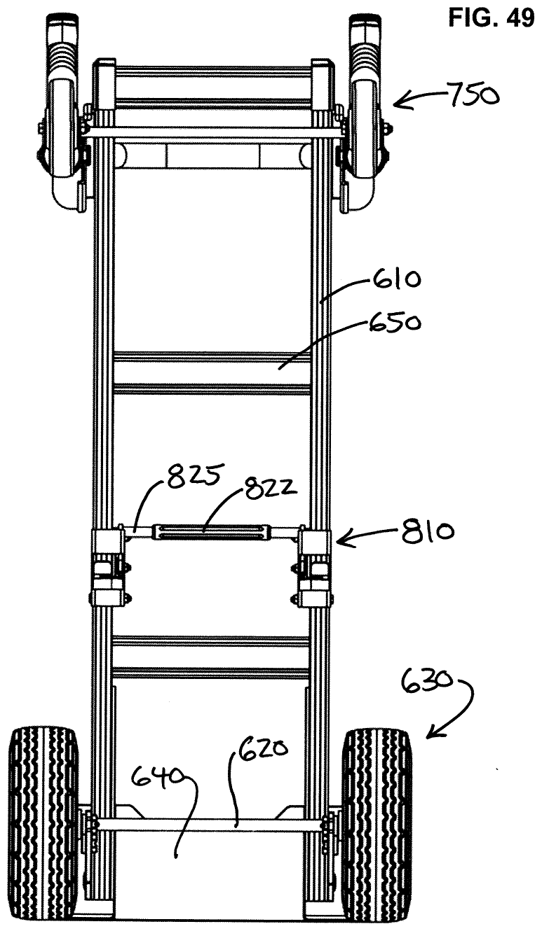

The embodiment of FIGS. 36-49 use frame axle brackets 315 to attach the wheels 330 and axle 320 to the material handling device 300. The axle brackets 315 are preferably A356 cast aluminum, but can be made of any material known in the art. The axle brackets 315 are connected to the side rails 312 with nuts 319 and bolts 318. The axle 320 is preferably made of 45# high strength steel but may be made of any suitable material.

Wheels 330 each comprise a rim 333 and tire 335 are attached at either end of the axle 320, preferably by a cotter pin 323. Other means known in the art may be used to attach the wheels 330 to the axle 320 and the wheels 330 may be a single body instead of separate rim 333 and tire 335. Preferably, the tires 335 of this embodiment are PVC while the rims 335 are constructed of polypropylene However, other materials may be used for both the tires 335 and rims 333 for specific needs.

In the preferred embodiment, the same nuts 319 and bolts 318 also secure nose plate brackets 314 to the side rails 312. In this arrangement, each side rail 312 is sandwiched between a frame axle bracket 315 and nose plate bracket 314, all held together with bolts 318 that traverse all three parts. The nose plate brackets 314 are preferably extruded 6063-T6 aluminum and provide connection between the nose plate 340 and the side rails 312.

The nose plate 340 of this embodiment is sized width-wise to extend to the approximate midpoint of each wheel 330 and is flat along the width of its upright portion. The upper outer portions of the upright of the nose plate 340 preferably include strap orifice 344 to allow straps, bungie cords, etc. to secure cargo to the material handling device 300. The front of the nose plate 340 may include a lip 342 that is thinner at the end of the nose plate 340 to assist is moving the material handling device 300 under a load and include a lift orifice 343 that allows a hook or strap to be attached to the toe plate 340 for lifting the front part of the material handling device 300. The central portion of the top of the toe plate 340 upright set at a height that is at or below the height of the axle 320 to accommodate a user's foot using the axle 320 as a lever to tilt the material handling device 300.

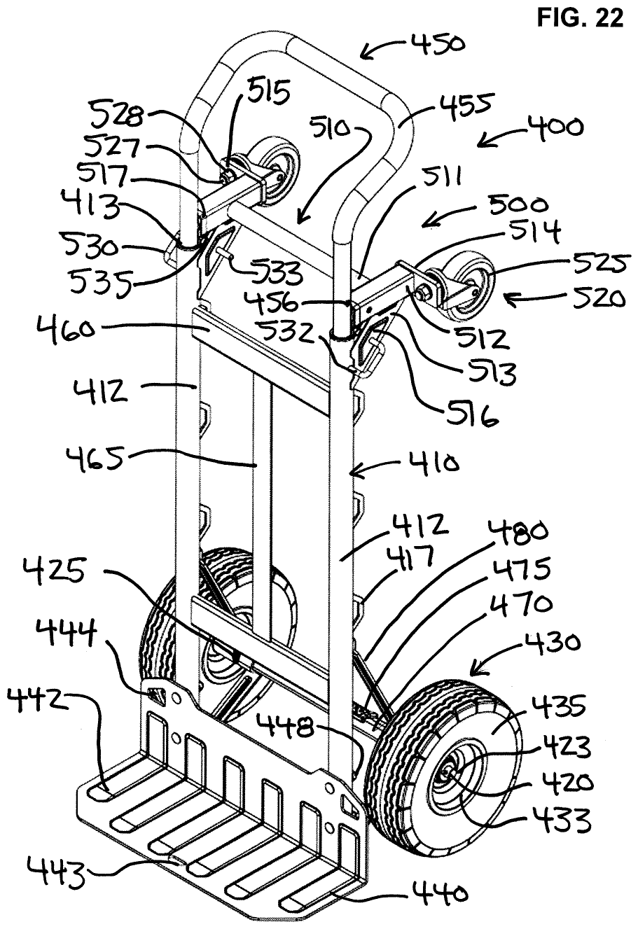

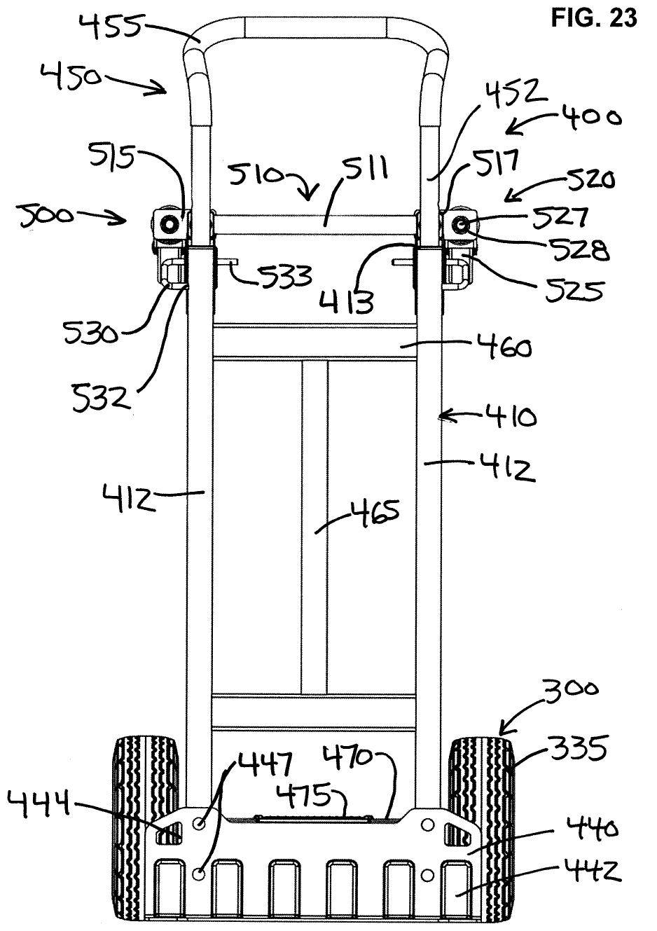

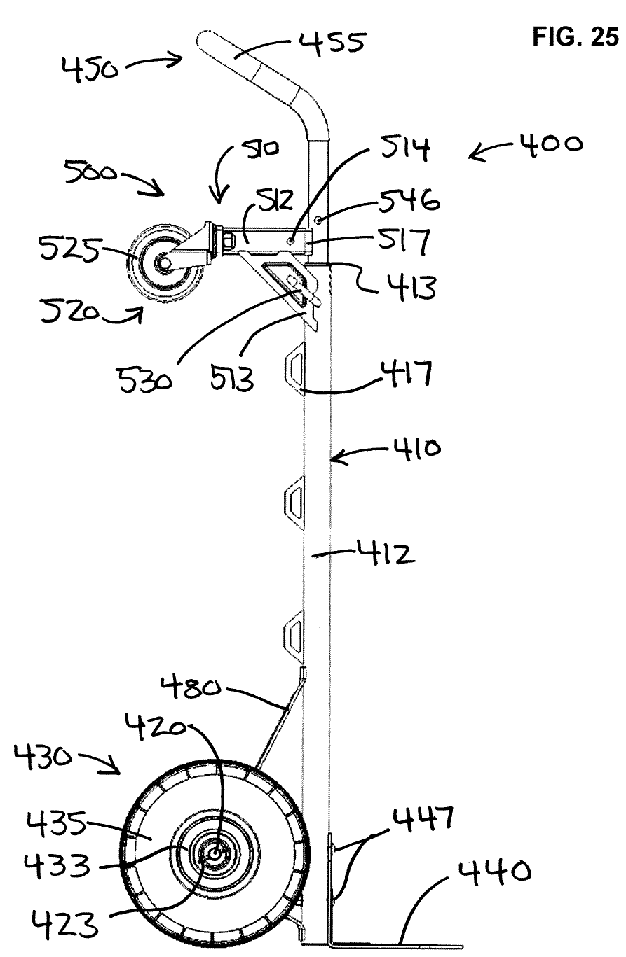

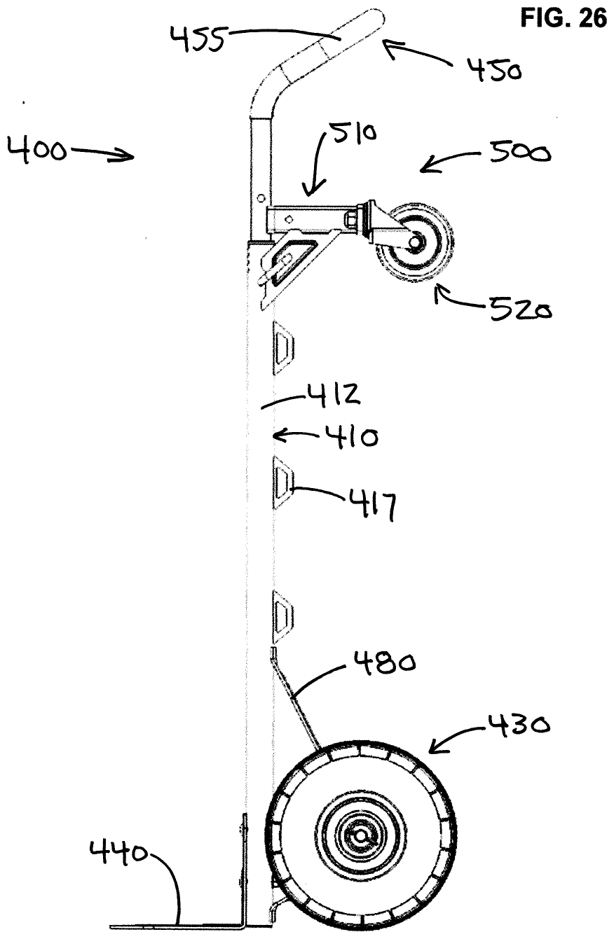

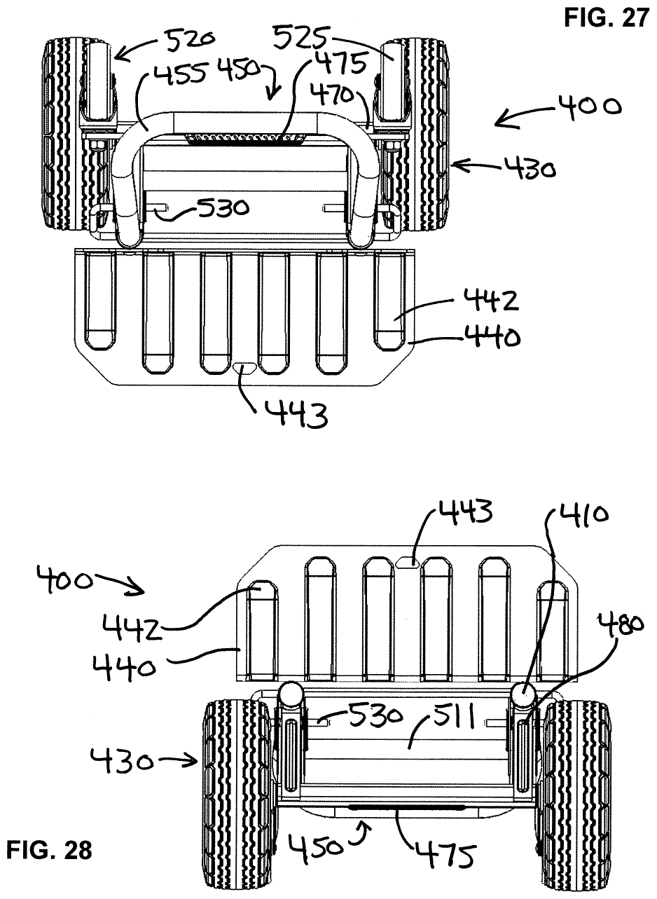

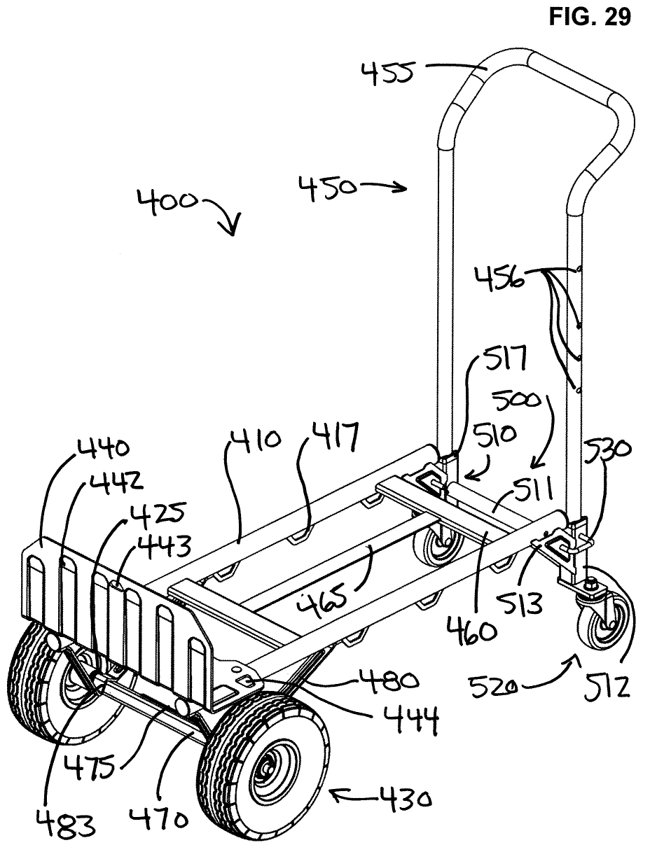

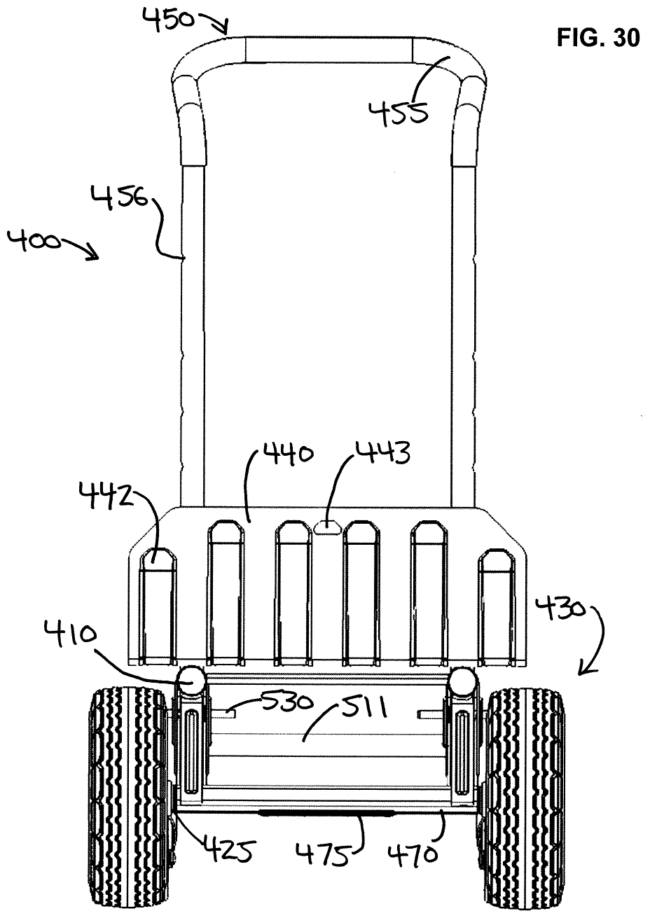

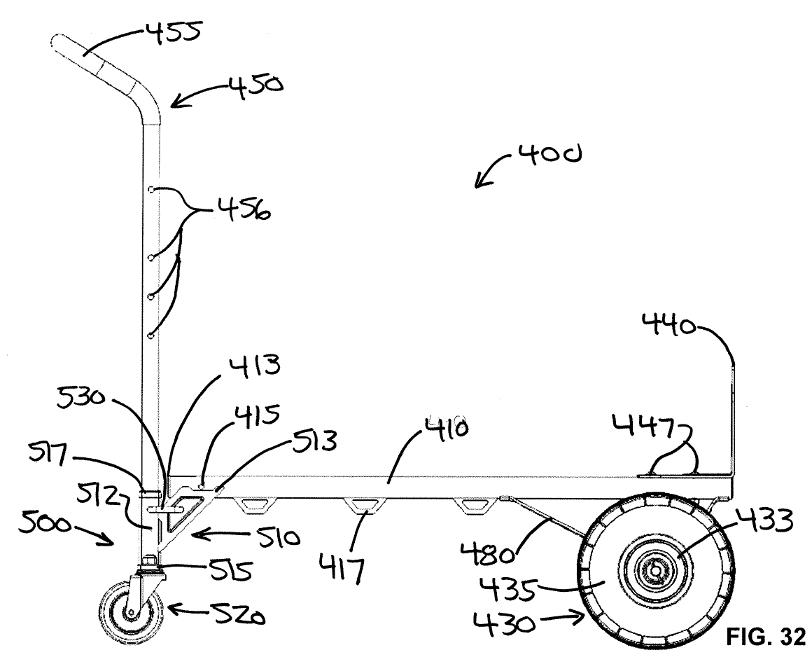

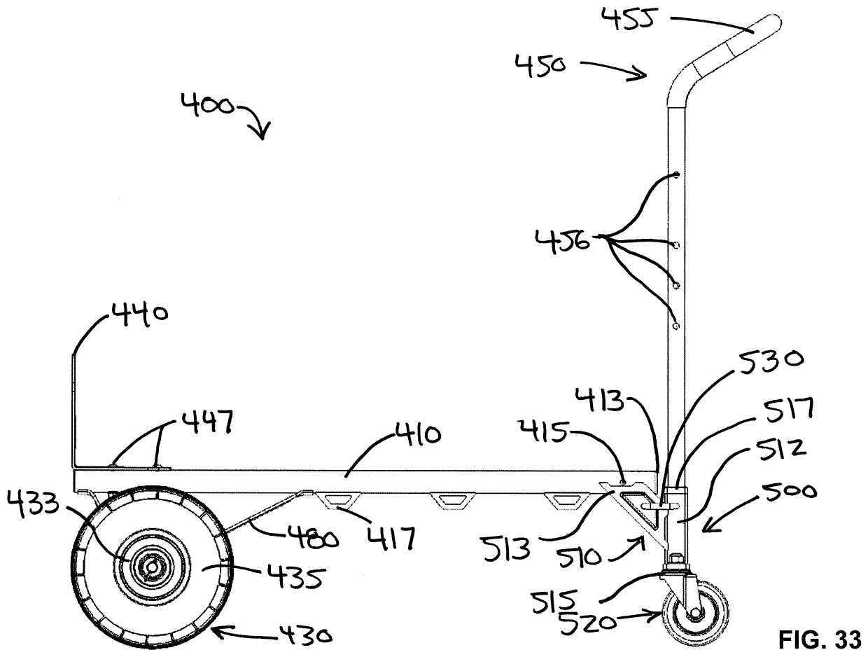

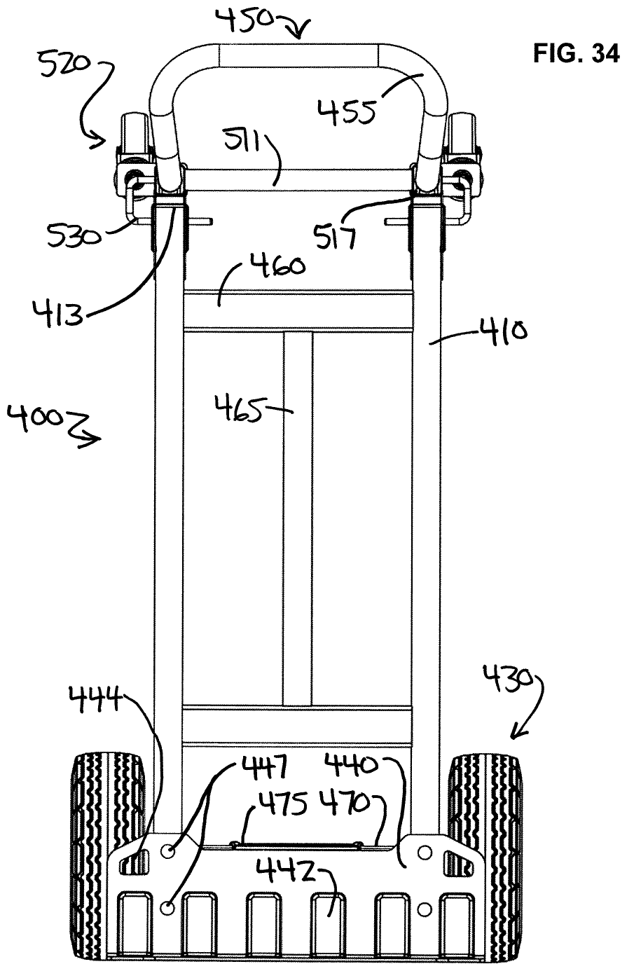

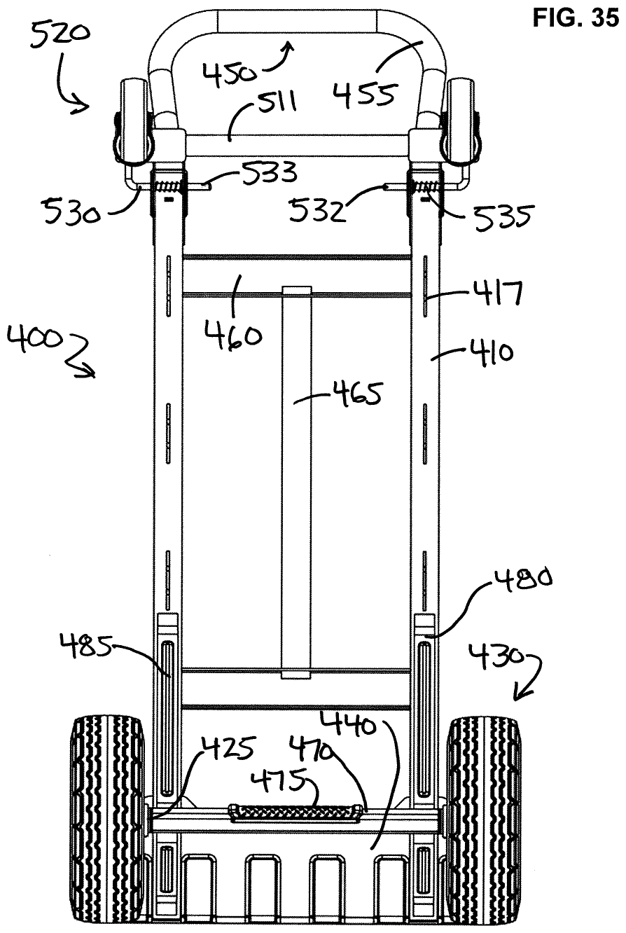

Another embodiment of the present invention is presented in FIGS. 22-35. This embodiment allows a material handling device 400 to be used in two orientations - upright on two wheels 430 as a hand truck (FIGS. 22-29) or on four wheels 430, 520 as a cart (FIGS. 30-35). The frame 410 is comprised of two uprights 410 with cross braces 460 and a center support 465. The uprights 410, cross braces 460, and center support 465 are all preferably steel constructed of steel and welded together with the uprights 410 being circular tubing and the cross braces 460 and center support 465 being C-channel. The handle 450 is also preferably comprised of steel being circular tubing with poles 452 sized to slide withing the uprights 412. The handle 450 may include grips 455 to assist in handling the material handling device 400. Grips 455 may be texturing of the handle 450, such as knurls, or may be rubber, plastic, or any other material known in the art. To provide smoother sliding of the handle 450 within the uprights 120 for adjusting the height of the material handling device 400 in the hand truck orientation or to convert the material handling device 400 to the cart orientation, the upper ends of the uprights 412 include handle bushings 413. The handle bushings are preferably nylon, but can be made of any suitable material known in the art.

Like the embodiment of FIGS. 1-7, the axle 420 of the embodiment of FIGS. 22-35 is housed in an axel tube 470 having a preferably square cross section for strength that is attached to the frame 410 by axle brackets 480. As seen in FIG. 29 (or in detail in FIG. 4A), the axle bracket 480 has a square axle tube inset 483 that is sized to accommodate the axle tube 470. To provide additional strength to the acle bracket 480, coining 485 may be used. While it is preferable to have a square axle tube 470 and axle tube inset 483, any shape may be used.

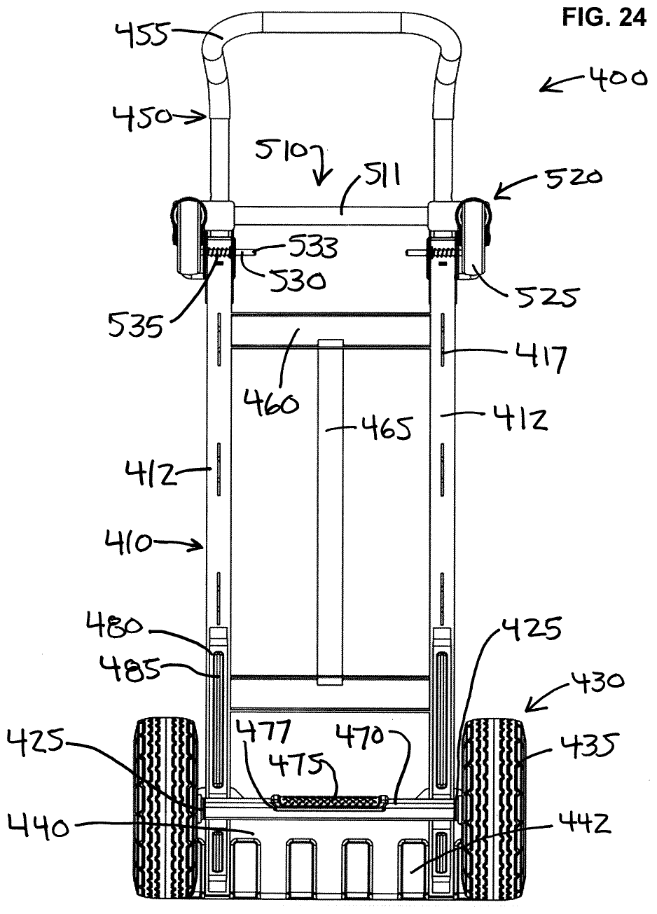

To support the axle 420 within the axle tube 470, a center axle bushing 475 is inserted in the center of the axle tube 470 and axle bushings 425 are located at the outer extremities of the axle tube 470. Thes bushings 425, 475 are preferably made of polypropylene to provide adequate support and cushion for the axle 420. As seen in FIG. 24 (or in detail in FIG. 4B), the center axle bushing 475 is exposed at the top and rear exterior of the axle tube 4170 to also provide a textured foot lever for aid in tipping the material handling device 400. This is accomplished by having the center axle bushing 475 sit within a cavity 477 in the axle tube 470 sized to tightly fit the bushing 475.

Wheels 430 each comprise a rim 433 and tire 435 are attached at either end of the axle 420, preferably by a cotter pin 423. Other means known in the art may be used to attach the wheels 430 to the axle 420 and the wheels 430 may be a single body instead of separate rim 433 and tire 435. Preferably the tires 435 of this embodiment are PVC while the rims 435 being constructed of polypropylene However, other materials may be used for both the tires 435 and rims 433 for specific needs.

The toe plate 440 of the embodiment of FIGS. 22-35 is attached to ends of the frame 410, preferably by bolts 447 and nuts 448 through the uprights 412, but may be welded or attached by any other means known in the art. The toe plate 440 is sized width-wise to extend to the approximate midpoint of each wheel 430. The upper outer portions of the upright of the nose plate 440 preferably include strap orifice 444 to allow straps, bungie cords, etc. to secure cargo to the material handling device 400. The front of the toe plate 440 include a lift orifice 443 that allows a hook or strap to be attached to the toe plate 140 for lifting the front part of the material handling device 400. The toe plate 440 may include coining 442 to provide strength. The central portion of the top of the toe plate 440 upright set at a height that is at or below the height of the center axle bushing 4175 to prevent interference with a user's foot.

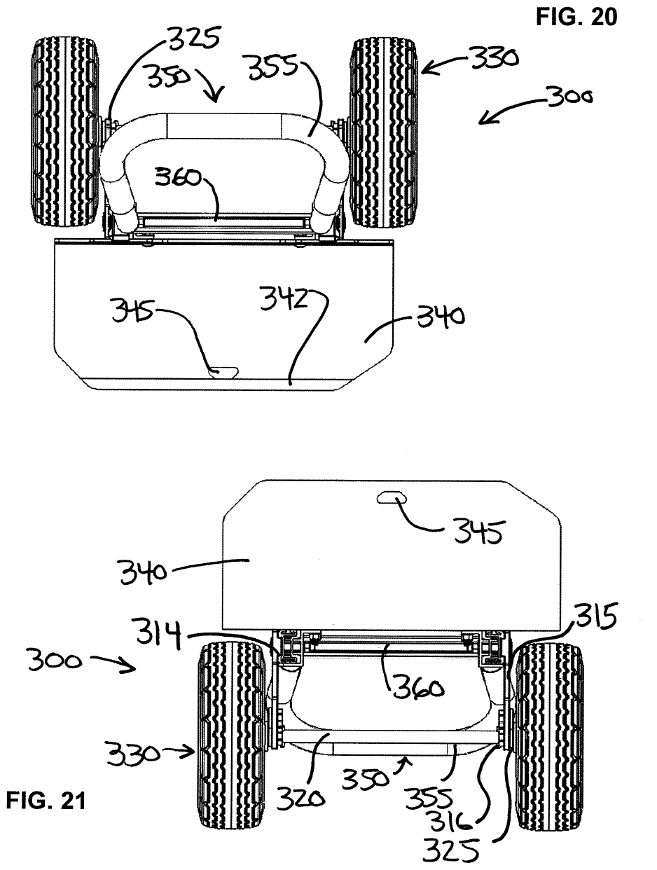

The material handling device 400 of FIGS. 20-35 also include strap loops 417 attached on the rear of the uprights 412 of the frame 410 to attach straps, bungie cords, etc. for securing cargo to the material handling device 400. The strap loops 417 are preferably made of the same steel as the frame 410 and welded to the frame 410. However, the strap loops 417 may also be made of any appropriate material and attached by any means known in the art.

A caster assembly 500 in combination with handle 450 being reoriented allows the material handling device 400 to change from its hand truck orientation (FIGS. 22-28) to its cart orientation (FIGS. 29-35). The caster mechanism 500 is attached to the frame 410 distal to the wheels 430 and includes a frame 510 having a crossbar 511, uprights 512, laterals 515, and angle supports 513, all preferably made of steel, and a pair of caster wheels 520. The attachment of components of the frame 510 are preferably all welded, but may use any method known in the art. The ends of the uprights 512 distal the caster wheels 530 include handle bushings 517, to hold the ends of the handle 450 firmly in the uprights 512. The handle bushings 517 are preferably nylon, but can be made of any suitable material known in the art. The angle supports 513 may also include coining 516 to provide additional strength. Caster wheels 520 preferably attached to laterals 515 by a nut 528 securing a bolt 527 on the caster wheel 520.

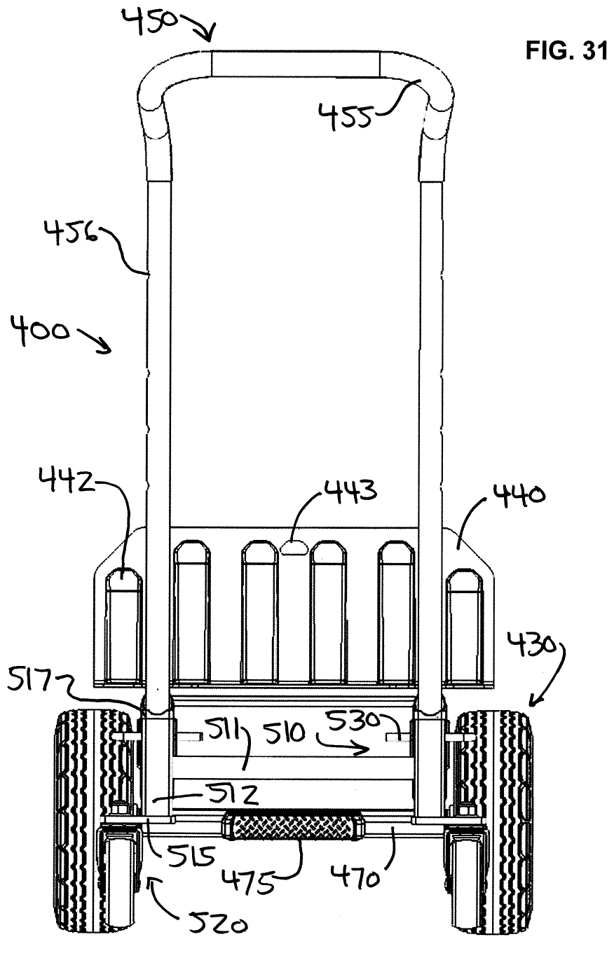

The handle 450 is locked in either its hand truck orientation or cart orientation by means of J-lock bars 530. Each J-lock bar has a stationary end 533 that rests within an orifice in its respective angle support 513. A biasing spring 535 within the angle support 513 biases the J-lock bar 530 against the angle support 513. Each J-lock bar includes a locking end 532 that can rotate to lock the handle 450 in position via a caster mechanism handle lock orifice 514 on the upright 512 (cart orientation) or via a frame handle lock orifice 415 on the frame upright 412 (hand truck orientation). The locking end 532 locks the handle 450 in its desired location by also entering a handle lock orifice 456 on the handle 450. This novel approach allow a single J-lock bar 530 on each frame upright 412. Handle lock orifices 456 may be placed anywhere along the length of the handle 450 to not only allow a change in orientation of the material handling device 400, but to allow for varying lengths of the handle 450. As best seen in FIG. 31, the caster mechanism is preferably dimensioned to have the inside of the caster wheels 520 align with the interior of the wheels 430. This arrangement provides improved stability of the material handling device 400 without interfering with clearance when in the cart orientation and without the caster mechanism 500 interfering with access of the handle 450 when in the hand truck orientation. Further, this orientation allows the caster frame crossbar 511 to function as an additional location on which a use can grasp the material handling device 400 in the hand truck orientation.

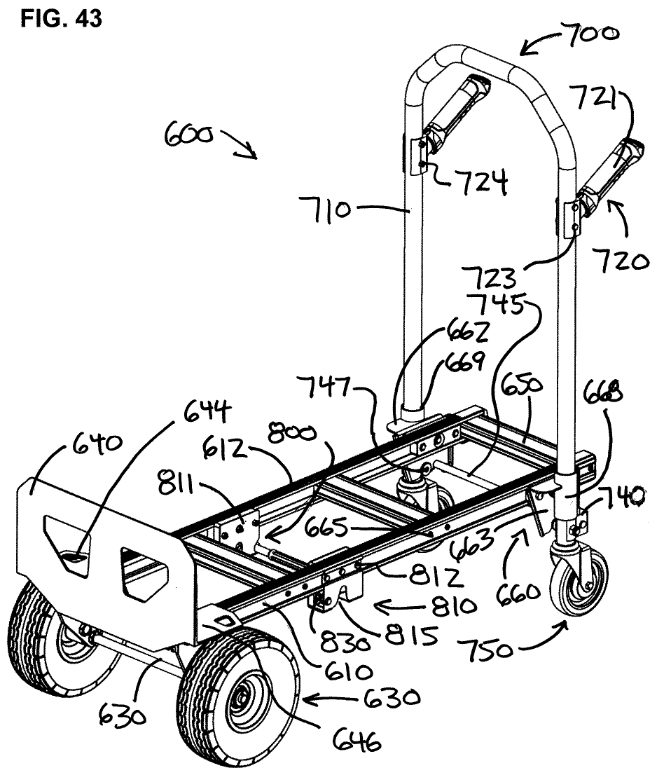

An alternative embodiment of the present invention being mostly constructed of aluminum structural parts is illustrated in FIGS. 36-49. Like the embodiment of FIGS. 22-35, this embodiment allows a material handling device 600 to be used in two orientations - upright on two wheels 630 as a hand truck (FIGS. 36-42) or on four wheels 630, 750 as a cart (FIGS. 43-49). This embodiment also includes being mostly constructed of aluminum structural parts, like the embodiment illustrated in FIGS. 15-21.

The frame 610 comprises two side rails 612 that are preferably extruded 6063-T6 aluminum with a C-channel cross section. The detail of the cross section is illustrated in FIG. 16A. This configuration provides an inset for heads of screws 655 that secure cross braces 650 to the side rails 612 as well as insets to secure rail bumpers 680. FIGS. 36-49 show rail bumpers 680 only on the front of the rails 612 but may be used on the rear of the rails 612, as well. The rail bumpers 680 are preferably made of PVC, but may be any material known in the art. The cross braces 650 are also preferably formed from extruded 6063-T6 aluminum in the form illustrated in FIG. 17A. The cross braces 650 include internal screw channels (367 in FIG. 17A) to accept screws to secure the cross braces to the side rails 612. The opening in the interior of the side rails 612 is sized to tightly fit the width of the cross braces 650 for added strength and stability. Side rail caps 613, preferably made of polypropylene, at the top of the side rails 612 act to protect the side rail 612 tops. In the preferred embodiment, the side rail caps 613 may also provide additional support for the top cross brace 650.

The embodiment of FIGS. 36-49 uses frame axle brackets 615 to attach the wheels 630 and axle 620 to the material handling device 600. The axle brackets 615 are preferably A356 cast aluminum, but can be made of any material known in the art. The axle brackets 615 are connected to the side rails 612 with nuts 647 and bolts 647. The axle 620 is preferably made of 45# high strength steel but may be made of any suitable material.

Wheels 630 each comprise a rim 633 and tire 635 are attached at either end of the axle 620, preferably by a cotter pin 623. Other means known in the art may be used to attach the wheels 630 to the axle 620 and the wheels 630 may be a single body instead of separate rim 633 and tire 635. Preferably the tires 635 are rubber and pneumatic while the rims 633 are steel. However, other materials may be used for both the tires 635 and rims 633 for specific needs.

The nose plate 640 of the embodiment of FIGS. 36-49 is attached to ends of the frame 610, preferably by bolts 648 and nuts 647, but may be welded or attached by any other means known in the art. The nose plate 640 is sized width-wise to extend to the approximate midpoint of each wheel 630. The portions of the upright portion of the toe plate 640 from the interior of the frame 610 to the outer extremity of the nose plate 640 form a wheel guard 646, which prevents cargo being transported with the material handling device 600 from contacting the wheels 630. The upper portion of each wheel guard 646 preferably includes a strap orifice 644 to allow straps, bungie cords, etc. to secure cargo to the material handling device 600. The front of the nose plate 640 may include a lip 642 that is thinner at the end of the nose plate 640 to assist is moving the material handling device 600 under a load and include cutouts 645 to lessen the weight of the nose plate 640. The central portion of the top of the toe plate 640 upright set at a height that is at or below the height of the axle 620 to accommodate a user's foot using the axle 620 as a lever to tilt the material handling device 600.

The handle mechanism 700 of this embodiment is a handle loop 710 formed of preferably extruded 6063-T5 aluminum with a circular cross section. The handle loop 710 is attached to the frame 610 via a frame conversion mechanism 660. The frame conversion mechanism 660 includes a bracket plate 663 that is connected to a side rail 612 and a bracket tube 668 within which the handle loop 710 slides to convert the material handling device 600 between its hand truck orientation (FIGS. 36-42) and cart orientation (FIGS. 43-49). The bracket tube 668 is preferably made of steel for strength and durability. The bracket tube 668 includes a bracket tube extension 669 that allows the bracket tube 668 to rotate via a bracket tube rotation bushing 661 located between the bracket tube 668 and the outer rail fitting 671. To allow the handle loop 710 to be a tighter fit but slide easily, the bracket tube 668 preferably includes bushings 670 at each end of the bracket tube 668. The bushings 670 are preferably made of nylon but can be any material known in the art for such purposes. The bracket tube 668 is attached to the frame 610 by a nut attached to the threaded end of the bracket tube extension 669. Preferably the bracket tube 668 is rotatably attached to the side rail 612 with an outer rail fitting 671 and an inner rail fitting 672. Both fittings 671, 672 are preferably comprised of high-density polyethylene, but can be made of any material known in the art. The frame conversion mechanism 660 may further include a frame conversion bracket 663 that is preferably made of steel and includes a bracket stop 662. The bracket stop 662 is dimensioned and oriented to provide a block to which the bracket tube 668 rests against when the handle mechanism 700 is position for the hand truck configuration or cart configuration. The frame conversion bracket 663 is located between the outer rail fitting 671 and the bracket tube rotation bushing 661. The preferred embodiment uses nuts and bolts to sandwich the inner rail fitting 672, rail 612, outer rail fitting 671, and frame conversion bracket 663.

The handle mechanism 700 of this embodiment may also include handle grips 720 to allow for a varied hold by a user. The handle grips 720 are preferably made of aluminum and attached to the handle loop 710 with bolts 723 and nuts 724. Handle grips 720 include grip sleeves 721, preferably made of polypropylene and thermoplastic vulcanizates to provide a more comfortable and improved hold while using the material handling device 600. The grip sleeves may be made of any material that is suitable for the disclosed purpose. The grip sleeves 721 are preferably attached to the handle grips 720 by grip sleeve rivets 722, but may be attached by any means known in the art, such as screws, adhesives, etc.

The handle mechanism 700 includes a latch bar 730 and latch bar brackets 740 at its ends adjacent to caster wheels 750. The latch bar 730 and latch bar brackets 740 are preferably made of steel for strength and durability but may be made of any material known in the art that is suitable for the disclosed purpose. The latch bar brackets 740 are attached to the handle loop 710 by socket head nuts 747 and bolts 748. The latch bar 730 is preferably held within latch bar bracket orifices 743 by retaining rings 745, but may be attached to the latch bar bracket 730 by any means known in the art.

A latch mechanism 800 allows the material handling device 600 of FIGS. 36-49 to convert between its hand truck orientation and cart orientation. The latch mechanism 800 includes a latch housing 810 that is attached to each of the side rails 612 with nuts 811 and bolts 812. The latch mechanism 800 includes a latch release 820 comprising a latch release bar 825 and a latch release plate 827 (shown in detail in FIGS. 36A-C). The latch release housing, 810, latch release bar 825, and latch release plate 827 are all preferably made of steel for strength and durability, but can be made with other materials known in the art. The latch release bar 825 preferably also includes a grip 822 made of polypropylene for improved comfort and hold. It is also preferable that the latch release bar grip 822 be a bright contrasting color for easy identification and location by a user.

The latch mechanism 800 functions to hold and release the handle latch bar 730 of the handle mechanism 700 from a latch housing notch 815. In the hand truck orientation, the handle latch bar 730 resides in a latch housing notch 815 and is locked in place by an indent 828 in the latch release plate 827. The latch release 820 is biased by a latch release torsion spring 830 so that the indent 828 maintains the locked position unless the latch release bar 825 is pulled. Pulling the latch release bar 825 rotates the latch release 820 about a pivot 829 freeing the handle latch bar 730 to exit the latch housing notch 815.

Once the handle latch bar 730 is released from the latch housing notch 815, the handle loop 710 can slide within the frame conversion bracket tube 668 and allow the frame conversion mechanism 660 to move toward caster wheels 750 via rotation of the frame conversion backet tube extension 669. When the material handling device 600 is fully in the cart orientation, the frame conversion bracket tube 668 is prevented from further movement by the frame conversion bracket stop 662. To further secure the material handling device 600 in the cart orientation, the handle latch bar 730 rests within a frame conversion bracket latch bar slot 665. In the preferred embodiment, the material handling device 600 is further secured in the cart orientation by the latch bar bracket socket head nut 747 resting within a frame conversion bracket socket head slot 667.

To convert the material handling device 600 from the cart orientation to the hand truck orientation, the top cross brace 650 or the side rail caps 613 may be lifted to allow the frame conversion mechanism 660 to slide up the handle loop 710 until in the full hand truck orientation. When in the full hand truck orientation, the handle latch bar 730 enters the latch housing notch 815 and is secured in position by the latch release plate indent 828.

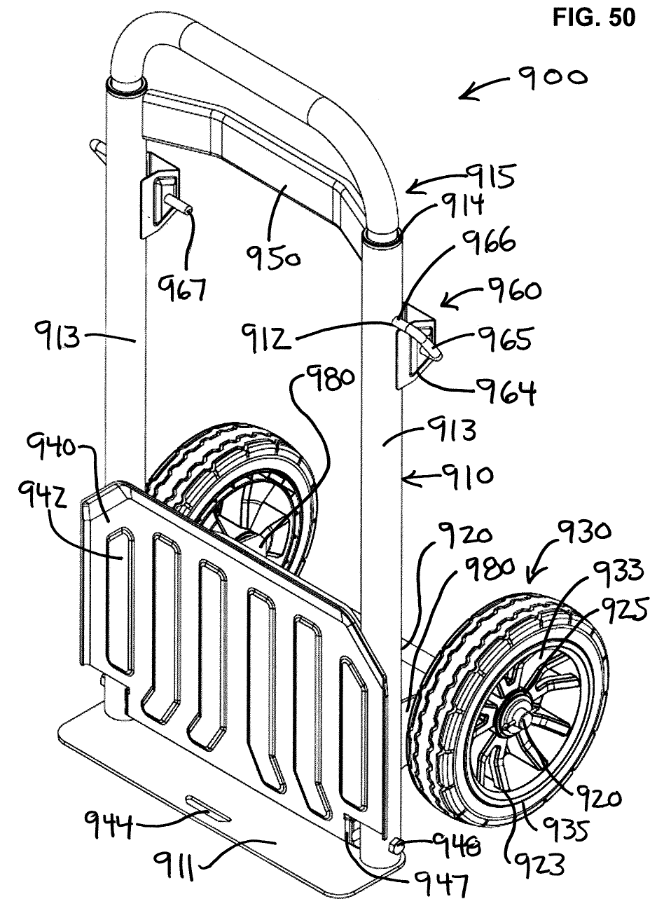

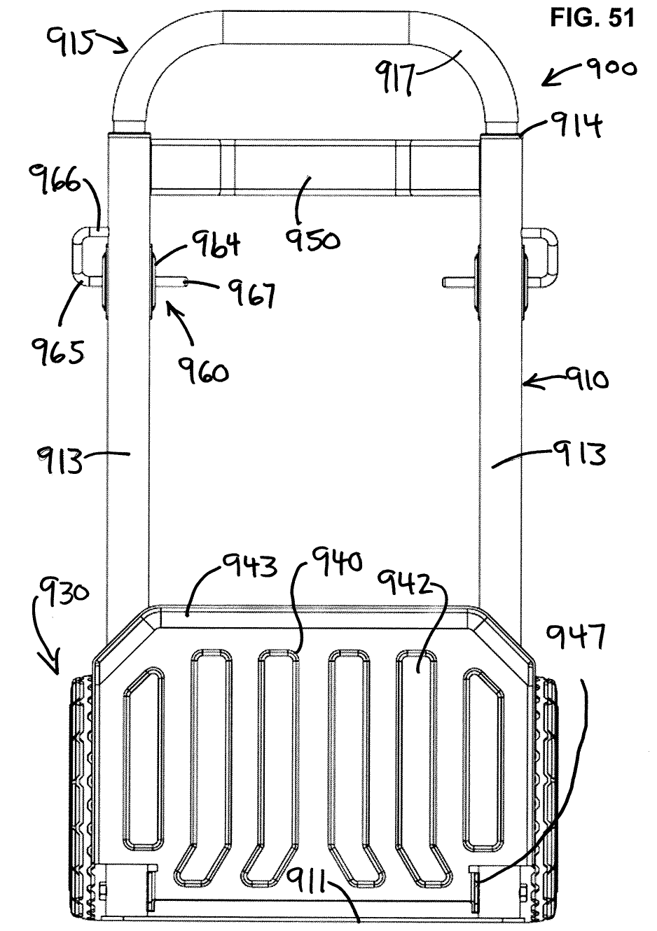

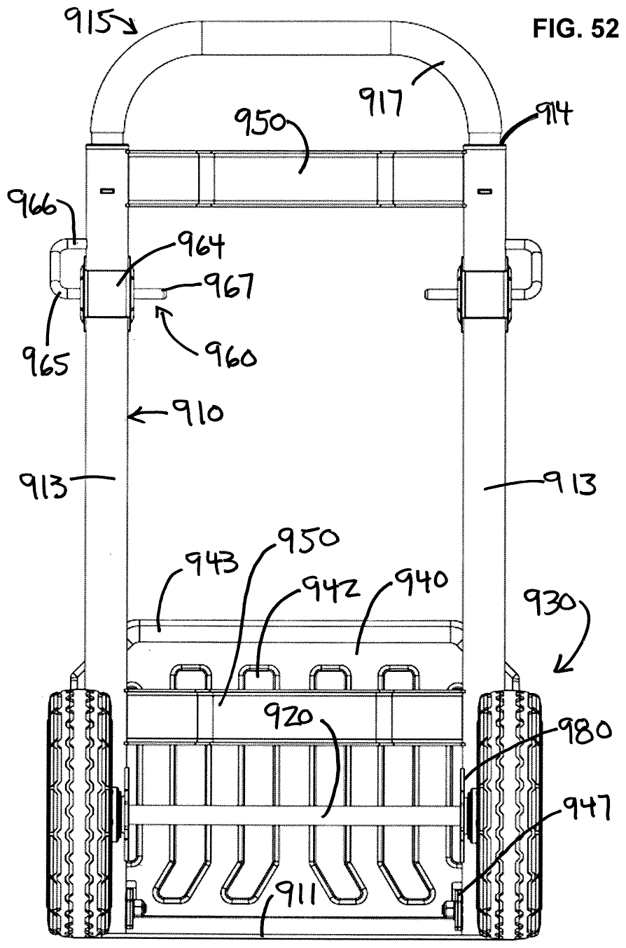

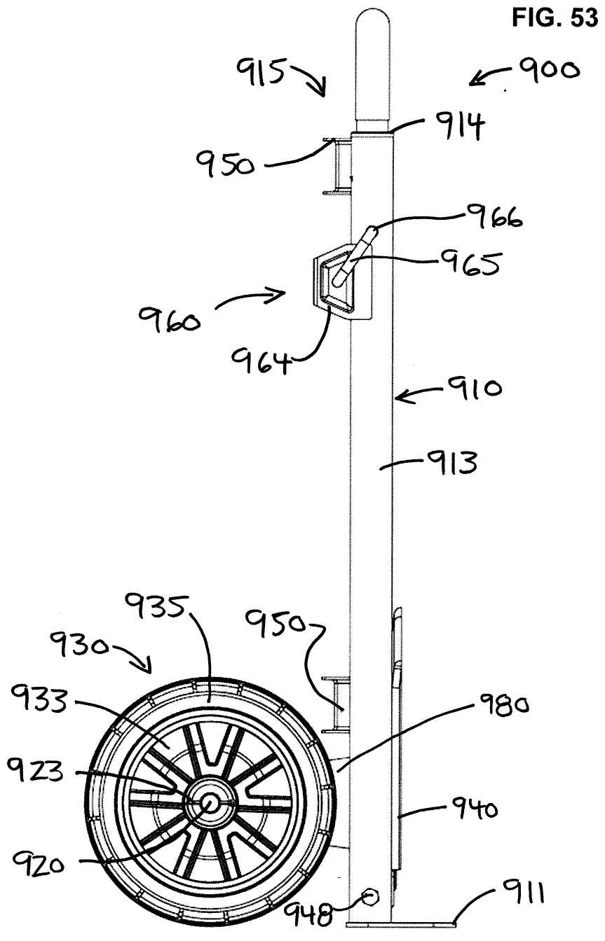

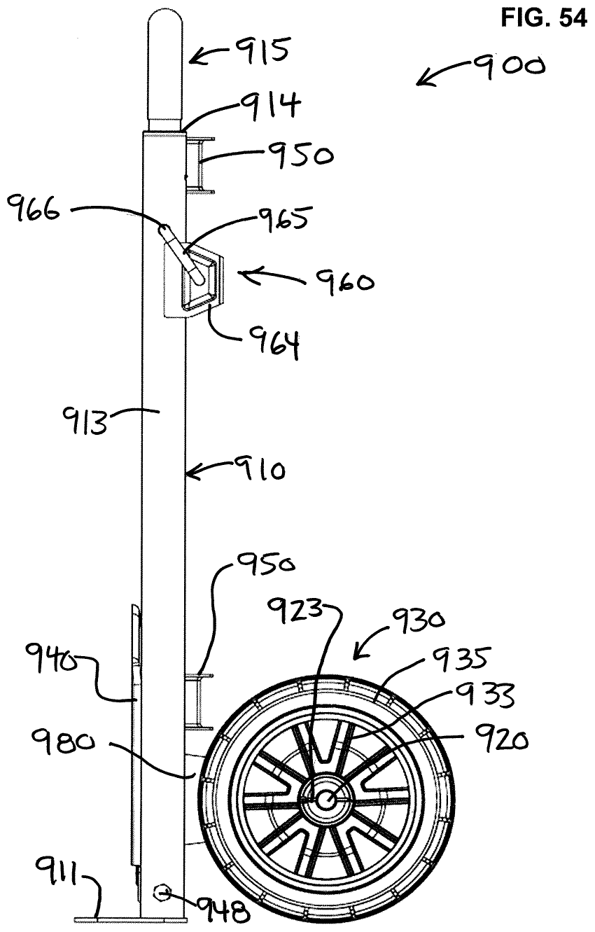

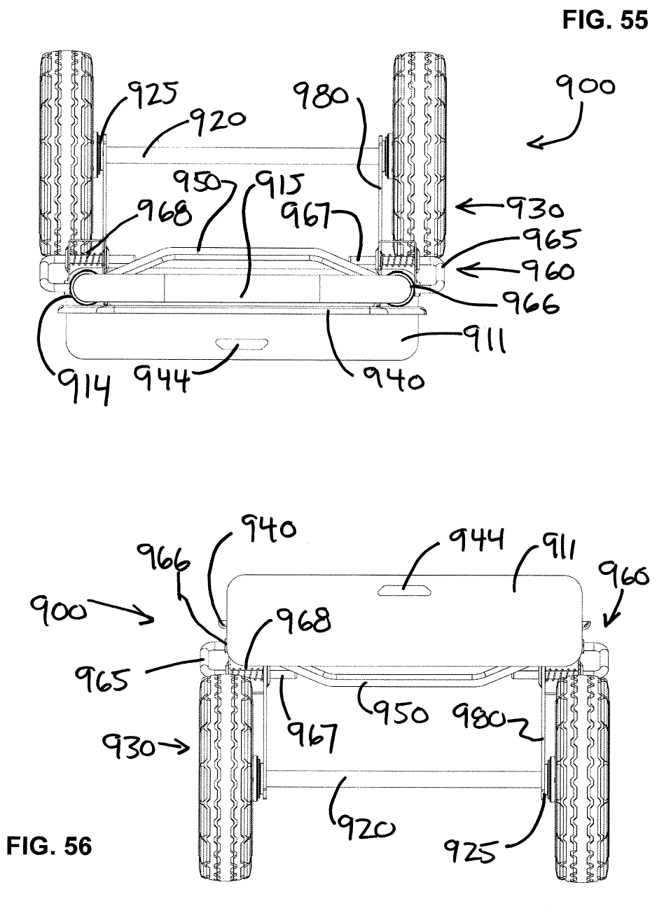

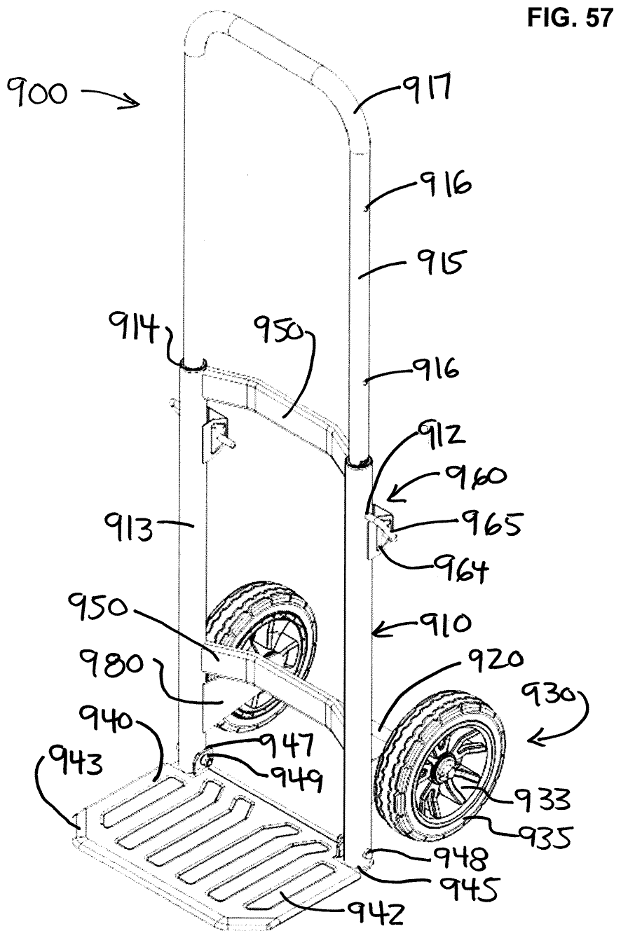

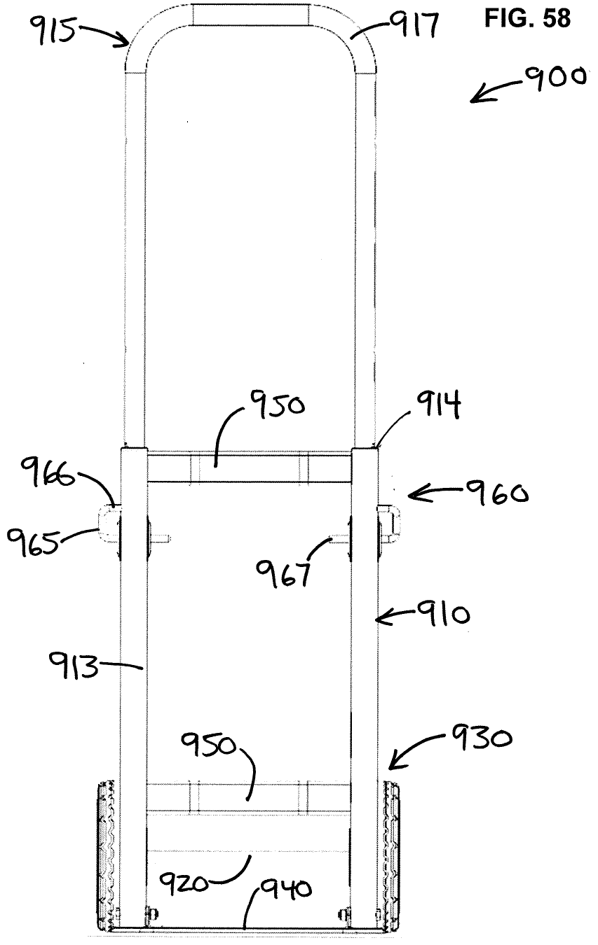

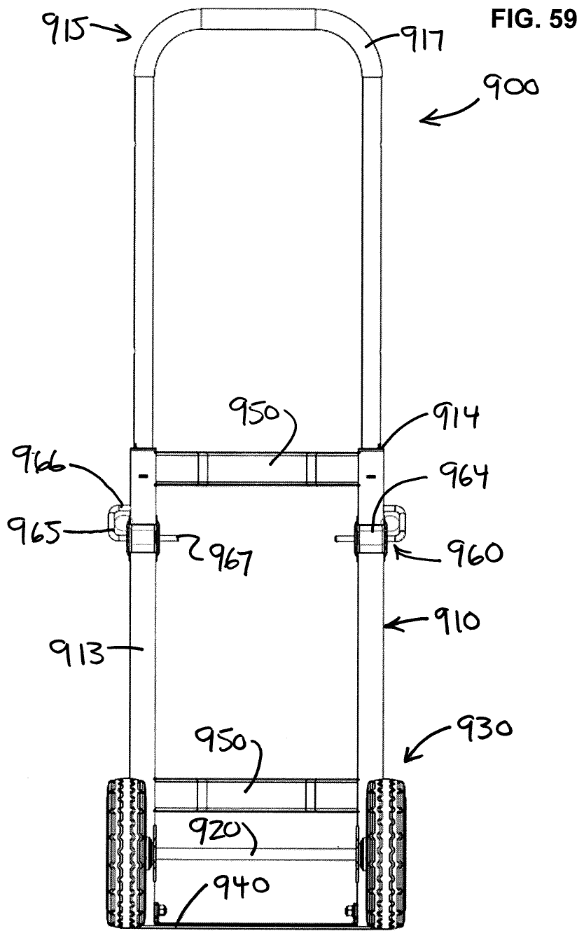

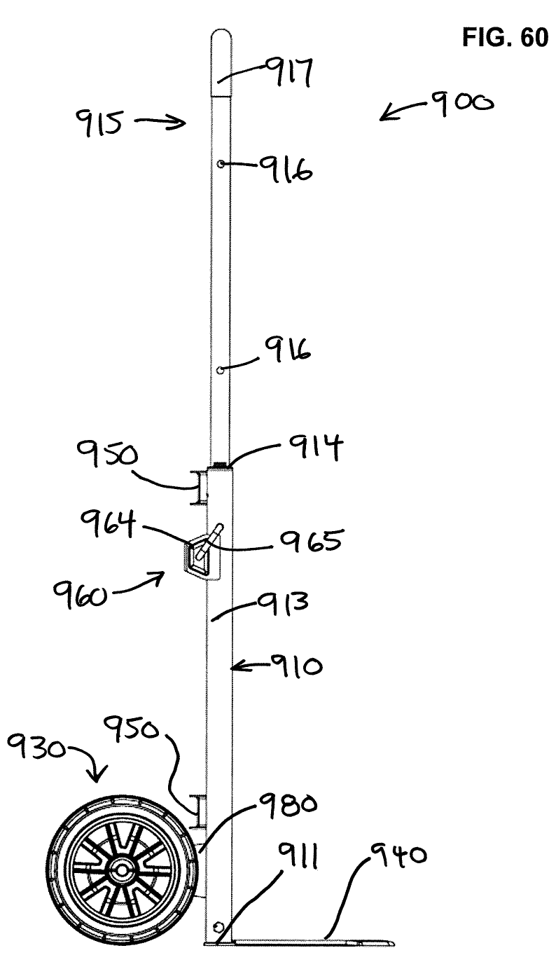

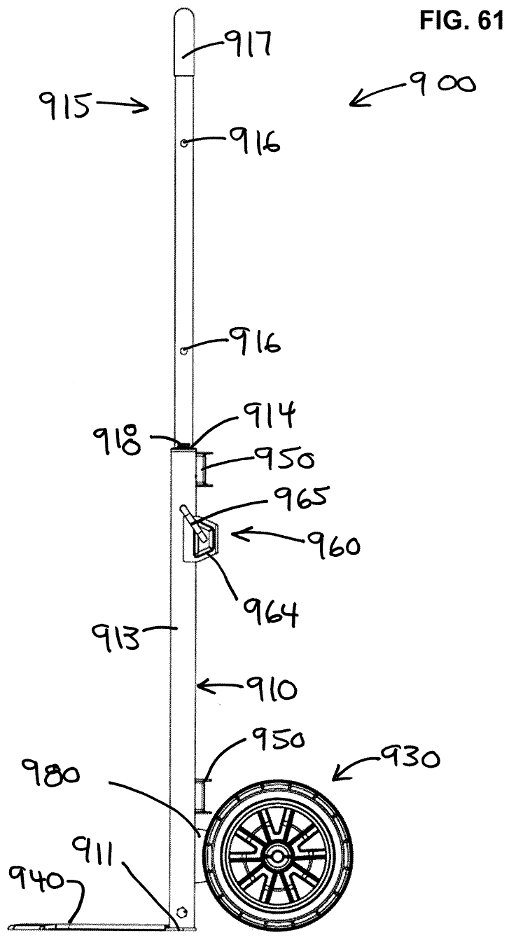

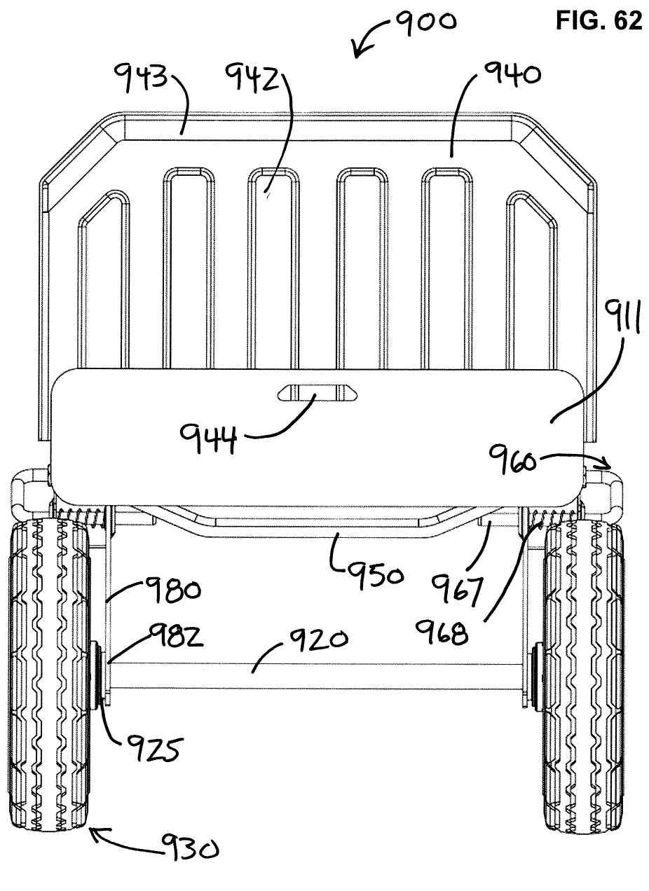

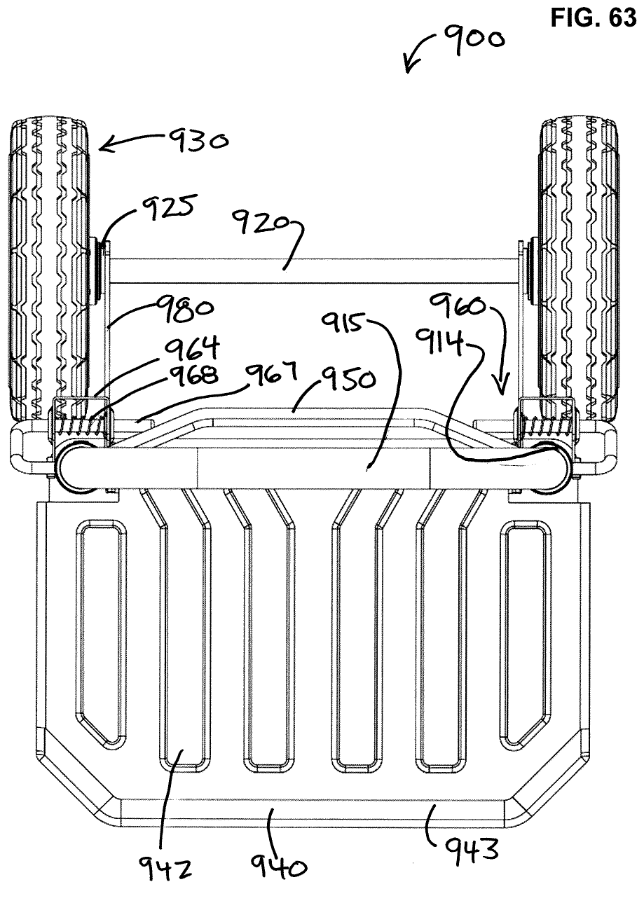

A further embodiment of a material handling device is illustrated in FIGS. 50-63. This embodiment presents a material hand truck 900 that can be collapsed into a stored orientation (FIGS. 50-56) to allow for easier transport and storage but provides a full-sized hand truck when in the use orientation (FIGS. 57-63). In the stored orientation, the material handling device 900 is less than 12″ deep and 30″ tall.

The material handling device 900 has a frame 910 with a handle loop 915, wheels 930, and a toe plate 940. The frame 910 comprises uprights 913 with a cross brace 950 proximate the top of the uprights 913, a toe plate support 911 at the bottom of the uprights 913, and axle brackets 980 extending to the rear of frame 910 at an appropriate height to support wheels 930 that allow the material handling device 900 to stand vertical when the wheels 930 and toe plate support 911 are on a level ground surface. The frame 910 may include more than one cross brace 950 and it is preferred that the cross braces 950 of this embodiment have a convex shape to allow cylindrical objects such as drums and pots to fit better on the material handling device 900. The axle 920 extends between and through the axle brackets 980 via axle bracket orifices 982. The frame 910 is preferably made of steel with the cross braces 950, toe plate support 911, and axle brackets 980 welded to the uprights 913 and the axle 920 welded to the axle brackets 980. However, the material of manufacture and means of attaching the parts of the frame 910 may be any known in the art suitable for the disclosed purpose.

The handle loop 915 is sized and configured to slide within the frame uprights 913. To provide smoother sliding of the handle loop 915 within the uprights 913 for adjusting the height of the material handling device 900, the upper ends of the uprights 913 include handle bushings 914. The handle bushings are preferably nylon, but can be made of any suitable material known in the art. The handle 915 may include grips 917 to assist in handling and comfort while using the material handling device 900. Grips 917 may be texturing of the handle 915, such as knurls, or may be rubber, plastic, or any other material known in the art. The preferred embodiment for the grips 917 is heat shrink rubber. The handle loop 915 also preferably includes handle plugs at each end of the handle loop 915 to act as stops to prevent the handle loop 915 from accidentally being removed completely from the frame 910 and to prevent and water from sitting on the toe plate support 911. The handle loop 915 also preferably includes a stop tab 918 that prevents the handle from completely being removed in this embodiment.

Axle brackets 980 extend to the rear of frame 910 at an appropriate height to support wheels 930 that allow the material handling device 900 to stand vertical when the wheels 930 and toe plate support 911 are on a level ground surface. The axle brackets 980 are preferably steel and welded to the frame 910. The axle 920 extends between and through the axle brackets 980 via axle bracket orifices 982.

The handle loop 915 is locked in either its collapsed orientation or use orientation by means of J-lock bars 965. Each J-lock bar has a stationary end 967 that rests within an orifice in its respective bracket 964. A biasing spring 968 within the bracket 964 biases the J-lock bar 965 against the bracket 964. Each J-lock bar includes a locking end 966 that can rotate to lock the handle loop 915 in position via a handle lock orifice 912 on the frame upright 913. The locking end 966 locks the handle loop 915 in its desired location by also entering a handle lock orifice 912 on the handle loop 915. This novel approach allow a single J-lock bar 965 on each frame upright 913 to affectively lock the handle loop 915 in place. Handle lock orifices 912 may be placed anywhere along the length of the handle loop 915 to allow for varying lengths of the handle loop 915.

Wheels 930, comprising rims 933 and tires 935 are mounted on either end of the axle 920 via axle bearings 925. Preferably, each wheel has an axle bearing on the inside and outside of the wheel 930. Wheels are attached to the axle 920 by any means known in the art, but preferably by cotter pins 923. Preferably, the tires 930 of this embodiment are PVC while the rims 933 being constructed of polypropylene However, other materials may be used for both the tires 935 and rims 933 for specific needs and the wheels 930 may even be unibody construction.

A unique feature of this embodiment of the material handling device 900 is the folding toe plate 940. To provide a toe plate 940 that is capable of folding and yet carry a significant load, the present embodiment includes a toe plate support 911 as part of the frame 910. The toe plate support 911 is preferably 30-40% of the depth of the toe plate 940 to provide an optimal support/weight ration. The toe plate support 911 includes a lift orifice 944 that allows a strap, chain, hook, or other means to attach to the material handling device 900 for either lifting a load or securing a load to the device 900. The toe plate 940 is also preferably made of steel for strength and includes coining 942. The toe plate 940 is designed to have a lip 943 around its front and sides with a depth sufficient to lay flat on an even surface while being supported by the toe plate support 911. The toe plate 940 is preferably attached to the frame uprights 913 with bolts 948 and nuts 949. To allow the toe plate 940 to lock in the upright position, toe plate spacers 947 are sandwiched between the frame upright 913 and a toe plate tab 945 that is preferably, a partial cutout of the toe plate 940 that is bent perpendicular to the toe plate 940.

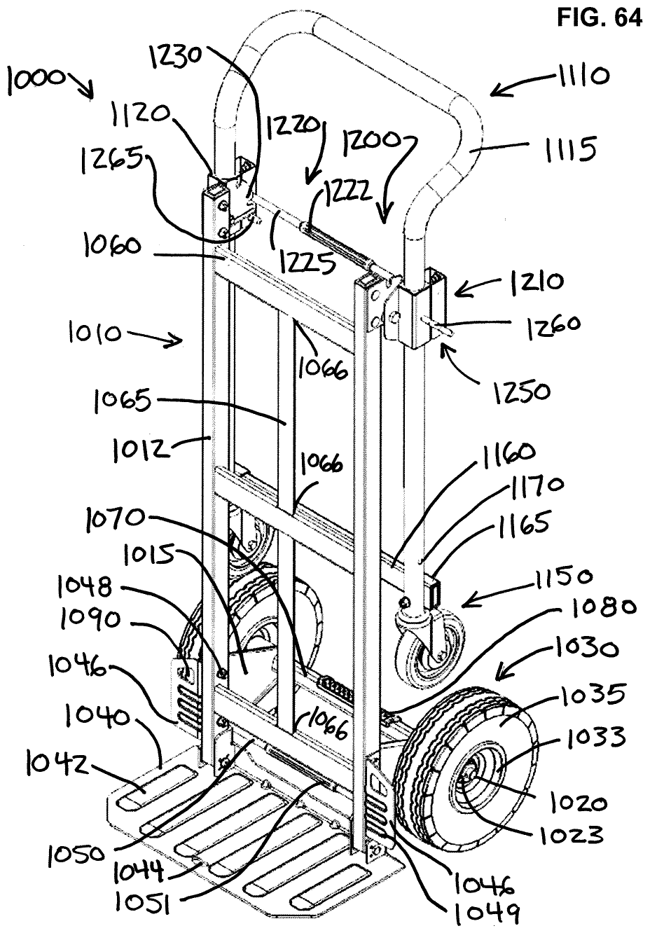

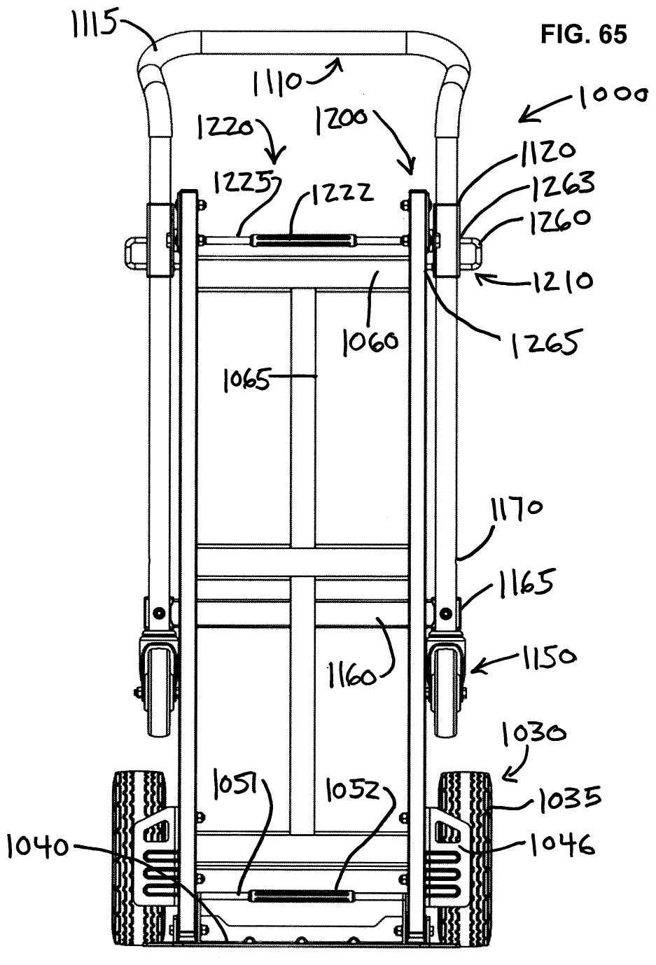

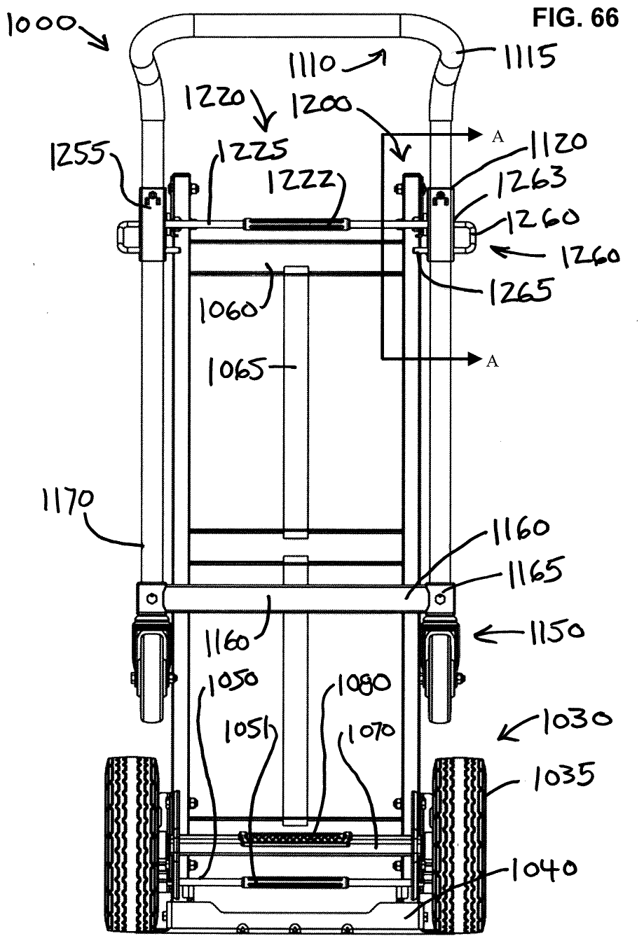

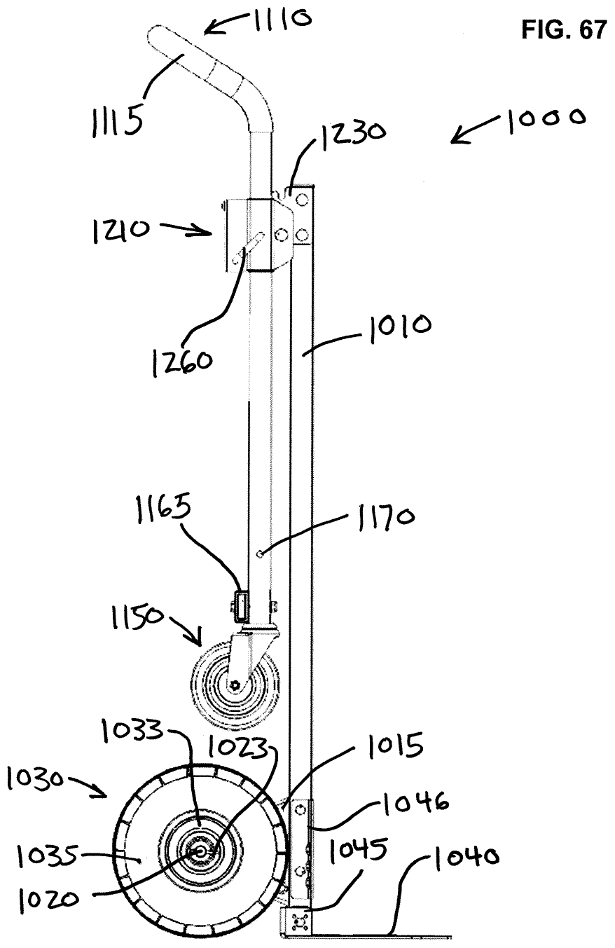

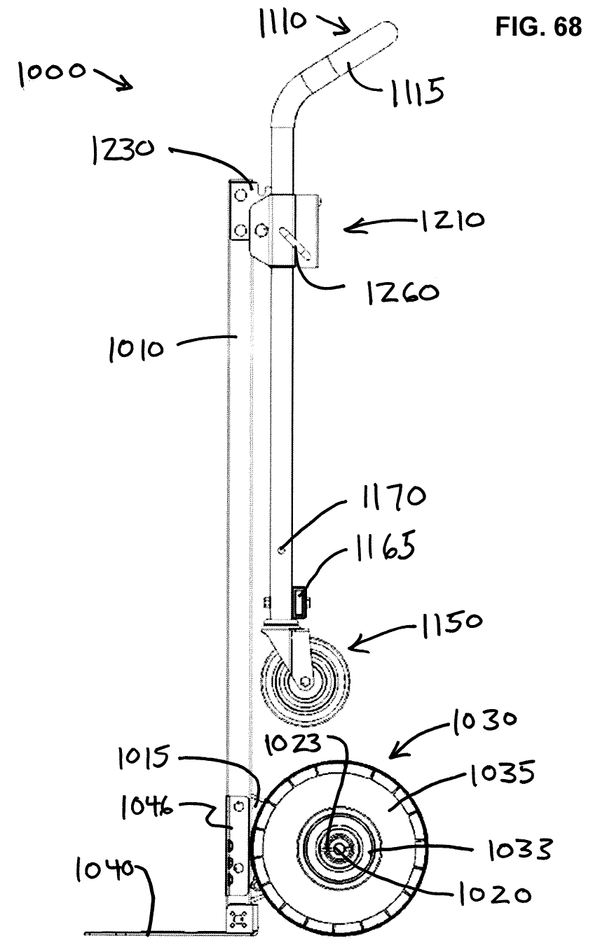

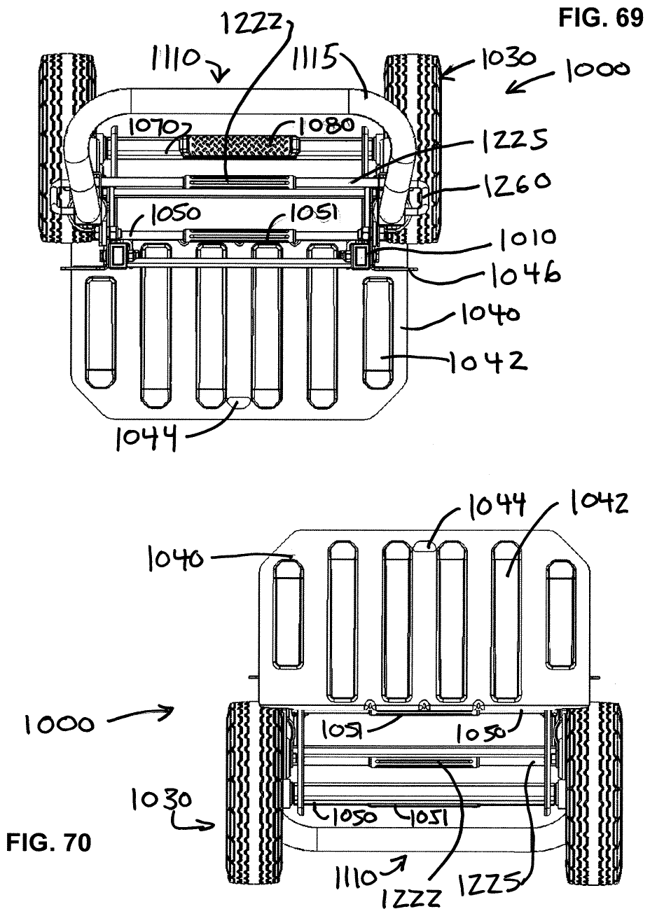

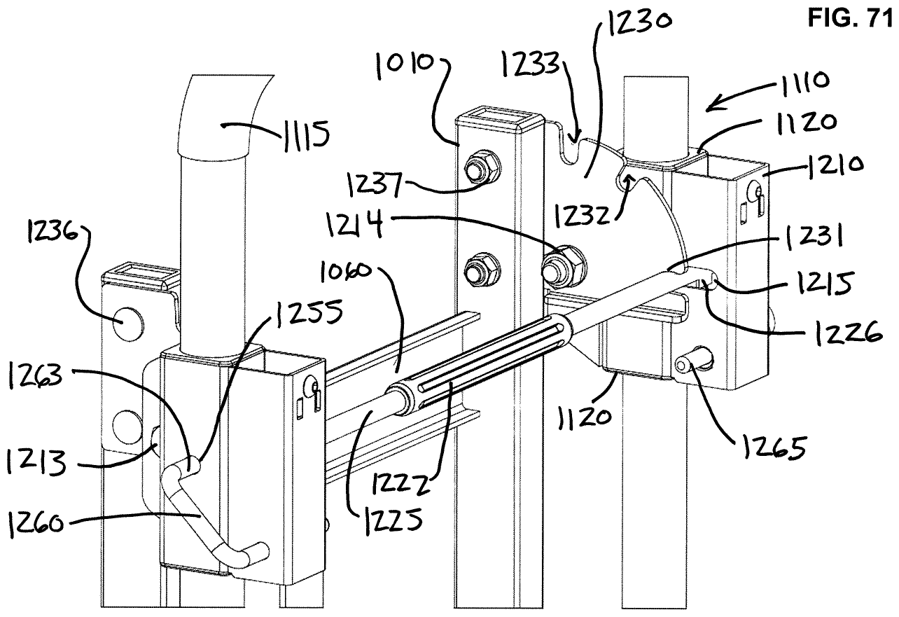

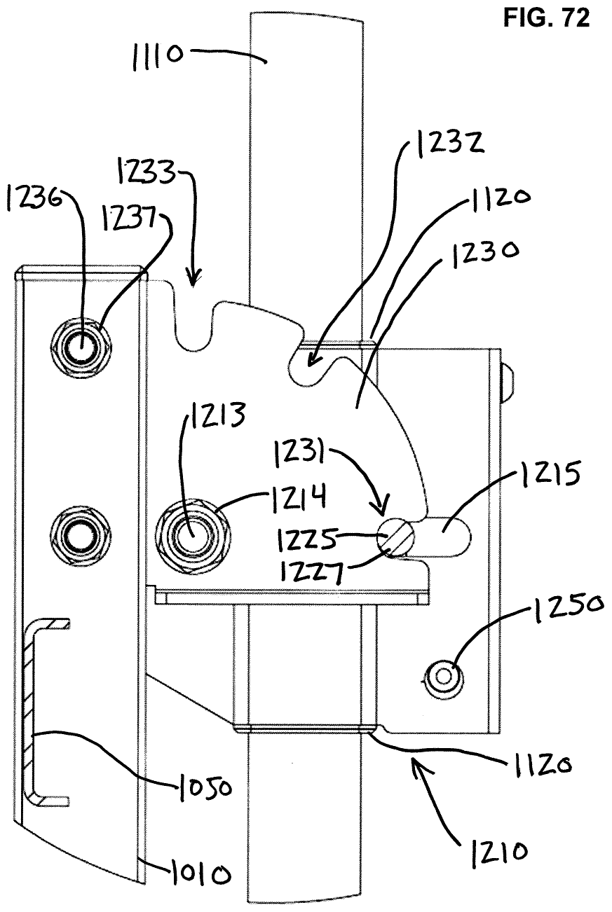

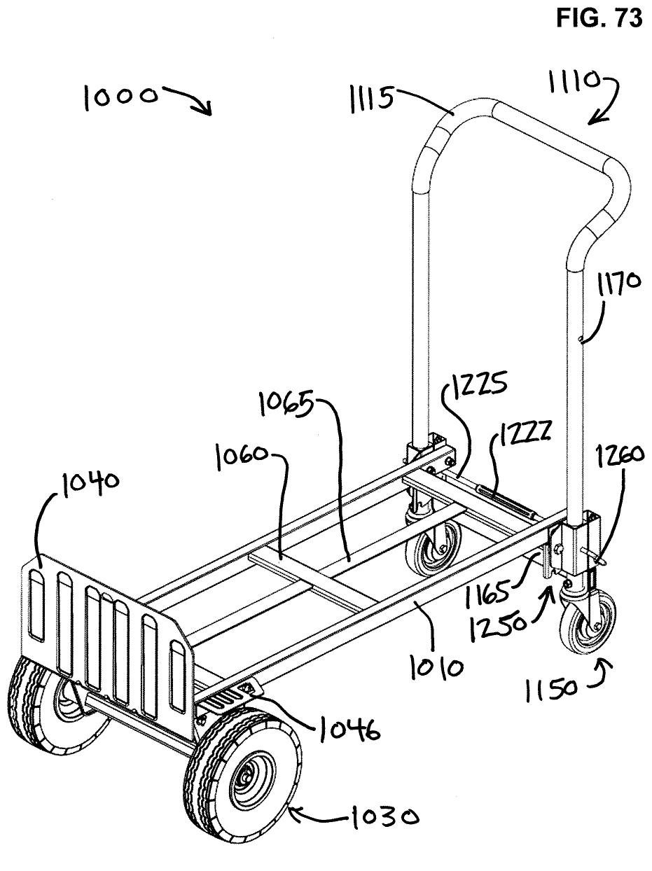

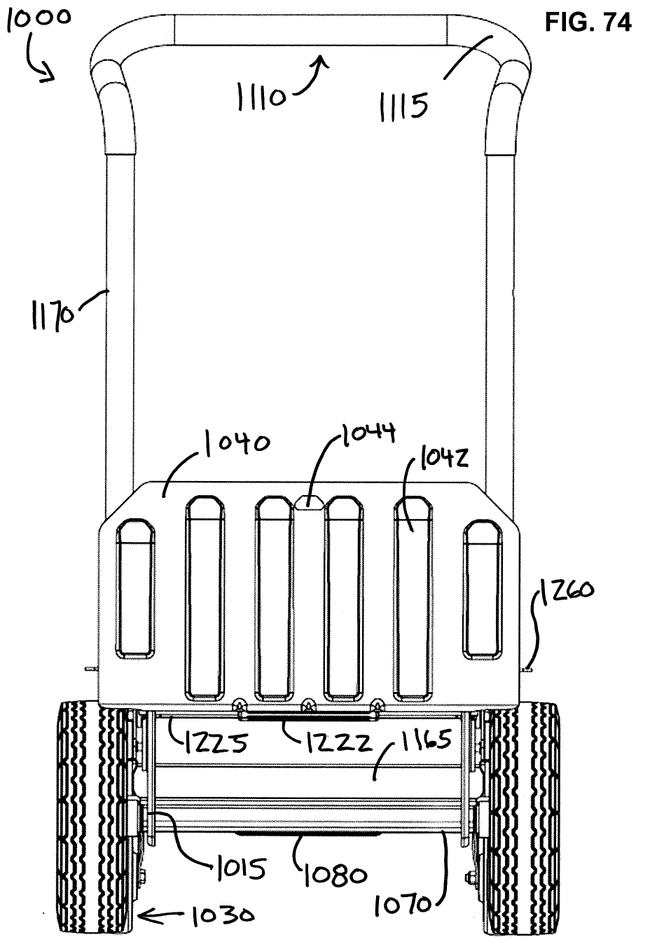

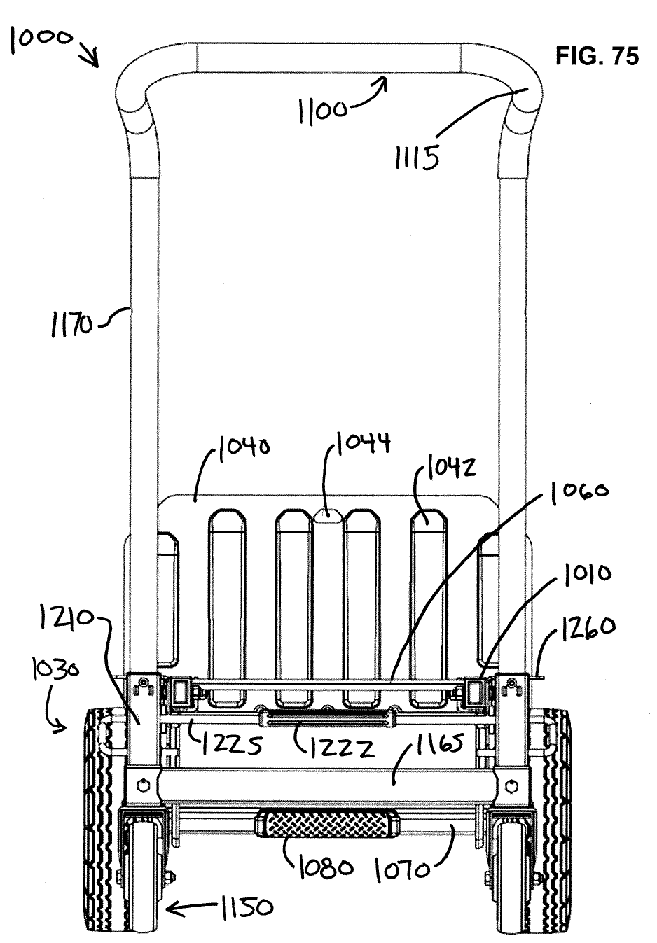

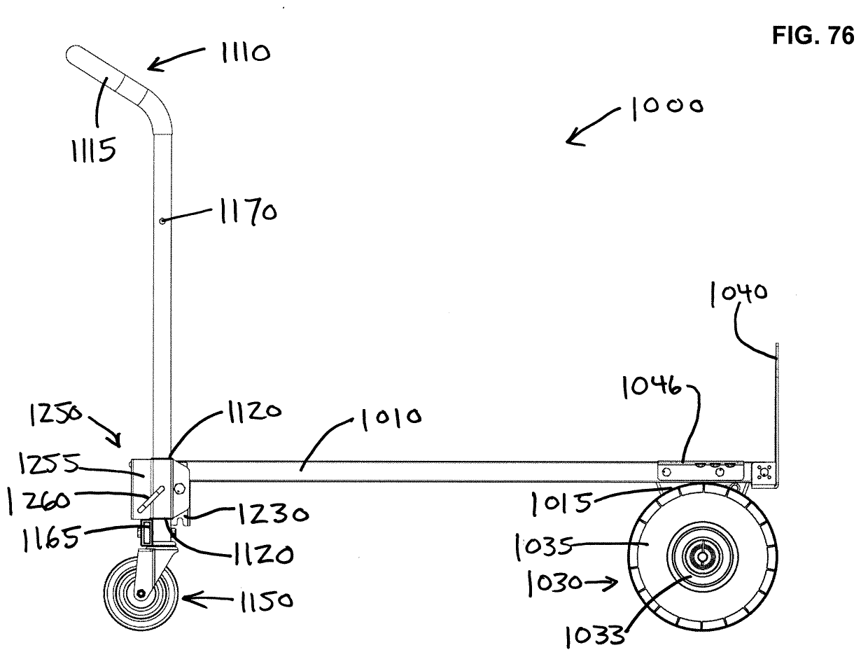

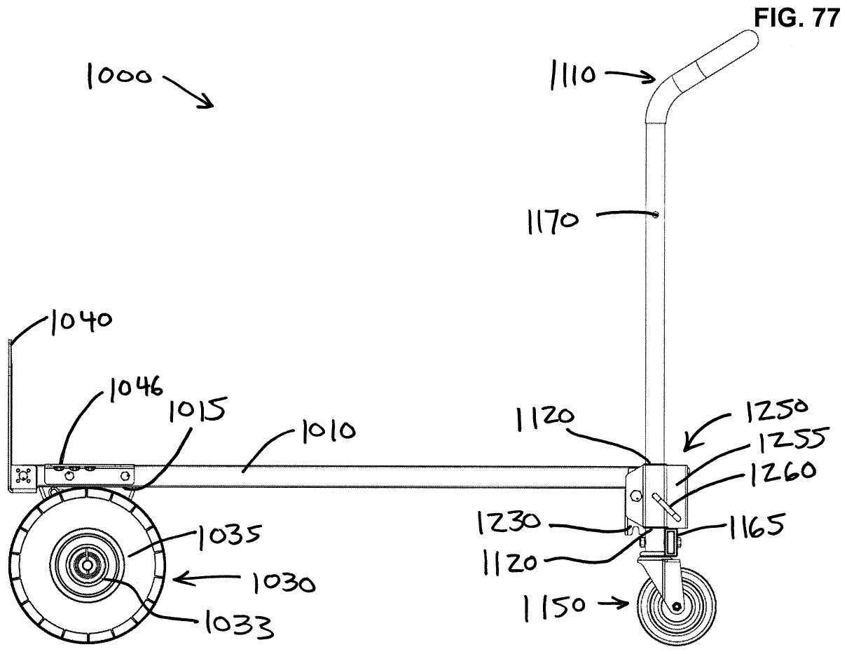

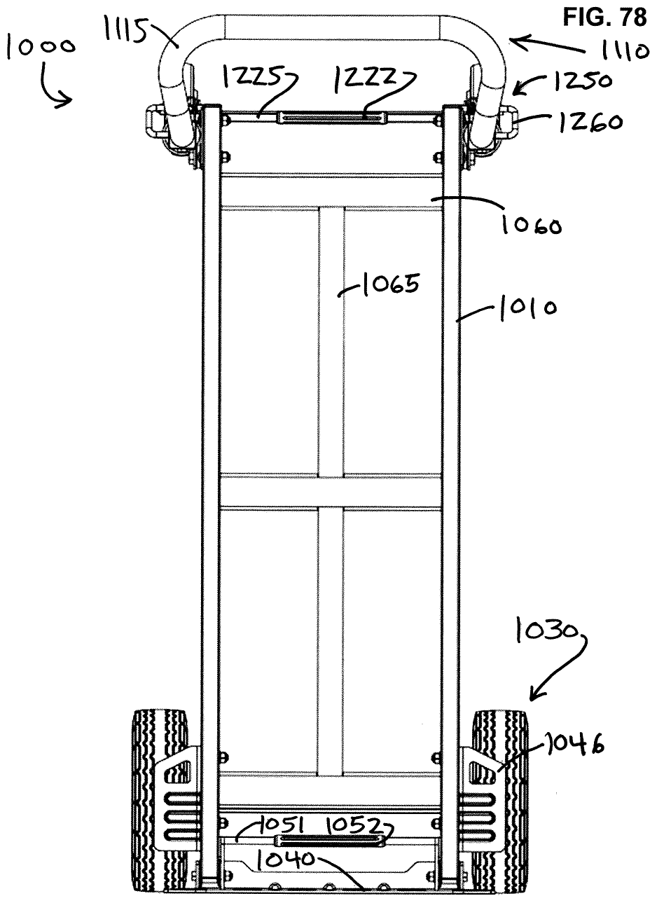

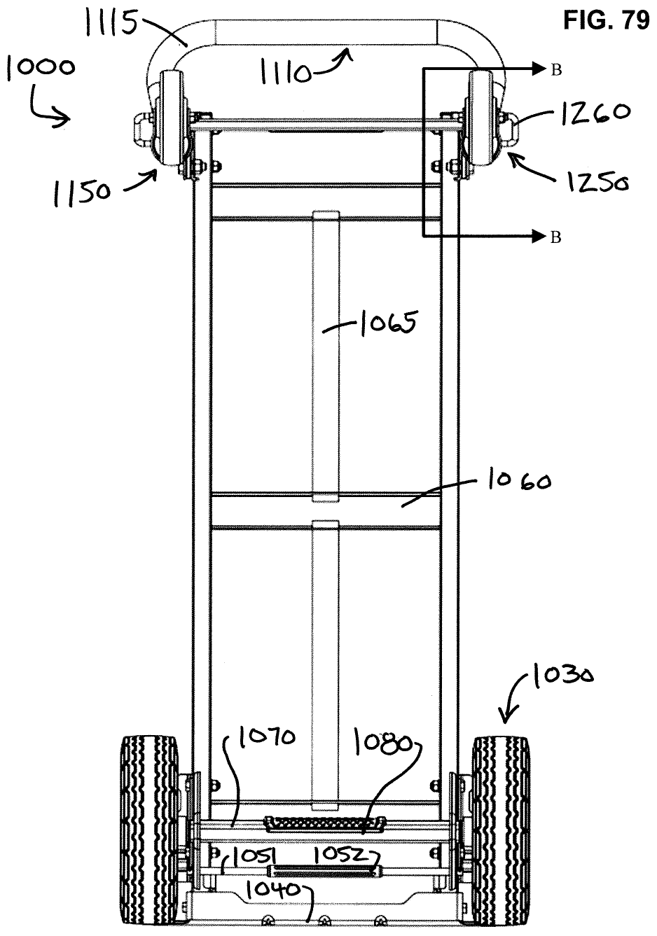

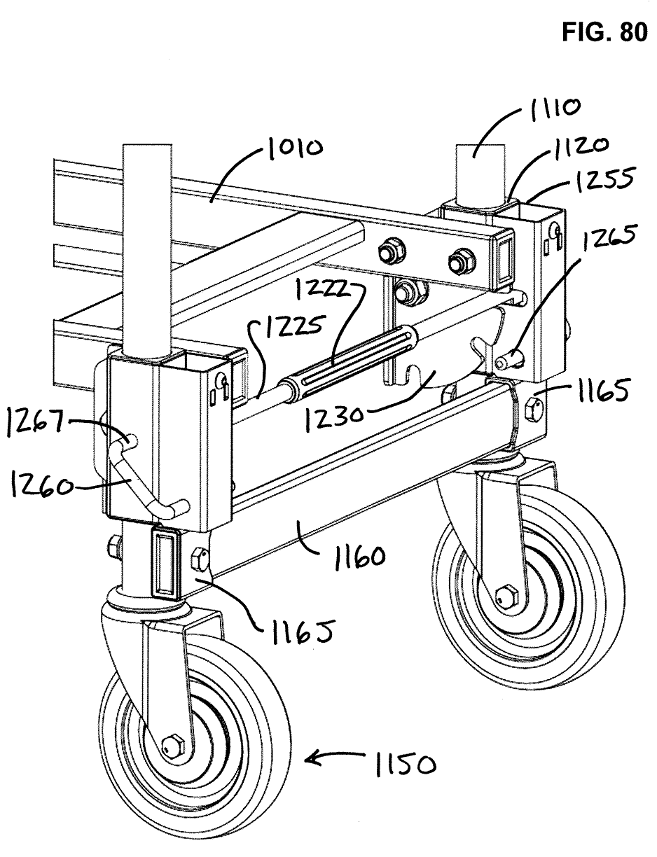

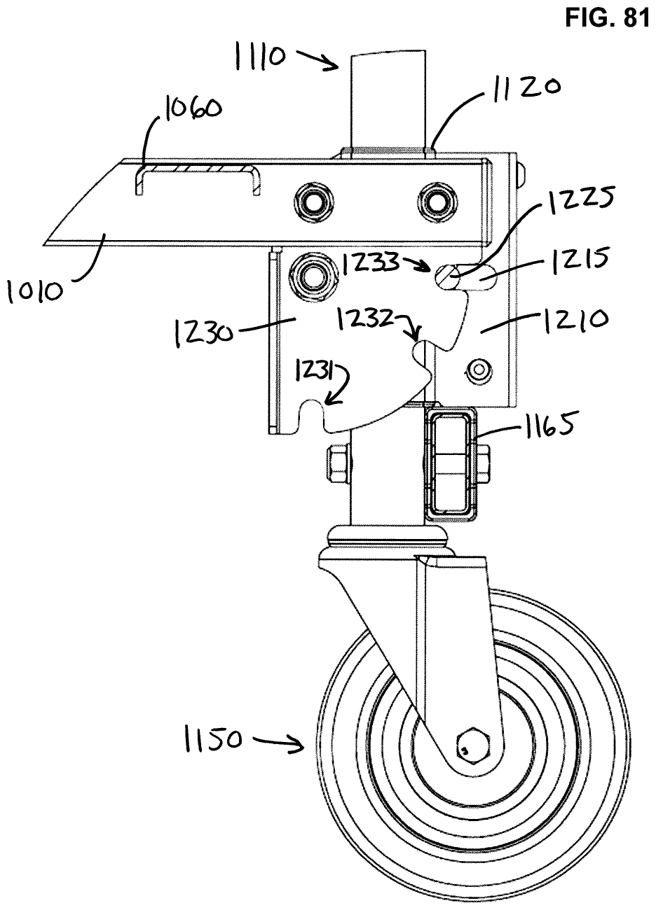

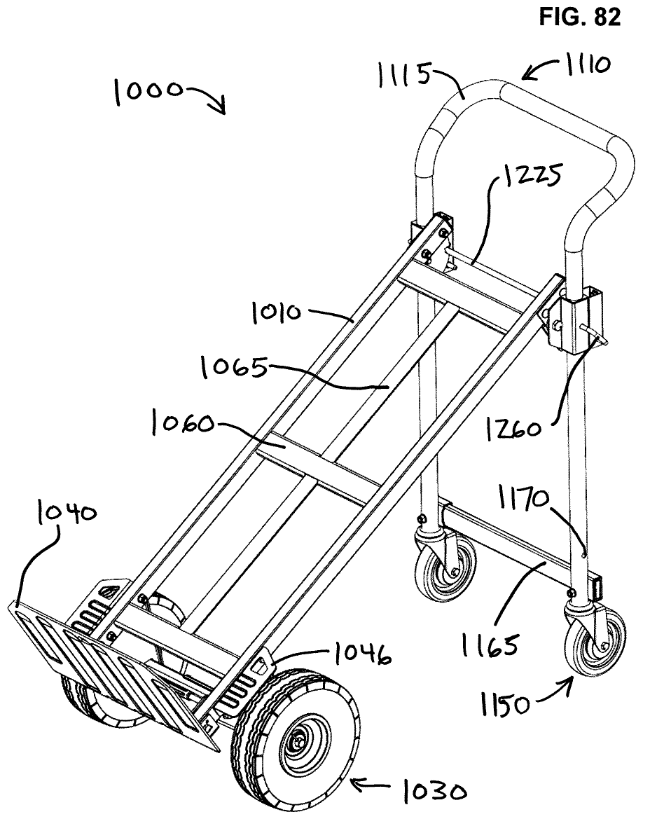

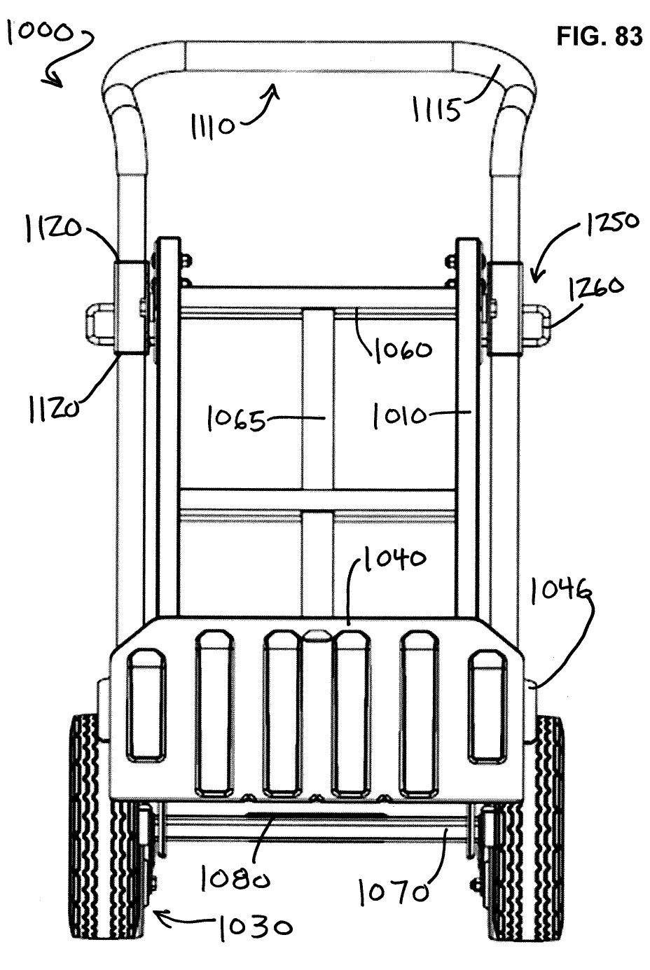

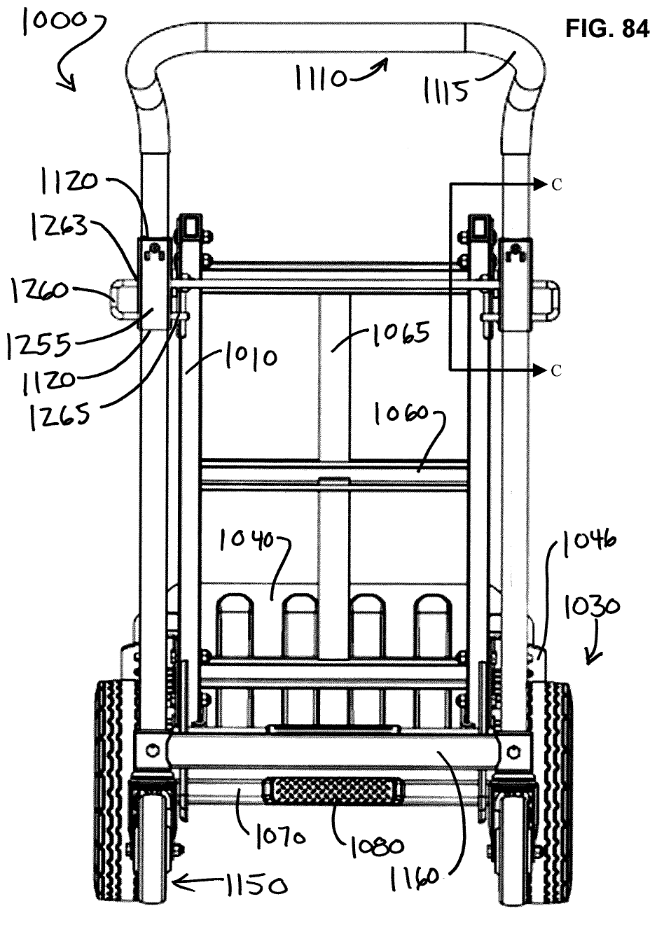

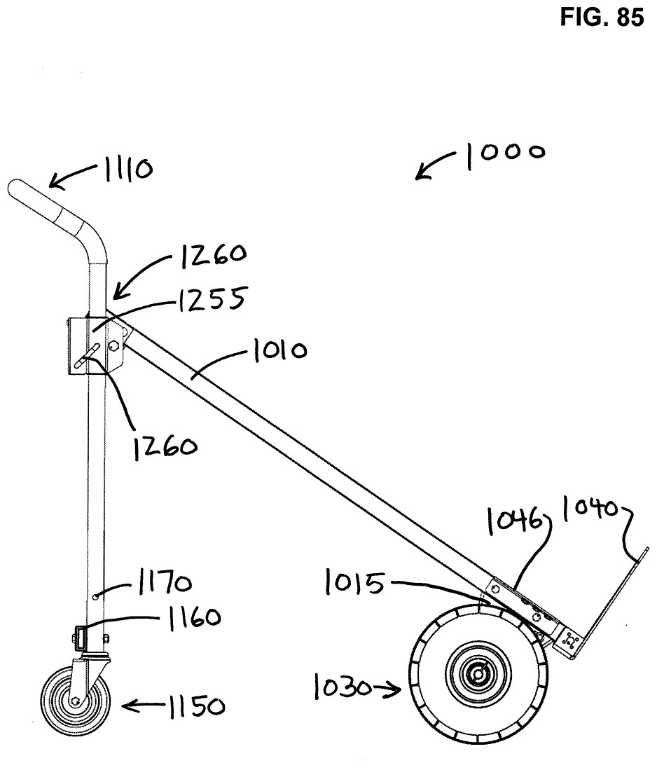

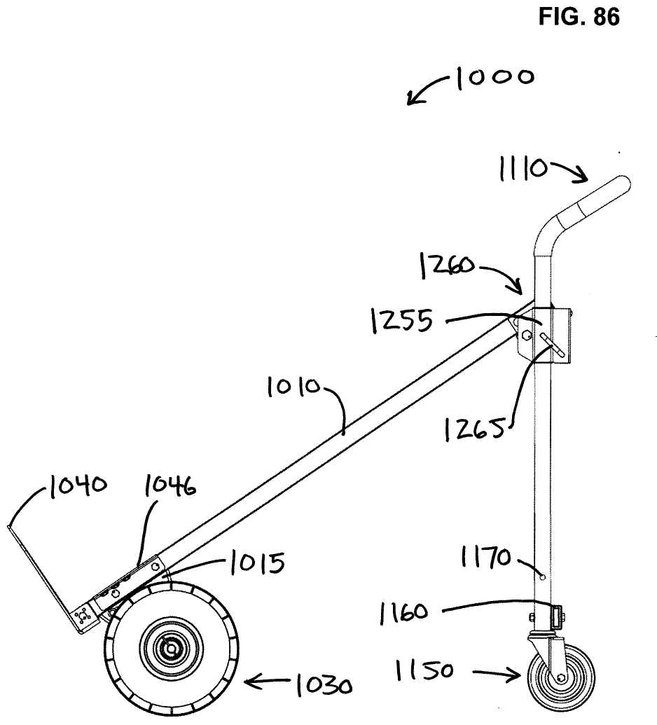

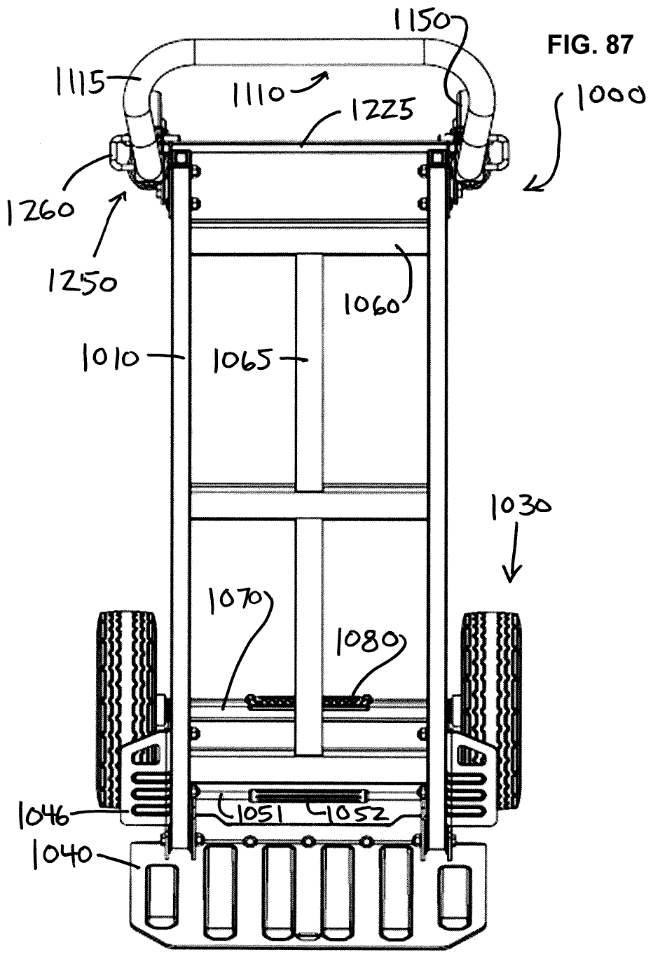

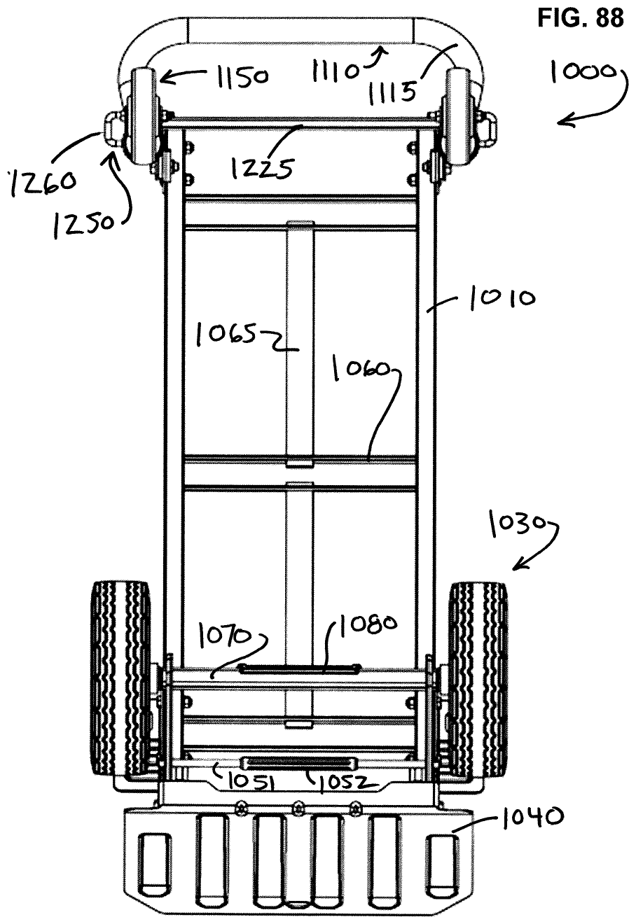

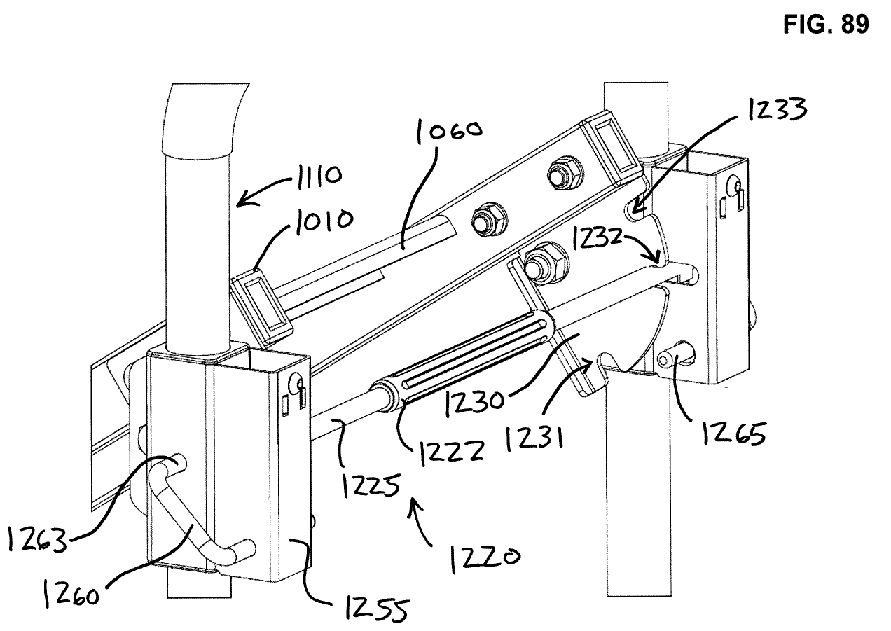

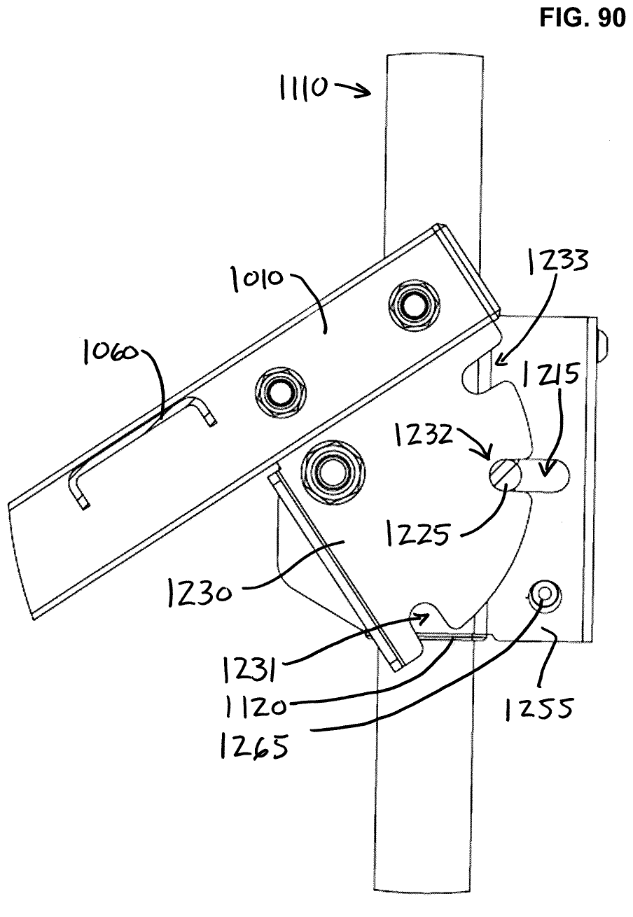

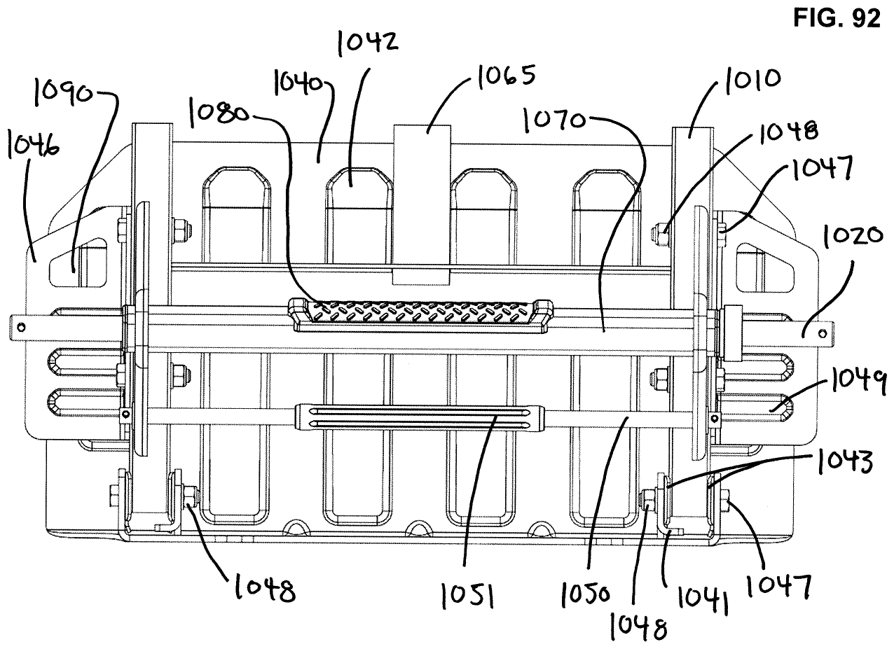

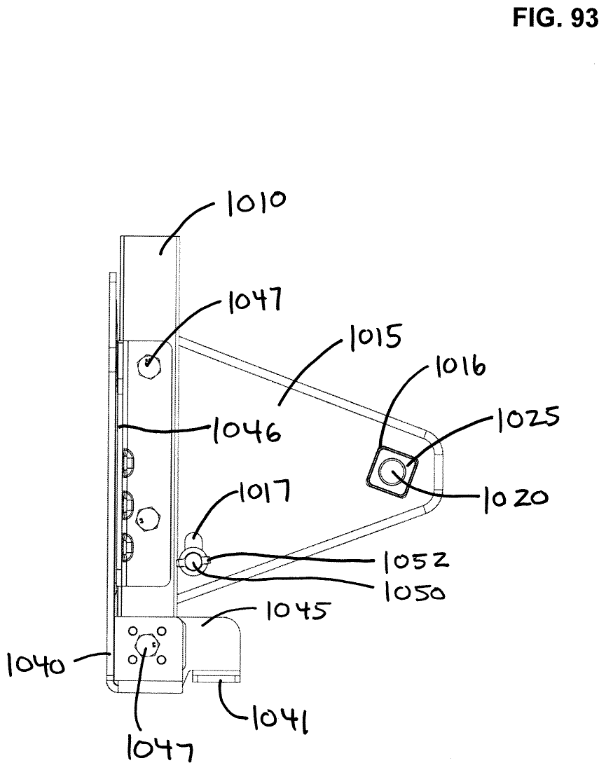

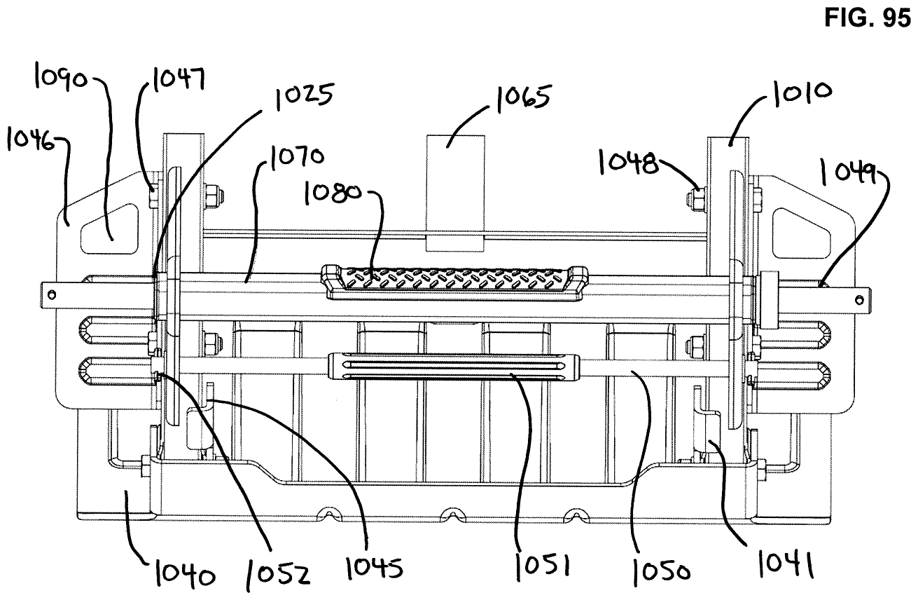

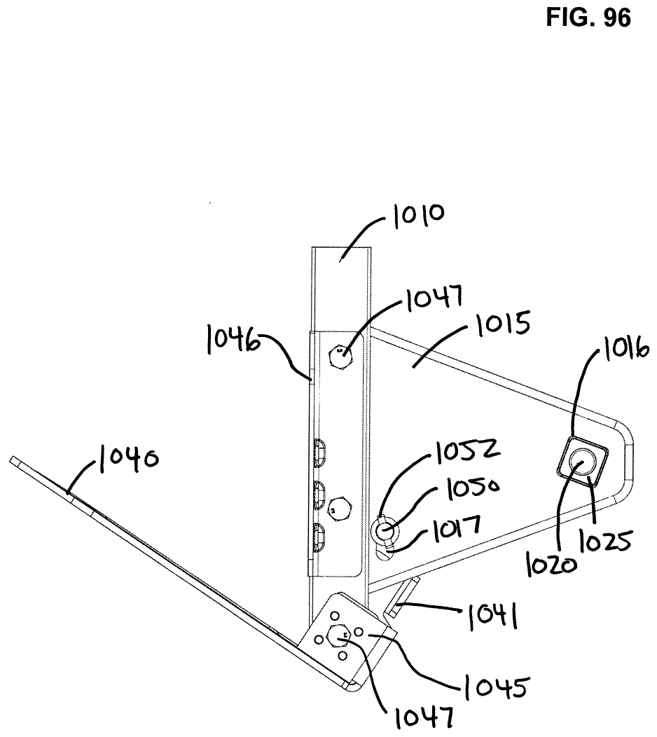

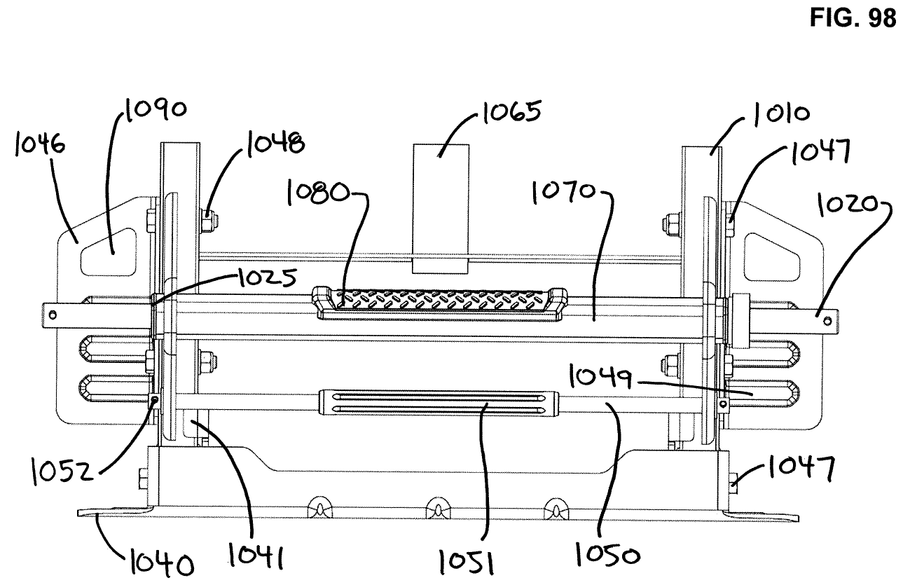

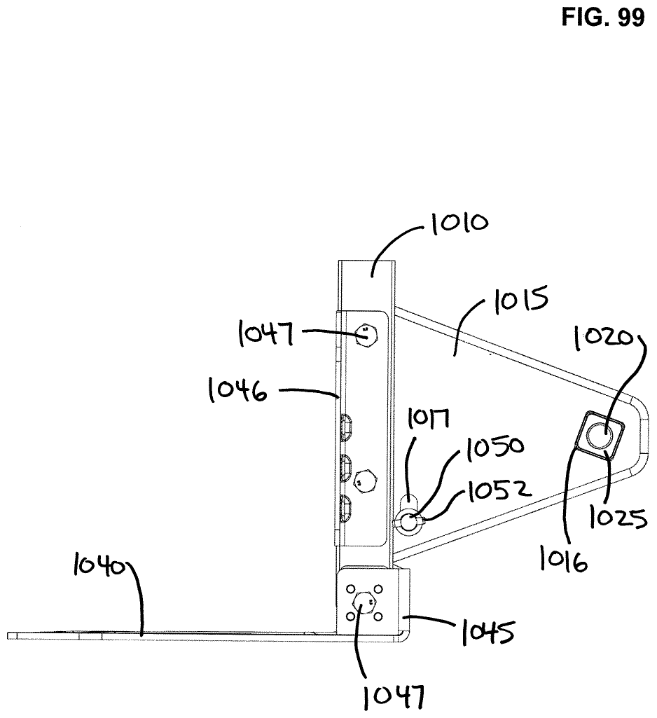

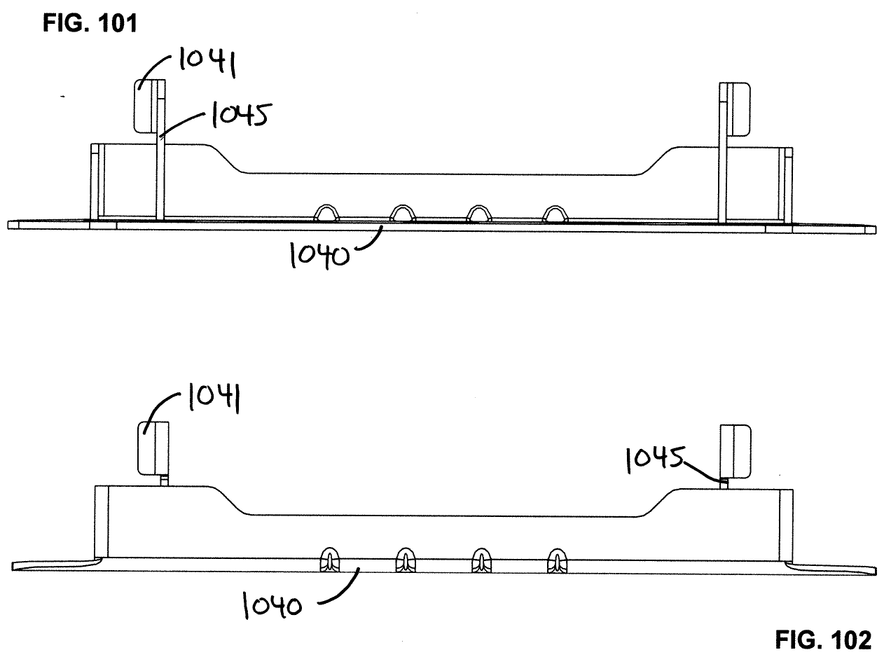

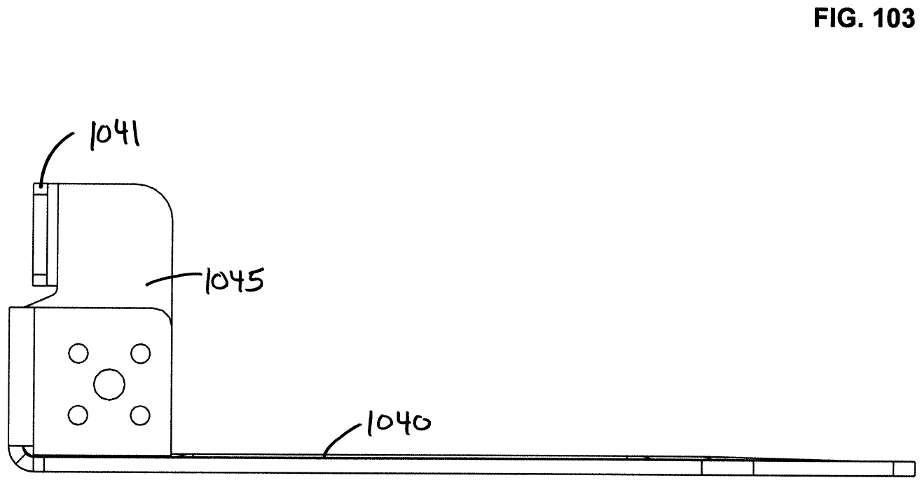

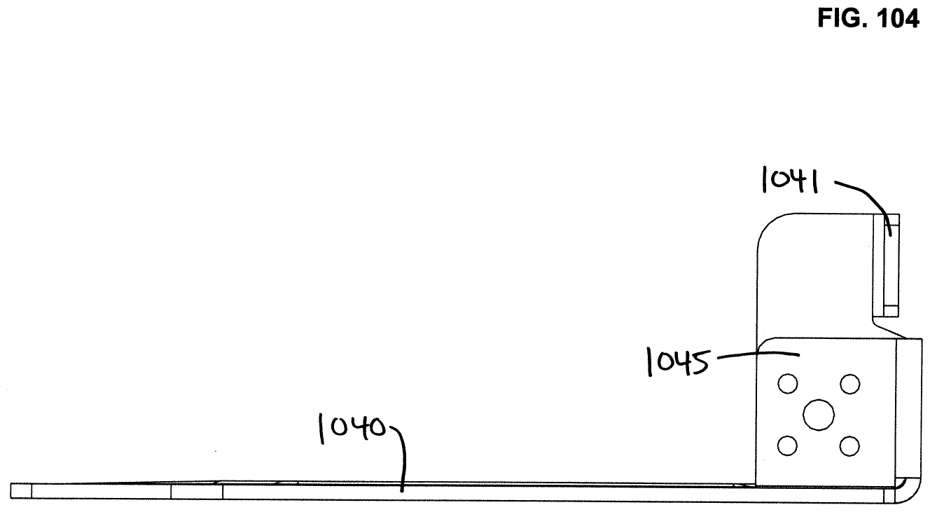

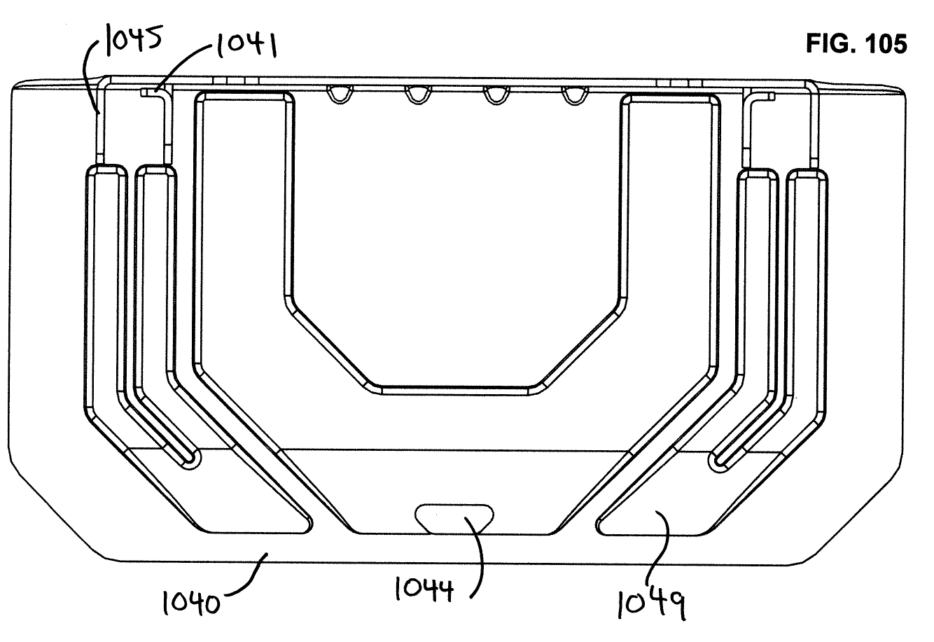

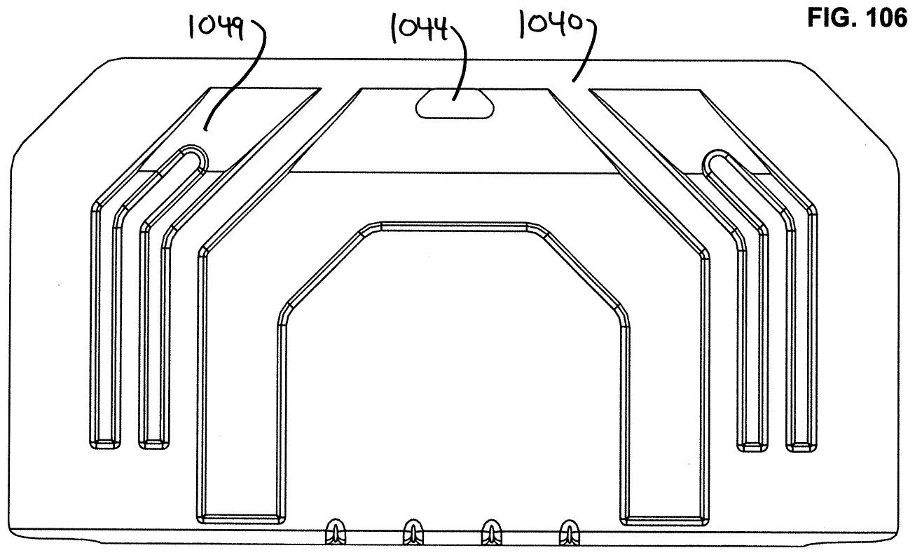

Another embodiment of the present invention is illustrated in FIGS. 64-106. This embodiment provide a material handling device 1000 that has three orientations: upright hand truck (FIGS. 64-70), cart (FIGS. 73-79), and angled hand truck (FIGS. 82-88). In addition to multiple orientations, the material handling device 100 includes a folding toe plate 1040. The structural components of this embodiment of a material handling device 1000 are made of steel to maximize the load capacity of the material handling device 1000.

The frame 1010 comprises two side rails 1012 made of steel tubing with preferably a rectangular cross section. Cross branches 1060 run between the side rails 1012 with a cross brace center support 1065 running parallel to the side rails 1012 between the uppermost and lowermost cross braces 1060. The center support 1065 is preferably a unibody piece that is sized to fit through apertures 1066 in the cross braces 1060. Axle brackets 1015 extending to the rear of frame 1010 at an appropriate height to support wheels 1030 that allow the material handling device 1000 to stand vertical when the wheels 1030 and toe plate 1040 are on a level ground surface. An axle tube 1070 spans the axle brackets 1015 through an axle orifice 1016 in each axle bracket 1015. Preferably all parts of the frame identified above are welded together with the front face of the cross braces 1060 are coplanar with the front face of the side rails 1012.

Wheels 1030 each comprise a steel rim 1033 and flat free rubber tire 1035 are attached at either end of the axle 1020, preferably by a cotter pin 1023. Other means known in the art may be used to attach the wheels 1030 to the axle 1020 and the wheels 1030 may be a single body instead of separate rim 1033 and tire 1035. Other materials may be used for both the tires 1035 and rims 1033 for specific needs.

To support the axle 1020 within the axle tube 1070, a center axle bushing 1080 is inserted in the center of the axle tube 1070 and axle bushings 1025 are located at the outer extremities of the axle tube 1070. These bushings 1025, 1080 are preferably made of polypropylene to provide adequate support and cushion for the axle 1020. This arrangement is identical to the embodiment of FIGS. 1-7. As best seen in FIG. 4B, the center axle bushing 1080 (175 in FIG. 4B) is exposed at the top and rear exterior of the axle tube 1070 (170 in FIG. 4B) to also provide a textured foot lever for aid in tipping the material handling device 1000. This is accomplished by having the center axle bushing 1080 sit within a cavity 1075 (177 in FIG. 4B) in the axle tube 1070 sized to tightly fit the bushing 1080.

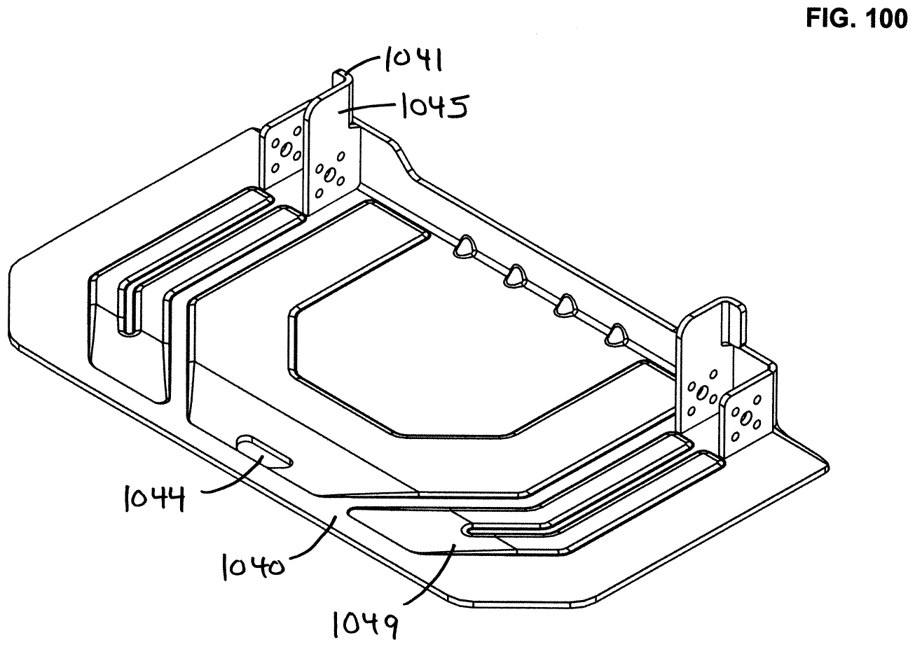

The toe plate 1040 of the embodiment of FIGS. 64-106 is attached to ends of the frame 1010, preferably by nuts 1047 and bolts 1048, but may be welded or attached by any other means known in the art. The nose plate 1040 is sized width-wise to extend to the approximate midpoint of each wheel 1030. The toe plate 1040 preferably includes coining 1042 to provide strength and stiffness to the toe plate 1040 and has a lift orifice 1044 at its front to allow for a strap, bungie cord, or hook to attached to the material handling device 1000 for lifting or to secure a load. The nose plate 1040 of this embodiment includes a frame bracket 1045 sized to fit the ends of the side rails 1012 and allow the toe plate 1040 to rotate around the bolts 1048 that hold the toe plate 1040 to the frame 1010. The frame bracket 1045 includes a stop 1041 that prevents the toe plate 1040 from rotating past perpendicular to the side rails 1012. Toe plate spacers 1043, preferably made of nylon, are located between the side rails 1012 and inside walls of the frame brackets to provide smoother movement of the toe plate 1040 when folding/unfolding and provide a tight wear surface. The toe plate spacers 1043 are also held to the side rails 1012 by the same bolts 1048 attaching the toe plate 1040 to the side rails 1012. Preferably the frame brackets 1045 include indents or orifices (See FIG. 100) that accept nubs on the toe plate spacers 1043 to prevent rotation of the spacers 1043 during movement of the toe plate 1040.

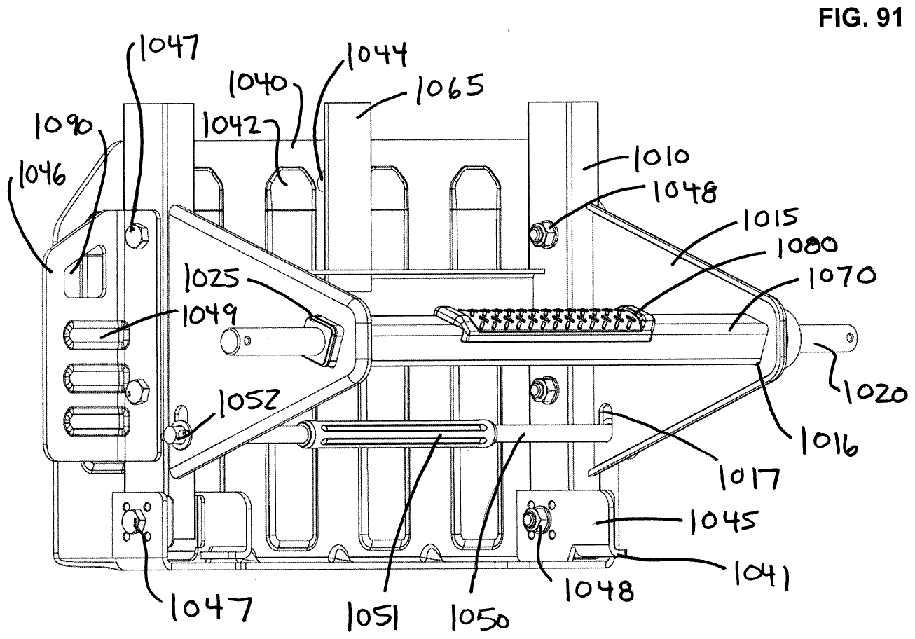

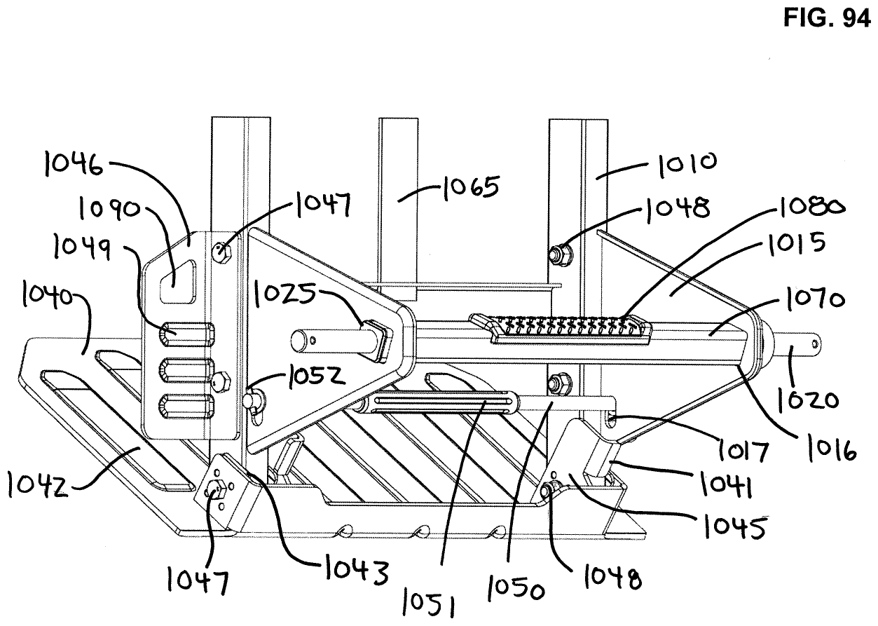

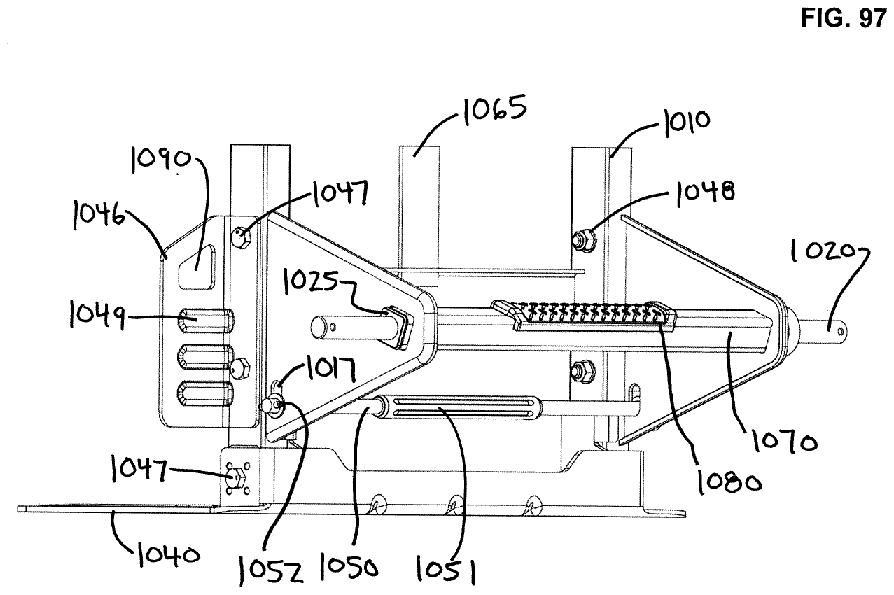

The toe plate 1040 is locked in its fully open orientation (FIGS. 97-99) or closed orientation (FIGS. 91-93) by means of a toe plate latch bar 1050. The toe plate latch bar 1050 spans between the two axle brackets 1015 through latch bar slots 1017 in the axle brackets 1015 and are held in place by latch bar pins 1052. Other means of retaining the latch bar 1050 within the axle brackets 1015 known in the art may also be used. When the latch bar 1050 is in its resting position due to gravity (lower end of the slatch bar slot 1017), it interferes with the toe plate frame bracket stop 1041 to prevent the toe plate 1040 from rotating. However, lifting the latch bar 1050 (see FIGS. 94-96) allows the toe plate frame bracket stop 1041 to rotate past the latch bar 1050 into the desired position.

Wheel guards 1046 are also attached to each side rail 1012 and extend to approximately the midpoint of each wheel 1030. The wheel guards are preferably attached to the frame with nuts 1047 and bolts 1048 but may be attached by other means known in the art such as welding. Steel is the preferred material for the wheel guards 1046 and include coining 1049 to provide strength as well as a strap orifice 1090.

The handle mechanism 1100 of this embodiment is a handle loop 1110 formed of preferably steel with a circular cross section. The handle loop 1110 is attached to the frame 1010 via a latch mechanism 1200. The latch mechanism 1200 includes a latch housing 1210 attached to a latch bracket 1230, preferably by nut 1213 and bolt 1214. The latch bracket 1230 is further attached to the top of the side rails 1012 by latchet bracket nuts 1236 and bolts 1237. Handle bushings 1120 are housed within the latch housing 1210 to retain the handle loop 1110 and allow it to slide when converting the material handling device 1000 between its three orientations: upright hand truck (FIGS. 64-70), cart (FIGS. 73-79), and angled hand truck (FIGS. 82-88).

The latch bracket 1230 includes a first notch 1231, second notch 1232, and third notch 1233, each corresponding to one of the three orientations for the material handling device 1000. The notches 1231, 1232, 1233 are sized to accept a latch release bar 1225 that spans between the latch housing 1210 located on each side rail 1110 through notches 1215 in each housing 1210. When not in a locked position, the latch housing 1210 can rotate around the latch housing bolts 1224 to allow for change of the material handling device 1000 orientation. In the embodiment shown in FIGS. 64-106, when the latch release bar 1225 is in the first notch 1231, the material handling device 1000 is in the upright hand truck orientation. When the latch release bar 1225 is in the second notch 1232, the material handling device 1000 is in the angled hand truck orientation. And when the latch release bar 1225 is in the third notch 1233, the material handling device 1000 is in the cart orientation. However, depending on the alignment of the latch bracket 1230 and notches 1231, 1232, 1233, the orientation of the material handling device with respect to the location of the latch release bar 1225 in relation to the notches 1231, 1232, 1233 can vary.

The latch release bar 1225 is preferably made of steel and is held within the latch housing notch 1215 by means of a latch release bar stop 1226. The latch release bar stop 1226 may be formed as part of the latch bar 1225 or can be a separate structure that is attached to the latch bar 1225 such as a cotter pin. The latch release bar 1225 is biased to enter one of the notches 1231, 1232, 1233 by a latch release bar biasing spring 1227 attached to the latch housing 1210. It is preferable for the latch release bar 1225 to include a latch release grip 1222 made of polypropylene for improved comfort and hold. It is also preferable that the latch release bar grip 1022 be a bright contrasting color for easy identification and location by a user.

To provide a further locking means of the material handling device 1000 in an orientation, this embodiment utilizes J-lock mechanisms 1250 similar to that of the embodiment in FIGS. 50-63. Once the latch bar 1225 is within a pair of correlating notches 1231, 1232, 1233 on each bracket 1230, a J-lock rod 1260 with a stationary end 1265 rests within the latch housing 1210 but may rotate. A biasing spring 1267 within the latch housing 1210 biases the J-lock rod 1260 against the housing 1210. Each J-lock rod 1260 includes a locking end 1263 that can rotate to lock the handle loop 1110 in position via a handle lock orifice 1170 on the handle loop 1110. The locking end 1263 locks the handle loop 1110 in its desired location by also entering a handle lock orifice 1255 on the latch housing 1210. This novel approach allow a single J-lock bar 1260 on each side of the material handling device 1000 to affectively lock the handle loop 1100 in place.

To allow for the material handling device 1000 to function in its cart orientation (FIGS. 73-79), caster wheels 1150 are mounted at the ends of the loop handle 1000. To provide strength to the loop handle 1000 as well as keep the lower end of the loop handle 1000 aligned, a caster wheel crossbar 1170 runs between the and proximate to the ends of the loop handle 1110.

It is contemplated that features disclosed in this application, as well as those described in the above applications incorporated by reference, can be mixed and matched to suit particular circumstances. Various other modifications and changes will be apparent to those of ordinary skill.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A hand truck comprising:
a frame comprising two uprights and a plurality of cross members, each cross member spanning between the two uprights;
a toe plate;
a pair of wheels; and
wherein the frame comprises a pair of strap anchors.

2. The hand truck of claim 1 wherein the frame and strap anchors are made of steel and the strap anchors are welded to the frame.

3. The hand truck of claim 2 wherein one of the pair of strap anchors is welded to a respective one of the two uprights at the same location as one of the plurality of cross members along the length of the uprights.

4. The hand truck of claim 3 comprising a quantity of pairs of strap anchors equal to the quantity of cross members and wherein one of each pair of strap anchors is located at the same location as a respective cross member along the length of the uprights.

5. The hand truck of claim 1 wherein each of the strap anchors has a depth and each of the cross members has a depth and the depth of the strap anchors does not exceed the depth of the cross members.

6. The hand truck of claim 4 wherein each of the strap anchors has a depth and each of the cross members has a depth and the depth of the strap anchors does not exceed the depth of the cross members.

7. The hand truck of claim 1 wherein the pair of strap anchors is attached to a respective upright at the same location as one of the plurality of cross members along the length of the uprights.

8. The hand truck of claim 7 comprising a quantity of pairs of strap anchors equal to the quantity of cross members and wherein one of each pair of strap anchors is located at the same location as a respective cross member along the length of the uprights.

9. The hand truck of claim 8 wherein each of the strap anchors has a depth and each of the cross members has a depth and the depth of the strap anchors does not exceed the depth of the cross members.

10. The hand truck of claim 8 wherein the frame and strap anchors are made of steel and the strap anchors are welded to the frame.

11. The hand truck of claim 9 wherein the frame and strap anchors are made of steel and the strap anchors are welded to the frame.

12. A hand truck comprising:
a pair of frame uprights;
a plurality of crossmembers, each cross member spanning between the two uprights;
a toe plate; and
a pair of wheels; and
wherein each frame upright comprises a strap loop.

13. The hand truck of claim 12 wherein each strap loop is attached to its respective frame upright at the same location along the length of the frame upright as one of the plurality of cross members.

14. The hand truck of claim 12 comprising a quantity of pairs of strap anchors equal to the quantity of cross members and wherein one of each pair of strap anchors is located at the same location as a respective crossmember along the length of the frame uprights.

15. The hand truck of claim 13 wherein each of the strap anchors has a depth and each of the cross members has a depth and the depth of the strap anchors does not exceed the depth of the cross members.

16. The hand truck of claim 14 wherein each of the strap anchors has a depth and each of the cross members has a depth and the depth of the strap anchors does not exceed the depth of the cross members.

17. The hand truck of claim 15 wherein the frame uprights and strap anchors are made of steel and the strap anchors are welded to the frame uprights.

18. The hand truck of claim 16 wherein the frame uprights and strap anchors are made of steel and the strap anchors are welded to the frame uprights.

19. The hand truck of claim 14 wherein each strap loop is trapezoidal in shape.

20. A hand truck comprising:
a pair of uprights spanned by a plurality of cross members;
a toe plate; and
a pair of wheels; and
a pair of strap anchors associated with each crossmember, each pair of strap anchors welded to the uprights at the same location along the length of the upright as its associated cross member.
